(19) United States
(12) Patent Application Publication
(10) Pub. No.: US 2007/0212626 A1
(43) Pub. Date: Sep. 13, 2007

(54) ELECTROPHOTOGRAPHIC PHOTORECEPTOR, AND IMAGE FORMING APPARATUS AND PROCESS CARTRIDGE USING THE SAME

(76) Inventors: Tetsuya Toshine, Numazu-shi (JP); Yasuo Suzuki, Fuji-shi (JP); Tetsuro Suzuki, Fuji-shi (JP); Hidetoshi Kami, Numazu-shi (JP); Yukio Fujiwara, Numazu-shi (JP); Yoshinori Inaba, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/684,520

(22) Filed: Mar. 9, 2007

(30) Foreign Application Priority Data
Mar. 10, 2006 (JP) JP2006-066518
Mar. 10, 2006 (JP) JP2006-066552
Mar. 14, 2006 (JP) JP 2006-069169

(51) Int. Cl. G03G 5/047; G03G 5/147

(52) U.S. Cl. 430/58.7; 430/133; 430/66; 399/159

(57) ABSTRACT

An electrophotographic photoreceptor is provided including an electroconductive substrate; a photosensitive layer located overlying the electroconductive substrate; and an outermost layer located overlying the photosensitive layer, wherein the outermost layer is formed by a reaction between a radical polymerizable compound having no charge transport structure including a compound having a specific formula, and a radical polymerizable compound having a charge transport structure, while applying heat, light, or ionizing radiation to the reaction, and wherein at least one of the photosensitive layer and the outermost layer includes at least an arylmethane compound having an alkylamino group or a compound having a specific formula.

### CROSS-REFERENCE TO RELATED APPLICATIONS

This document claims priority and contains subject matter related to Japanese Patent Applications Nos. 2006-066518, 2006-066552, and 2006-069169, filed on Mar. 10, 2006, Mar. 10, 2006, and Mar. 14, 2006, respectively, the entire contents of each of which are incorporated herein by reference.

### BACKGROUND OF THE INVENTION

1. Field of the Invention

Exemplary aspects of the present invention relate to an electrophotographic photoreceptor. In addition, exemplary aspects of the present invention relate to an image forming apparatus and a process cartridge using the electrophotographic photoreceptor.

2. Description of the Related Art

Organic photoreceptors are widely used as an electrophotographic photoreceptor (hereinafter referred to as photoreceptor). Organic photoreceptors typically have the following advantages over inorganic photoreceptors.

Organic photoreceptors are capable of using materials responsive to various light (e.g., visible light, infrared light) irradiators, which are easily developed;

capable of using environmental-friendly materials; and

have a low manufacturing cost.

On the other hand, organic photoreceptors are easily abraded or scratched after long repeated use because of having poor physical and chemical strength.

An electrophotographic image forming apparatus typically includes a photoreceptor, a charger for charging the photoreceptor, an image former for forming an electrostatic latent image on the charged photoreceptor, an image developer for adhering a toner to an image portion of the electrostatic latent image, and a transferrer for transferring the toner adhered to the image portion onto a transfer medium, and optionally includes a cleaner for removing toner particles remaining on the surface of the photoreceptor which are not transferred. Such toner particles remaining on the surface of the photoreceptor contribute to image deterioration. Therefore, most image forming apparatuses include the cleaner.

As the cleaner, a brush cleaner, a magnetic brush cleaner, and a blade cleaner are typically used. For the brush cleaner, polyester and acrylic fibers are typically used. These fibers may be shaped like a loop, a straight hair, etc., and hardness and diameter thereof may be optimized for use in the brush cleaner. However, it is difficult to completely remove toner particles by the brush cleaner because ultrafine particles tend to slip through fibers. The magnetic brush cleaner to which an electric field is applied so as to electrostatically remove toner particles has been proposed. In this case, there is a problem that toner particles tend to be scattered due to the electrostatic force and then adhere to the photoreceptor again. For the above reason, a blade cleaner using an elastic blade, that can remove remaining toner particles (especially those having a smaller particle diameter) and that can be manufactured at a low cost, are mainly used at present. In this case, the blade cleaner slides over the surface of the photoreceptor while contacting therewith. Therefore, the surface of the photoreceptor tends to be mechanically abraded or scratched.

As mentioned above, a physical external force is directly applied to the surface of the photoreceptor, and therefore the photoreceptor is required to have durability.

Various attempts to form a protective layer as the outermost layer of a photoreceptor and improve mechanical durability by dispersing a particulate inorganic material in the protective layer have been made. For example, published unexamined Japanese patent application No. (hereinafter referred to as JP-A) 2002-139859 discloses a photoreceptor including an electroconductive substrate, a photosensitive layer overlaid thereon, and a protective layer including a filler overlaid thereon in this order.

Other attempts to improve mechanical durability by increasing hardness of the surface of a photoreceptor have also been made. For example, JP-A 2001-125286 and JP-A 2001-324857 have disclosed photoreceptors of which the hardness of the surface is increased, used in combination with a charger including a magnetic brush. When such a charger is used, magnetic particles of the magnetic brush are involuntarily transferred onto the photoreceptor, and then pressed thereon in the transfer process and the cleaning process, resulting in scratches being made on the surface of the photoreceptor. It is described therein that such a photoreceptor of which the hardness of the surface is increased prevents scratches from being made thereon. JP-A 2003-98708 discloses an image forming apparatus including a blade cleaner and a photoreceptor of which the hardness of the surface is increased in order to prevent the abrasion thereof.

In attempting to increase the hardness of the surface of a photoreceptor, a method in which the outermost layer of a photoreceptor includes a cross-linking material, such as a thermosetting resin and an ultraviolet (UV) curing resin, is proposed. For example, JP-A 05-181299, 2002-6526, and JP-A 2002-82465 have disclosed photoreceptors, the outermost layer of which includes a thermosetting resin as a binder resin so as to improve abrasion resistance and scratch resistance thereof. JP-A 2000-284514, JP-A 2000-284515, and JP-A 2001-194813 have disclosed photoreceptors including a siloxane resin having a cross-linking structure as a charge transport material so as to improve abrasion resistance and scratch resistance thereof. Japanese Patent Nos. (hereinafter referred to as JP) 3194392 and 3286704 have disclosed photoreceptors including a monomer having a carbon-carbon double bond, a charge transport material having a carbon-carbon double bond, and a binder resin so as to improve abrasion resistance and scratch resistance thereof.

However, these attempts are not enough to improve mechanical durability and electric property of an electrophotographic photoreceptor. For example, the above-mentioned JP 3286704 discloses a photoreceptor, the outermost layer of which includes a polyfunctional acrylate monomer. However, no mention is made of a charge transport material used together therewith. If the outermost layer includes a low-molecular-weight charge transport material, there may be a case where the charge transport material and the resultant polymer obtained from the above monomer are incompatible. In this case, the low-molecular-weight components may bleed out and mechanical strength of the outermost layer may deteriorate. In order to improve their compatibility, a technique in which a polycarbonate resin is added to the outermost layer is disclosed therein. In this case, the content of the polyfunctional acrylate monomer in the outermost layer relatively decreases. As a result, mechanical durability and abrasion resistance of the resultant photoreceptor deteriorate. It is also described therein that the outermost layer can be much thinner when the outermost layer includes no charge transport material. However, such a thin outermost layer may disappear by abrasion in a short time. Typically, the life of a photoreceptor having an outermost layer is determined by a time that elapses before the outermost layer disappears by abrasion. Therefore, such a photoreceptor having a thin outermost layer cannot be a long-life photoreceptor.

The above-mentioned JP 3194392 discloses a photoreceptor having a charge transport layer formed by applying a coating liquid including a monomer having a carbon-carbon double bond, a charge transport material having a carbon-carbon double bond, and a binder resin. The binder resin may be both of a compound having a carbon-carbon double bond which is reactive to the charge transport material, and a compound having no carbon-carbon double bond which is not reactive to the charge transport material. It is described therein that such a photoreceptor has a good combination of abrasion resistance and electrical properties. However, when the above compound having no reactivity is used as the binder resin, the binder resin and the reaction product of the monomer with the charge transport material may have poor compatibility, and therefore the layer tend to separate and decrease the smoothness of the surface. As a result, the resultant photoreceptor has poor cleanability and the resultant image quality deteriorates. As specific examples of the compound having reactivity, difunctional compounds are disclosed therein, but it is difficult to obtain a high cross-linking density by using these compounds, and therefore the resultant photoreceptor has poor abrasion resistance.

In order to improve mechanical durability, materials used for the outermost layer must be sufficiently studied.

Even if a photoreceptor having good mechanical durability is obtained, another problem of poor image quality (such as image density unevenness) arises. When the outermost layer is formed by a cross-linking reaction upon application of heat or light energy thereto, materials composing the photoreceptor (such as a charge generation material and a charge transport material) are also influenced thereby. For example, it is known that titanyl phthalocyanine pigments, which are widely used as a charge generation material, have a deteriorated charging ability because adsorbed water desorbs therefrom due to the application of heat. It is also known that triphenylamine materials, which are widely used as a charge transport material, typically absorb short-wavelength light (such as ultraviolet ray), and thereby form complexes or get denatured. As a result, charge transport ability tends to deteriorate and a charge trap tends to be formed. Since materials composing organic photoreceptors have poor resistance to heat and light, oxidizing gas resistance tends to deteriorate and cause image density unevenness.

Image density unevenness occurs when chargeability of a photoreceptor deteriorates due to an influence of an oxidizing gas and when surface resistance of a photoreceptor decreases by accretion of an ionic material thereon. In the former case, the photoreceptor cannot be charged to a desired potential level, resulting in increasing image density in a low potential portion of the resultant image. In the latter case, an electrostatic latent image cannot be kept on the photoreceptor due to the low surface resistance thereof, resulting in deterioration of image density of the resultant image.

The mechanism of the occurrence of image density unevenness is unknown, but it may be considered as below.

The former case (i.e., deterioration of chargeability of the photoreceptor) may occur due to deterioration of the constituent material, which is caused by diffusion of an oxidizing gas produced by a charger into the inner portion of the photoreceptor. In particular, a cross-linked outermost layer is considered to have high gas permeability because the layer is contracted when cross-linked. Therefore, a photoreceptor having the cross-linked outermost layer easily causes deterioration of the constituent material compared with that formed of a thermoplastic resin.

The latter case (i.e., deterioration of surface resistance of the photoreceptor) may occur due to accretion and adsorption of an ionic material originated from an oxidizing gas produced by a charger on the surface of the photoreceptor. In this case, charges of the electrostatic latent image laterally migrate on the surface of the photoreceptor. Since a related art photoreceptor has poor mechanical durability and is easily abraded, it is easy to remove the accretion of the ionic material therefrom by applying a mechanical external force thereto using a cleaning blade. Therefore, image density unevenness rarely occurs. Even if image density unevenness occurs, it can recover in a short time. In contrast, it is difficult to remove the accretion of the ionic material from a photoreceptor having good mechanical durability because the surface thereof is hardly abraded. Therefore, image density unevenness obviously occurs and rarely recovers.

In attempting to solve the problems of the image defect, JP-A 2004-317944 discloses a photoreceptor of which a charge transport layer includes an oxidation inhibitor. JP-A 2004-240047 discloses a photoreceptor of which a cross-linked outermost layer includes an oxidation inhibitor. Whether the oxidation inhibitor functions or not depends on the added amount thereof, and therefore a large amount of the oxidation inhibitor is needed to exerts its effect. Since the oxidation inhibitor has no charge transport ability, the charge transport ability deteriorates as the added amount of the oxidation inhibitor increases. The oxidation inhibitor typically has high charge acceptability so as to interact with an oxidizing gas, etc., and therefore a material which mainly cross-links by a radial polymerization reaction tends to be prevented from cross-linking thereby. It is difficult to obtain a photoreceptor which simultaneously satisfies charge transport ability, abrasion resistance, and oxidizing gas resistance when the oxidation inhibitor is used.

A photoreceptor having a cross-linked outermost layer has good mechanical durability and abrasion resistance, and therefore it can be used for a long time. On the other hand, such a photoreceptor has a disadvantage in producing high quality images. In order to obtain a high-durable photoreceptor, it is necessary to take measures against deterioration of the constituent materials.

As a measure against deterioration of the constituent materials, an initiator which needs a smaller amount of energy may be used. For example, when a thermosetting material is used for an outermost layer, an initiator having a lower half-life temperature may be used. When a light curing material is used, an initiator having high efficiency in a lower illuminance and an initiator generating a large amount of radical under a lower exposure may be used. However, when such initiators are used, there is a problem that cross-linking density of the resultant outermost layer decreases. There is also a limitation in choosing the kind of the initiators. For these reasons, the above initiators are not widely used.

### SUMMARY

Accordingly, exemplary aspects of the present invention provide an electrophotographic photoreceptor having a good combination of a mechanical durability and an oxidizing gas resistance.

Exemplary aspects of the present invention provide an image forming apparatus and a process cartridge which can produce high quality images having high image density without causing image density unevenness for a long period of the time.

Exemplary aspects of the present invention, either individually or in combinations thereof, as hereinafter will become more readily apparent include an electrophotographic photoreceptor, including an electroconductive substrate, a photosensitive layer located overlying the electroconductive substrate, and an outermost layer located overlying the photosensitive layer. The outermost layer is formed by a reaction between a radical polymerizable compound having no charge transport structure and including a compound represented by the following formula (1),

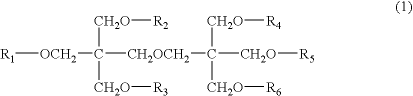

and a radical polymerizable compound having a charge transport structure, while applying at least one member selected from the group consisting of heat, light, and ionizing radiation to the reaction. At least one of the photosensitive layer and the outermost layer includes at least one member selected from (A) an arylmethane compound having an alkylamino group, (B) a compound represented by the following formula (2),

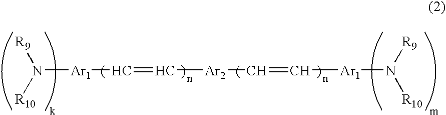

### (C) a compound represented by the following formula (3),

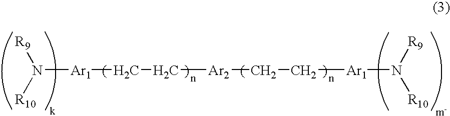

and (D) a compound represented by the following formula (4):

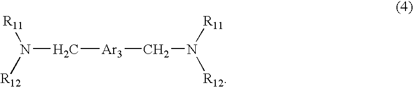

Each of R₁, R₂, R₃, R₄, R₅, and R₆ independently represents a hydrogen atom or a group represented by the following formula:

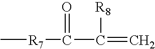

R₇ represents a single bond, an alkylene group, an alkylene ether group, a polyoxyalkylene group, an alkylene ether group substituted with a hydroxyl group, an alkylene ether group substituted with a (meth)acryloyloxy group, an oxyalkylene carbonyl group, or a poly(oxyalkylene carbonyl) group; and R₈ represents a hydrogen atom or a methyl group,

Four or more of R₁, R₂, R₃, R₄, R₅, and R₆ do not simultaneously represent hydrogen atoms:

Each of R₉ and R₁₀ independently represents a substituted or unsubstituted aryl group or a substituted or unsubstituted alkyl group. R₉ and R₁₀ optionally share bond connectivity to form a heterocyclic group containing a nitrogen atom. Each of Ar₁ and Ar₂ independently represents a substituted or unsubstituted aryl group. Each of k and m independently represents an integer of from 0 to 3, wherein both of k and m does not simultaneously represent 0; and n represents an integer of from 1 to 3.

Each of R₁₁ and R₁₂ independently represents a substituted or unsubstituted alkyl group or a substituted or unsubstituted aryl group, wherein at least one of R₁₁ and R₁₂ is a substituted or unsubstituted aryl group, and wherein R₁₁ and R₁₂ optionally share bond connectivity to form a substituted or unsubstituted heterocyclic group containing a nitrogen atom. Ar₃ represents a substituted or unsubstituted aryl group.

Exemplary aspects of the invention include an image forming apparatus and a process cartridge using the electrophotographic photoreceptor.

### BRIEF DESCRIPTION OF THE DRAWINGS

These and other objects, features and advantages of the exemplary embodiments of the present invention will become apparent upon consideration of the following description of the exemplary embodiments of the present invention taken in conjunction with the accompanying drawings, wherein:

FIGS. 1 to 3 are schematic views illustrating cross-sections of exemplary embodiments of an electrophotographic photoreceptor of the present invention;

FIG. 4 is a schematic view illustrating an exemplary embodiment of an image forming apparatus of the present invention; and

FIG. 5 is a schematic view illustrating an exemplary embodiment of a process cartridge of the present invention.

### DETAILED DESCRIPTION OF THE INVENTION

The surface of a photoreceptor can be prevented from being abraded or scratched even after a long repeated use when mechanical strengths (such as hardness and elastic power) thereof are large. Various attempts have been made to increase the mechanical strengths. It is generally known that a cross-linking material, which binds molecules with each other, can increase mechanical strength. The cross-linking material can exert various effects by changing the structure of the functional group, the molecular structure, and the number of the functional groups, etc. Since the cross-linking material can be molecular-designed so as to improve not only mechanical strength but also electrical properties of the resultant photoreceptor, such materials have been widely used for electrophotographic photoreceptors.

A photoreceptor having an outermost layer formed from a cross-linking material has excellent mechanical durability, and thereby occurrence of image defects, which are caused when the photoreceptor is abraded or scratched, can be largely decreased. When the cross-linking material is cross-linked upon application of energy (such as heat and light), materials constituting a photosensitive layer tend to deteriorate thereby. As a result, electrical properties and oxidizing gas resistance deteriorate and image density unevenness is caused in the resultant image.

It is generally considered that the image density unevenness is caused by deterioration of the surface resistance or the bulk resistance of the photoreceptor, which is caused by accretion or adsorption of an oxidizing gas, such as NOx produced by an electric discharge of a charger and an ionic material produced from the reaction of the oxidizing gas with other compounds. Since related art photoreceptors have poor mechanical durability, the surface thereof can be easily refaced by applying a mechanical external force using a cleaning blade. Therefore, even if image density unevenness occurs, it can recover in a short time.

A photoreceptor having an outermost layer which has good mechanical durability is hardly abraded or scratched for a long period of the time even if a mechanical external force is applied thereto. On the other hand, it is difficult to remove an oxidizing gas and an ionic material present thereon, and the resultant image quality tends to deteriorate.

In order to address the above problems, exemplary aspects of the present invention generally provide an electrophotographic photoreceptor including an electroconductive substrate, a photosensitive layer located overlying the electroconductive substrate, and an outermost layer located overlying the photosensitive layer. The outermost layer is formed by a reaction between a radical polymerizable compound having no charge transport structure and includes a compound represented by the formula (1), and a radical polymerizable compound having a charge transport structure, while applying at least one member selected from the group consisting of heat, light, and ionizing radiation to the reaction. At least one of the photosensitive layer and the outermost layer includes at least one member selected from (A) an arylmethane compound having an alkylamino group, (B) a compound represented by the formula (2), (C) a compound represented by the formula (3), and (D) a compound represented by the formula (4).

### Composition of Photoreceptor

A photoreceptor of an exemplary embodiment of the present invention is a multi-layered photoreceptor including an electroconductive substrate, and a photosensitive layer and an outermost layer overlaid on the electroconductive substrate in this order. The photosensitive layer may be either a single-layered or multi-layered so long as having a charge generation mechanism and a charge transport mechanism.

Within the context of the present invention, if a first layer is stated to be “overlaid” on, or “overlying” a second layer, the first layer may be in direct contact with the second layer, or there may be one or more intervening layers between the first and second layer, with the second layer being closer to the substrate than the first layer.

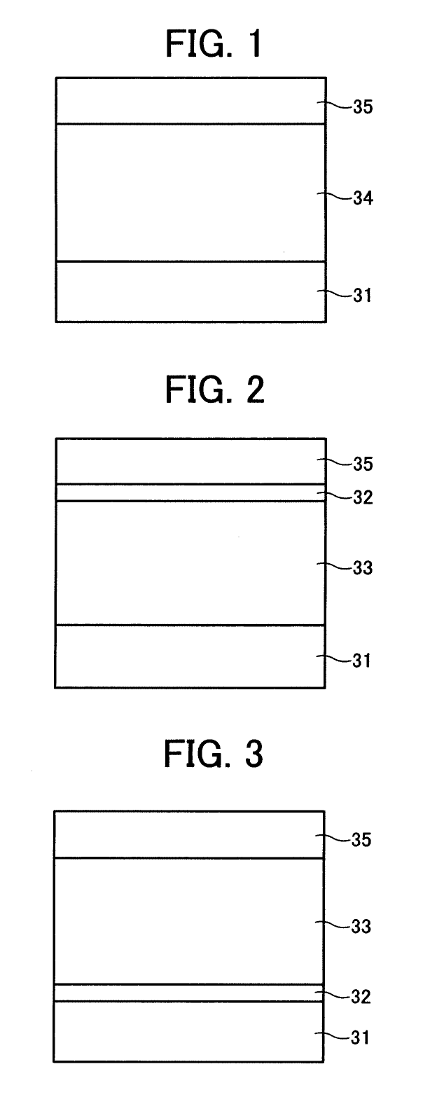

FIG. 1 is a cross-sectional view illustrating an exemplary embodiment of the photoreceptor of the present invention having a single-layered photosensitive layer. This photoreceptor includes an electroconductive substrate 31, a photosensitive layer 34 overlaid on the electroconductive substrate 31 and including a charge generation material and a charge transport material, and an outermost layer 35 overlaid on the photosensitive layer 34. The outermost layer 35 represents the after-mentioned cross-linked outermost layer.

FIGS. 2 and 3 are cross-sectional views illustrating exemplary embodiments of the photoreceptor of the present invention having a multi-layered photosensitive layer. Each of these photoreceptors includes an electroconductive substrate 31; a charge generation layer 32 and a charge transport layer 33 overlaid on the electroconductive substrate 31; and an outermost layer 35. The charge generation layer 32 and the charge transport layer 33 may be either overlaid on the electroconductive substrate 31 in this order (i.e., FIG. 3) or the reverse order (i.e., FIG. 2).

### Functional Additive

The photosensitive layer and/or the outermost layer of the photoreceptor of the exemplary embodiment of the present invention includes at least one member selected from:

### (A) an arylmethane compound having an alkylamino group;

### (B) a compound represented by the formula (2);

### (C) a compound represented by the formula (3); and

### (D) a compound represented by the formula (4).

The above compounds can impart oxidizing gas resistance to the resultant photoreceptor without causing deterioration of charge transport ability, inhibition of cross-linking, and decrease of hardness, which tend to be caused when an oxidation inhibitor is used.

### (A) Arylmethane Compound Having Alkylamino Group

Specific examples of the arylmethane compounds having an alkylamino group include the following compounds represented by the formulae (5) to (8).

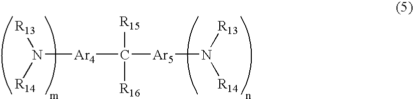

Each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom. Each of R₁₅ and R₁₆ independently represents a hydrogen atom, a substituted or unsubstituted alkyl group having 1 to 11 carbon atoms, or a substituted or unsubstituted aryl group. Each of Ar₄ and Ar₅ independently represents a substituted or unsubstituted aryl group. Each of m and n independently represents an integer of from 0 to 3, wherein both of m and n does not simultaneously represent 0.

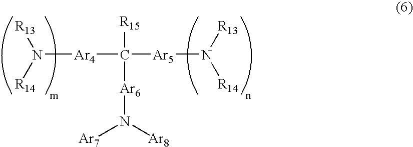

Each of R₁₃ and R₁₄ independently represents an alkyl group having 1 to 4 carbon atoms which may be substituted with an aryl group. R₁₃ and R₁₄ optionally share bond connectivity to form a heterocyclic group containing a nitrogen atom. R₁₅ represents a hydrogen atom, a substituted or unsubstituted alkyl group having 1 to 11 carbon atoms, or a substituted or unsubstituted aryl group. Each of Ar₄, Ar₅, Ar₆, Ar₇, and Ar₈ independently represents a substituted or unsubstituted aryl group, wherein Ar₇ optionally shares bond connectivity with Ar₆ or Ar₈ to form a heterocyclic group containing a nitrogen atom. Each of m and n independently represents an integer of from 0 to 3, wherein both of m and n does not simultaneously represent 0.

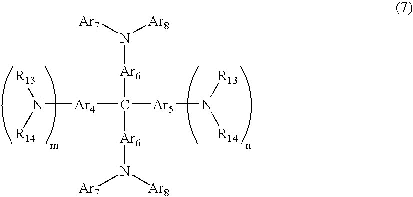

Each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom. Each of Ar₄, Ar₅, Ar₆, Ar₇, and Ar₈ independently represents a substituted or unsubstituted aryl group, wherein Ar₇ optionally shares bond connectivity with Ar₆ or Ar₈ to form a heterocyclic group containing a nitrogen atom. Each of m and n independently represents an integer of from 0 to 3, wherein both of m and n does not simultaneously represent 0.

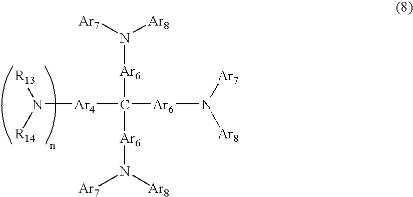

Each of R₁₃ and R₁₄ independently represents an alkyl group having 1 to 4 carbon atoms which may be substituted with an aryl group. R₁₃ and R₁₄ optionally share bond connectivity to form a heterocyclic group containing a nitrogen atom. Each of Ar₄, Ar₆, Ar₇, and Ar₈ independently represents a substituted or unsubstituted aryl group. Ar₇ optionally shares bond connectivity with Ar₆ or Ar₈ to form a heterocyclic group containing a nitrogen atom. n represents an integer of from 1 to 3.

The arylmethane compound having an alkylamino group can reduce the likelihood or prevent occurrence of image density unevenness. It is considered that the amino groups substituted with R₁₃ and R₁₄ can effectively reduce the likelihood or prevent the oxidizing gas from producing a radical substance. Since the compounds represented by the formulae (5) to (8) have a charge transport structure, charges are not trapped therein, and therefore deterioration of electric property (such as increase of residual potential) hardly occurs.

Specific examples of the alkyl groups represented by R₁₃ and R₁₄ include, but are not limited to, methyl group, ethyl group, propyl group, and butyl group. Specific examples of the aryl groups included in R₁₃ and R₁₄ and represented by Ar₄ to Ar₈ include, but are not limited to, aromatic hydrocarbon groups derived from aromatic hydrocarbon rings (e.g., benzene, naphthalene, anthracene, pyrene) having 1 to 6 valences; and aromatic heterocyclic groups derived from aromatic heterocyclic rings (e.g., pyridine, quinoline, thiophene, furan, oxazole, oxadiazole, carbazole) having 1 to 6 valences. Specific examples of the substituent groups thereof include, but are not limited to, alkyl groups (e.g., methyl group, ethyl group, propyl group, butyl group), alkoxy groups (e.g., methoxy group, ethoxy group, propoxy group, butoxy group), halogen atoms (e.g., fluorine atom, chlorine atom, bromine atom, iodine atom), and aryl groups. Specific examples of the heterocyclic groups containing a nitrogen atom formed of R₁₃ and R₁₄ include, but are not limited to, pyrrolidinyl group, piperidinyl group, and pyrrolinyl group. Specific examples of the heterocyclic groups containing a nitrogen atom formed of combinations of Ar₆ and Ar₇, or Ar₇ and Ar₈ include, but are not limited to, aromatic heterocyclic groups derived from N-methyl carbazole, N-ethyl carbazole, N-phenyl carbazole, indole, and quinoline.

Specific preferred examples of suitable compounds represented by the formulae (5), (6), (7), and (8) include the following compounds shown in Tables 1, 2, 3, and 4, respectively, but are not limited thereto.

TABLE 1

| Formula | No. |
|---|---|
| 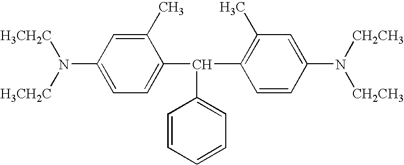 | (5-1) |
| 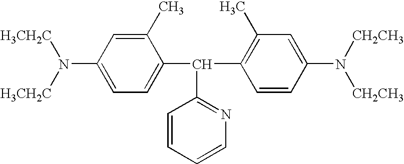 | (5-2) |
| 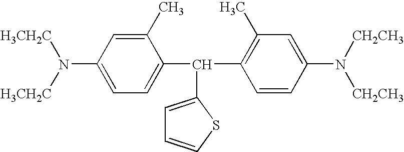 | (5-3) |
| 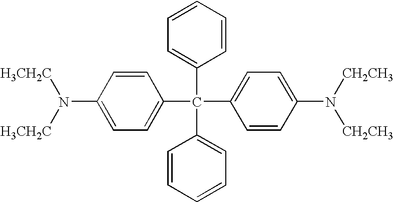 | (5-4) |
| 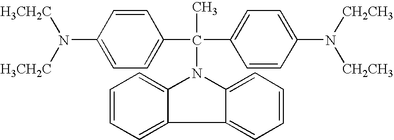 | (5-5) |
| 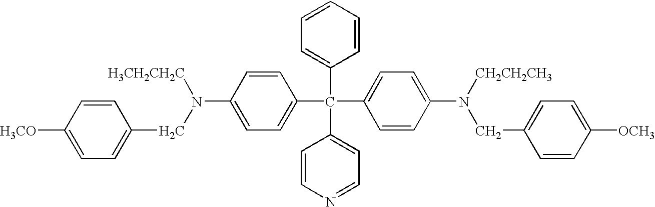 | (5-6) |

TABLE 2

| Formula | No. |
|---|---|
| 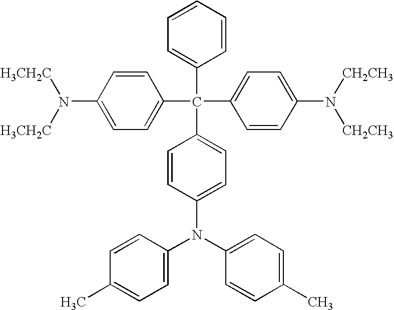 | (6-1) |
| 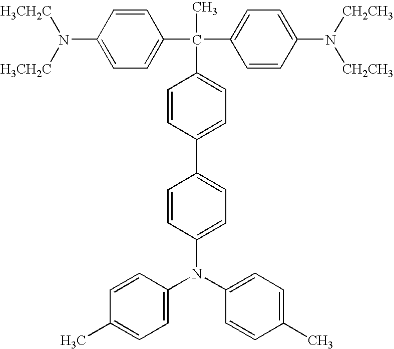 | (6-2) |
| 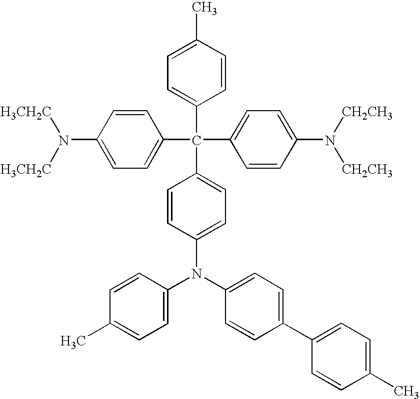 | (6-3) |
| 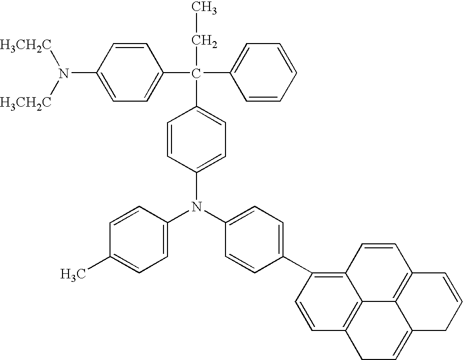 | (6-4) |
| 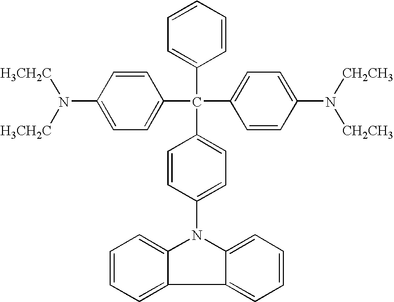 | (6-5) |
| 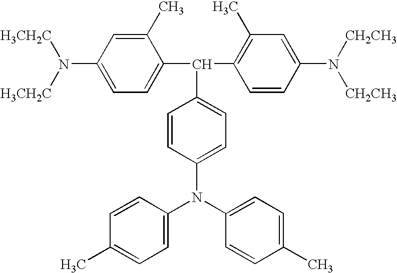 | (6-6) |
| 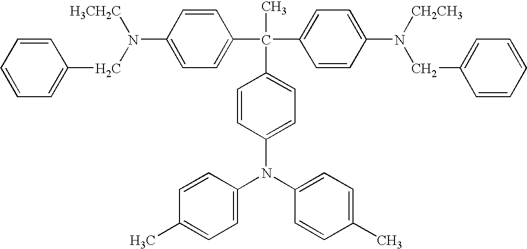 | (6-7) |

TABLE 3

| Formula | No. |
|---|---|
| 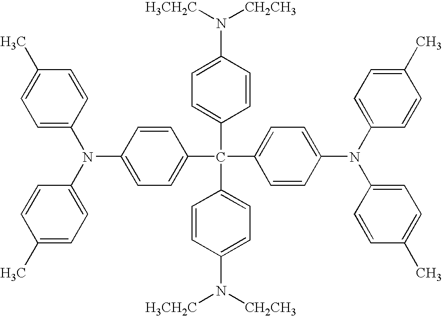 | (7-1) |
| 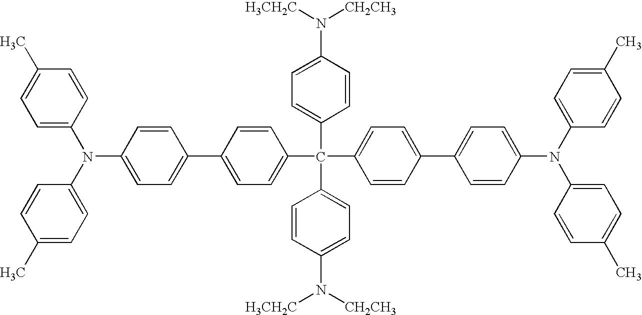 | (7-2) |
| 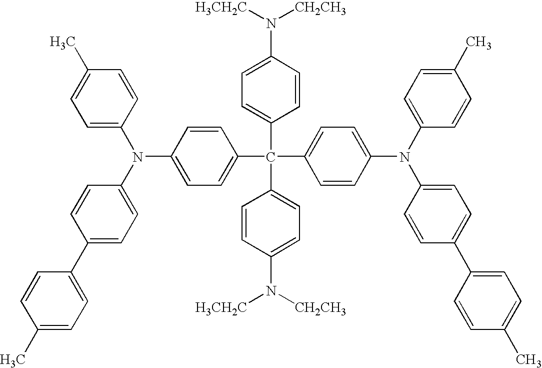 | (7-3) |
| 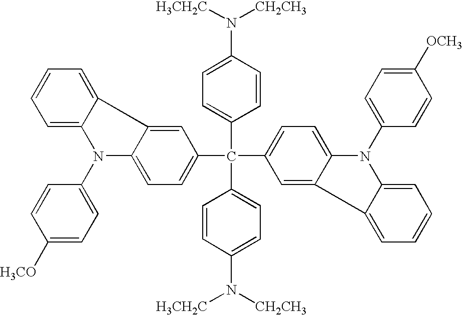 | (7-4) |
| 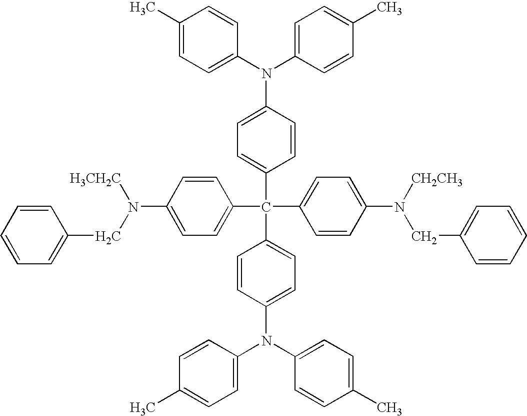 | (7-5) |

TABLE 4

| Formula | No. |
|---|---|
| 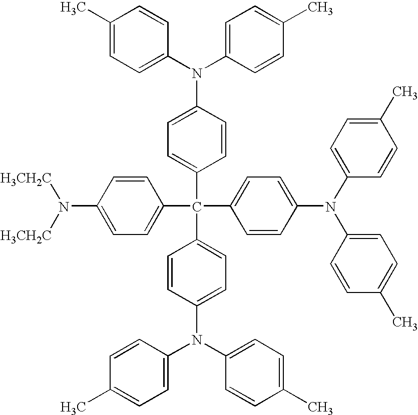 | (8-1) |
| 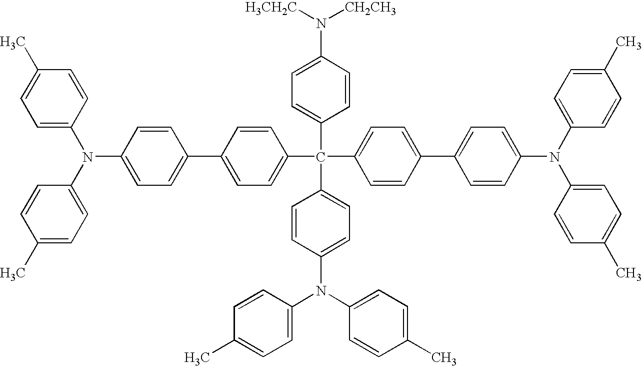 | (8-2) |
| 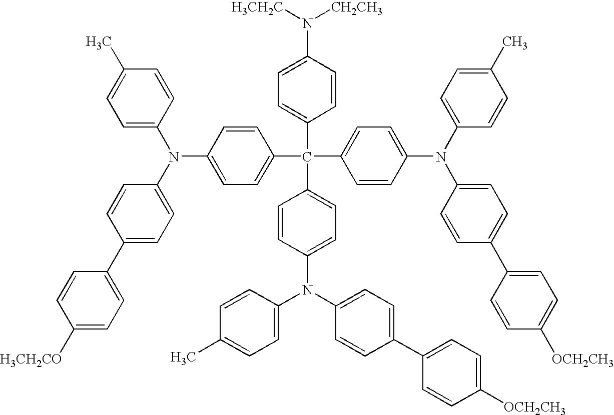 | (8-3) |
| 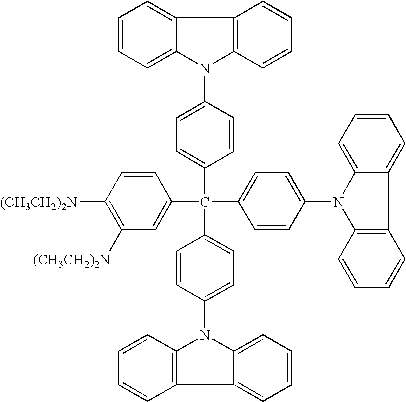 | (8-4) |
| 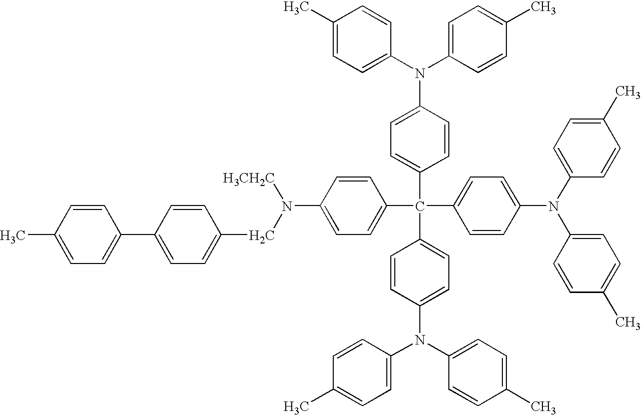 | (8-5) |

### (B) (C) Compounds Represented by Formulae (2) and (3)

The compounds represented by the formulae (2) and (3) can reduce the likelihood or prevent the occurrence of image density unevenness. It is considered that the amino groups substituted with R₉ and R₁₀ can reduce the likelihood or prevent the oxidizing gas from producing a radical substance. Since the compounds represented by the formulae (2) and (3) have a charge transport structure, charges are not trapped therein, and therefore deterioration of electric property (such as increase of residual potential) hardly occurs.

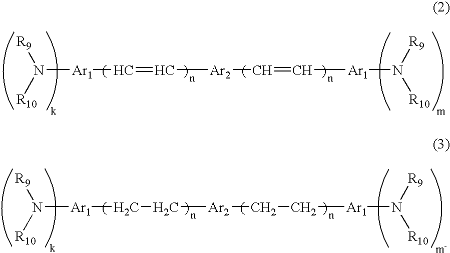

Each of R₉ and R₁₀ independently represents a substituted or unsubstituted aryl group or a substituted or unsubstituted alkyl group, R₉ and R₁₀ optionally share bond connectivity to form a heterocyclic group containing a nitrogen atom. Each of Ar₁ and Ar₂ independently represents a substituted or unsubstituted aryl group. Each of k and m independently represents an integer of from 0 to 3. Both of k and m does not simultaneously represent 0 and n represents an integer of from 1 to 3.

Specific examples of the aryl groups represented by R₉ and R₁₀ include, but are not limited to, aromatic hydrocarbon groups derived from aromatic hydrocarbon rings, such as benzene, naphthalene, anthracene, and pyrene. Specific examples of the alkyl groups represented by R₉ and R₁₀ include, but are not limited to, methyl group, ethyl group, propyl group, butyl group, hexyl group, and undecanyl group. Among these, alkyl groups having 1 to 4 carbon atoms may be used. Specific examples of the aryl groups represented by Ar₁ and Ar₂ include, but are not limited to, aromatic hydrocarbon groups derived from aromatic hydrocarbon rings (e.g., benzene, naphthalene, anthracene, pyrene) having 1 to 4 valences; and aromatic heterocyclic groups derived from aromatic heterocyclic rings (e.g., pyridine, quinoline, thiophene, furan, oxazole, oxadiazole, carbazole) having 1 to 4 valences. Specific examples of the substituent groups thereof include, but are not limited to, alkyl groups (e.g., methyl group, ethyl group, propyl group, butyl group, hexyl group, undecanyl group), alkoxy groups (e.g., methoxy group, ethoxy group, propoxy group, butoxy group), halogen atoms (e.g., fluorine atom, chlorine atom, bromine atom, iodine atom), and aryl groups. Specific examples of the heterocyclic group containing a nitrogen atom formed of R₉ and R₁₀ include, but are not limited to, pyrrolidinyl group, piperidinyl group, pyrrolinyl group, and aromatic heterocyclic group derived from N-methyl carbazole, N-ethyl carbazole, N-phenyl carbazole, indole, and quinoline.

Specific examples of suitable compounds represented by the formulae (2) and (3) include the following compounds shown in Tables 5 and 6, respectively, but are not limited thereto.

The compounds represented by the formulae (2) and (3) further include compounds disclosed in published examined Japanese patent application No. (hereinafter referred to as JP-B) 58-57739 and JP 2529299. The compound represented by the formula (2) can be prepared by so-called Wittig reaction or Wittig-Horner reaction in which a triphenyl phosphonium salt or a phosphonic acid ester, respectively, is reacted with an aldehyde. The compound represented by the formula (3) can be prepared by reduction of the compound represented by the formula (2).

TABLE 5

| Formula | No. |
|---|---|
| 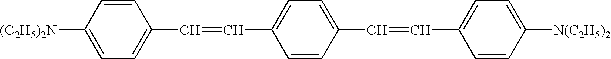 | (2-1) |
| 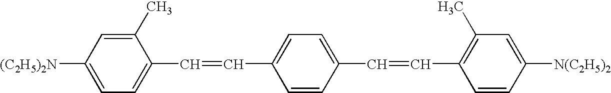 | (2-2) |
| 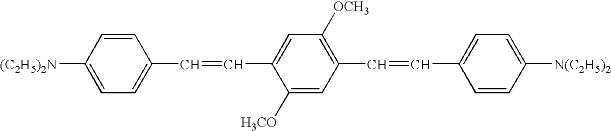 | (2-3) |
| 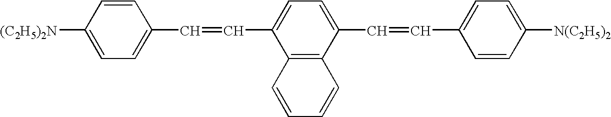 | (2-4) |
| 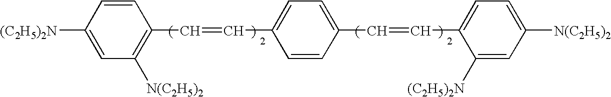 | (2-5) |
| 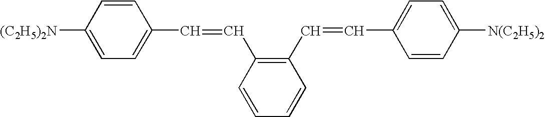 | (2-6) |
| 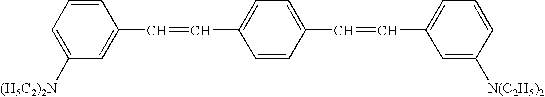 | (2-7) |
| 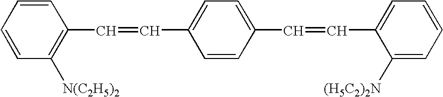 | (2-8) |
| 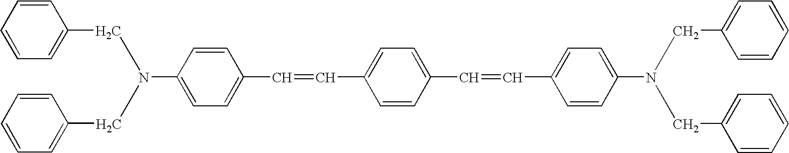 | (2-9) |
| 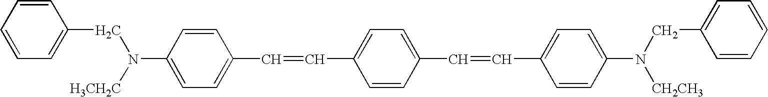 | (2-10) |
| 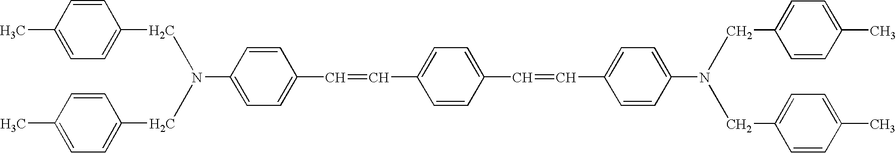 | (2-11) |
| 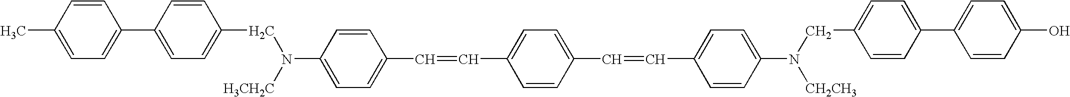 | (2-12) |
| 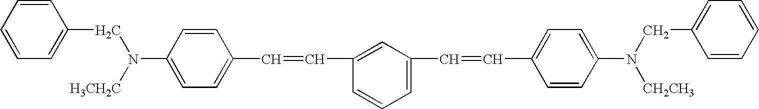 | (2-13) |
| 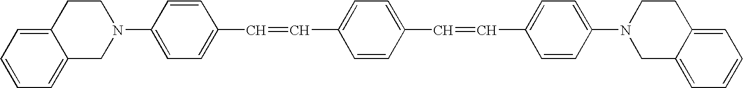 | (2-14) |
| 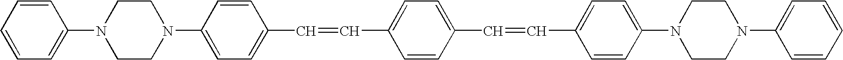 | (2-15) |

TABLE 6

| Formula | No. |
|---|---|
| 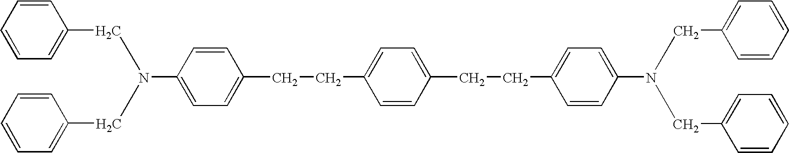 | (3-1) |
| 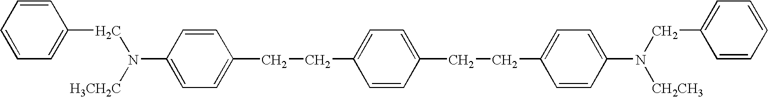 | (3-2) |
| 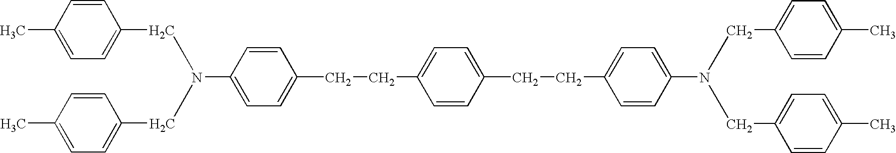 | (3-3) |
| 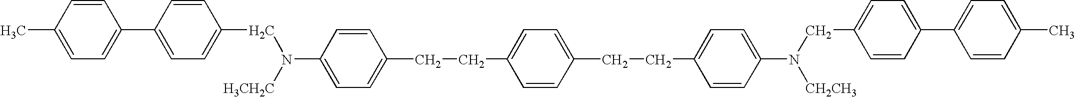 | (3-4) |
| 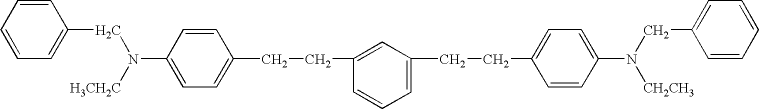 | (3-5) |
| 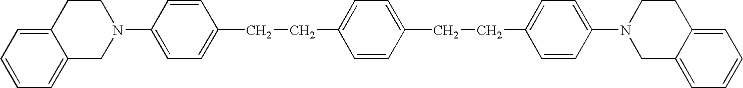 | (3-6) |
| 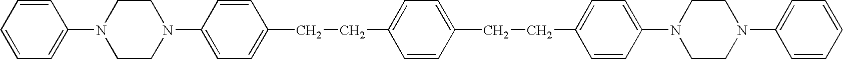 | (3-7) |
| 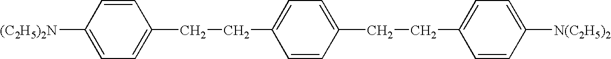 | (3-8) |
| 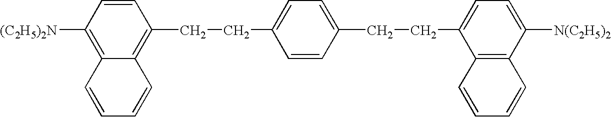 | (3-9) |
| 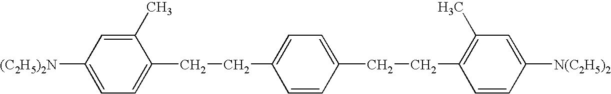 | (3-10) |
| 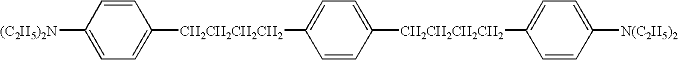 | (3-11) |
| 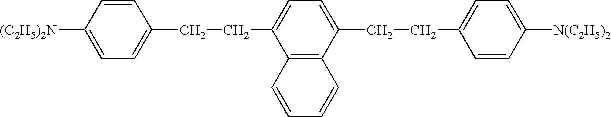 | (3-12) |
| 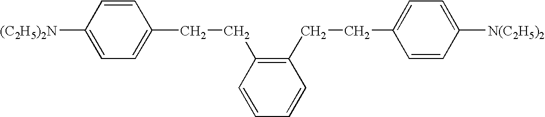 | (3-13) |
| 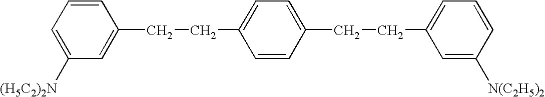 | (3-14) |
| 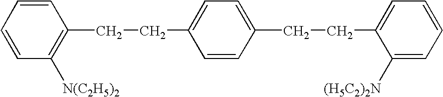 | (3-15) |

### (D) Compound Represented by Formula (4)

Diamine compounds represented by the formula (4) are disclosed in JP-B 62-13382, and U.S. Pat. Nos. 4,223,144, 3,271,383, and 3,291,788 as an intermediate of a dye or a precursor of a polymer.

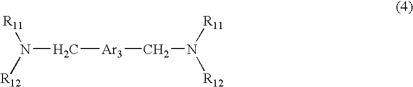

Each of R₁₁ and R₁₂ independently represents a substituted or unsubstituted alkyl group or a substituted or unsubstituted aryl group. At least one of R₁₁ and R₁₂ is a substituted or unsubstituted aryl group. R₁₁ and R₁₂ optionally share bond connectivity to form a substituted or unsubstituted heterocyclic group containing a nitrogen atom. Ar₃ represents a substituted or unsubstituted aryl group.

When a photoreceptor includes such a compound, the resultant image quality is maintained in good level even after the photoreceptor is repeatedly used. The mechanism is considered as follows. Because an alkylamino group included in the compound has strong basic properties, an oxidizing gas and an ionic substance which are considered to cause image density unevenness can be neutralized thereby. Further, the diamine compound used for exemplary embodiments of the present invention has good charge transport ability because of having an amino group substituted with an aryl group, which is known as a functional group having good charge transport ability (described in a technical document “Guiding concept for developing better charge transporting organic materials”, Takahashi et al., Electrophotography (DENSHISHY ASHIN GAKKAISHI), Vol. 25, No. 3, p. 16 (1983)). In addition, when a photoreceptor includes the diamine compounds together with another charge transport material, the photoreceptor has better sensitivity and stability even after repeated use.

The diamine compound represented by the formula (4) can be easily prepared by the method described in a technical document “A new synthesis of bisbenzils and novel poly(phenylquinoxaline)s therefrom”, E. Elce and A. S. Hay, Polymer, Vol. 37, No. 9, 1745 (1996). Specifically, a dihalogen compound represented by the following formula (12) is reacted with a secondary amine compound represented by the following formula (13) in the presence of a basic compound at a temperature of from room temperature to about 100° C.:

BH₂C—Ar₃CH₂B (12)

Ar₃ represents a substituted or unsubstituted aryl group and B represents a halogen atom.

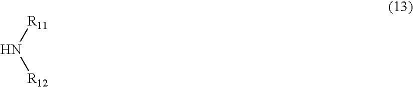

Each of R₁₁ and R₁₂ independently represents a substituted or unsubstituted alkyl group or a substituted or unsubstituted aryl group. At least one of R₁₁ and R₁₂ is a substituted or unsubstituted aryl group, and wherein R₁₁ and R₁₂ optionally share bond connectivity to form a substituted or unsubstituted heterocyclic group containing a nitrogen atom.

Specific examples of the basic compounds include, but are not limited to, potassium carbonate, sodium carbonate, potassium hydroxide, sodium hydroxide, sodium hydride, sodium methylate, and potassium t-butoxide. Specific examples of the reaction solvents include, but are not limited to, dioxane, tetrahydrofuran, toluene, xylene, dimethyl sulfoxide, N,N-dimethyl formamide, N-methylpyrrolidone, 1,3-dimethyl-2-imidazolidinone, and acetonitrile.

Specific examples of the alkyl groups represented by R₁₁ and R₁₂ included in the formulae (4) and (13) include, but are not limited to, methyl group, ethyl group, propyl group, butyl group, hexyl group, and undecanyl group. Specific examples of the aromatic group represented by R₁₁, R₁₂, and Ar₃ included in the formulae (4) and (12) include, but are not limited to, aromatic hydrocarbon groups derived from aromatic hydrocarbon rings such as benzene, biphenyl, naphthalene, anthracene, fluorene, and pyrene; and aromatic heterocyclic groups derived from aromatic heterocyclic rings such as pyridine, quinoline, thiophene, furan, oxazole, oxadiazole, and carbazole. Specific examples of the substituent groups thereof include, but are not limited to, alkyl groups (e.g., methyl group, ethyl group, propyl group, butyl group, hexyl group, undecanyl group), alkoxy groups (e.g., methoxy group, ethoxy group, propoxy group, butoxy group), halogen atoms (e.g., fluorine atom, chlorine atom, bromine atom, iodine atom), aryl groups, and heterocyclic groups derived from heterocyclic rings such as pyrrolidine, piperidine, and piperazine. Specific examples of the heterocyclic group containing a nitrogen atom formed of R₁₁ and R₁₂ include, but are not limited to, condensed heterocyclic groups to which an aryl group is bound to heterocyclic groups, such as pyrrolidinyl group, piperidinyl group, and pyrrolinyl group.

Specific preferred examples of suitable compounds represented by the formula (4) include the following compounds shown in Table 7, but are not limited thereto.

TABLE 7

| Formula | | | |
|---|---|---|---|
| Ar₃ | R₁₁ | R₁₂ | No. |
| 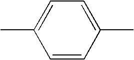 | —CH₃ | 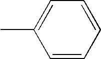 | (4-1) |
| 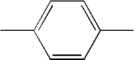 | —CH₂CH₃ | 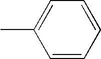 | (4-2) |
| 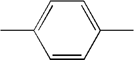 | —CH₃ | 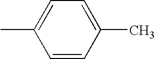 | (4-3) |
| 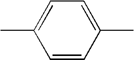 | —CH₂CH₃ | 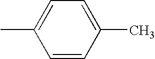 | (4-4) |
| 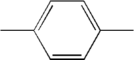 | —CH₂CH₂CH₃ | 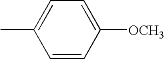 | (4-5) |
| 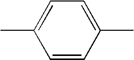 | —CH₂CH₃ | 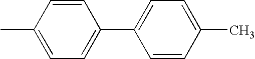 | (4-6) |
| 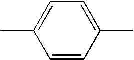 | 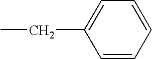 | 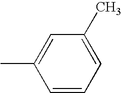 | (4-7) |
| 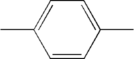 | 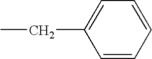 | 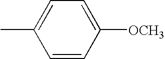 | (4-8) |
| 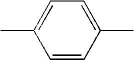 | 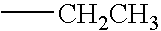 | 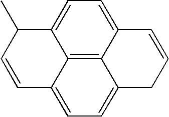 | (4-9) |
| 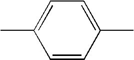 | 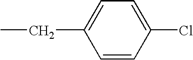 | 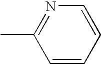 | (4-10) |
| 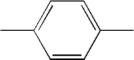 | —CH₂CH₃ | 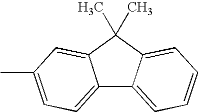 | (4-11) |
| 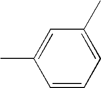 | —CH₂CH₃ | 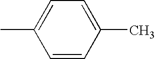 | (4-12) |
| 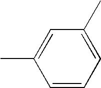 | 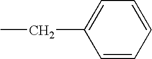 | 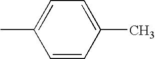 | (4-13) |
| 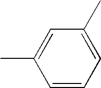 | 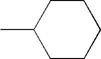 | 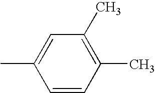 | (4-14) |
| 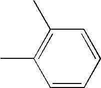 | —CH₂CH₃ | 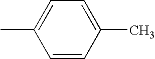 | (4-15) |
| 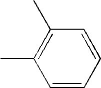 | —CH₃ | 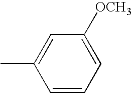 | (4-16) |
| 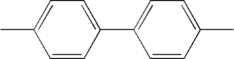 | —CH₂CH₃ | 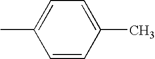 | (4-17) |
| 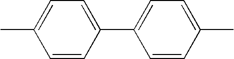 | 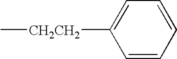 | 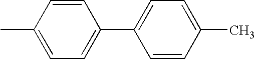 | (4-18) |
| 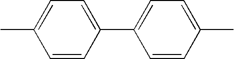 | —CH₃ | 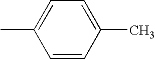 | (4-19) |
| 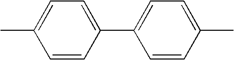 | —CH₂CH₃ | 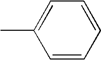 | (4-20) |
| 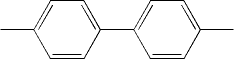 | 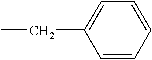 | 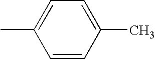 | (4-21) |
| 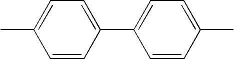 | 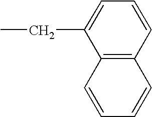 | 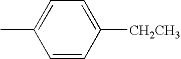 | (4-22) |
| 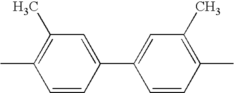 | —CH₂CH₃ | 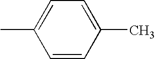 | (4-23) |
| 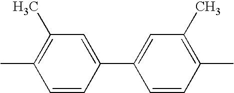 | 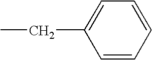 | 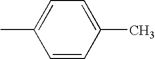 | (4-24) |
| 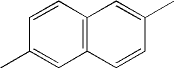 | —CH₂CH₃ | 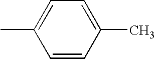 | (4-25) |
| 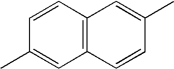 | —CH₃ | 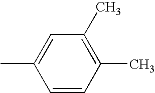 | (4-26) |
| 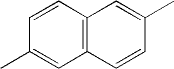 | 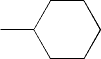 | 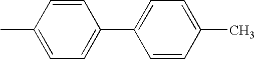 | (4-27) |
| 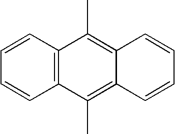 | —CH₂CH₃ | 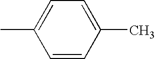 | (4-28) |
| 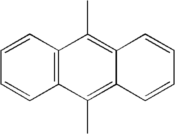 | —CH₃ | | (4-29) |
| 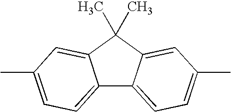 | —CH₂CH₃ | 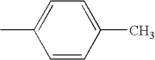 | (4-30) |
| 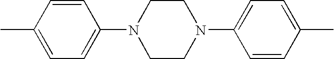 | —CH₂CH₃ | 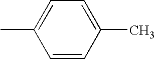 | (4-31) |
| 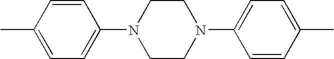 | —CH₂CH₃ | 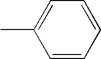 | (4-32) |
| 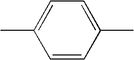 | —CH₂CH₃ | 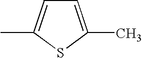 | (4-33) |
| 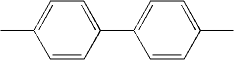 | 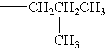 | 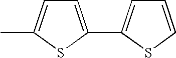 | (4-34) |

| | | |
|---|---|---|
| 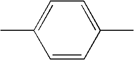 | 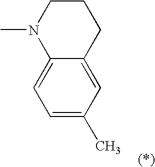 | (4-35) |
| 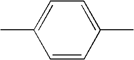 | 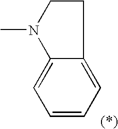 | (4-36) |
| 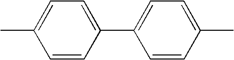 | 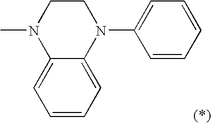 | (4-37) |

(*) —NR₁₁R₁₂

The above-mentioned compounds (i.e., (A) an arylmethane compound having an alkylamino group; (B) a compound represented by the formula (2); (C) a compound represented by the formula (3); and (D) a compound represented by the formula (4)) can be added to either or both of the photosensitive layer and the outermost layer. When the photosensitive layer includes the charge generation layer and the charge transport layer, the above-mentioned compounds can be added to either or both thereof.

The layer may include the compound in an amount of from 0.01 to 150% by weight based on total weight of the layer, but the amount is not limited thereto as long as the photoreceptor has good electric and mechanical properties. When the amount is too small, the resultant photoreceptor does not have sufficient oxidizing gas resistance. When the amount is too large, the resultant photoreceptor has sufficient oxidizing gas resistance, but does not have sufficient oxidizing gas resistance.

### Outermost Layer

### Radical Polymerizable Compound Having No Charge Transport Structure

The radical polymerizable compound having no charge transport structure for use in exemplary embodiments of the present invention is represented by the formula (1).

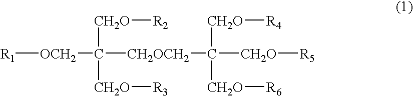

Each of R₁, R₂, R₃, R₄, R₅, and R₆ independently represents a hydrogen atom or a group represented by the following formula:

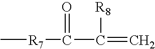

R₇ represents a single bond, an alkylene group, an alkylene ether group, a polyoxyalkylene group, an alkylene ether group substituted with a hydroxyl group, an alkylene ether group substituted with a (meth)acryloyloxy group, an oxyalkylene carbonyl group, or a poly(oxyalkylene carbonyl) group; and R₈ represents a hydrogen atom or a methyl group. Four or more of R₁, R₂, R₃, R₄, R₅, and R₆ do not simultaneously represent hydrogen atoms. R₇ is preferably a single bond or an alkylene ether group substituted with a hydroxyl group.

A compound having 5 or more acryloyloxy or methacryloyloxy groups as radical polymerizable functional groups may be used.

A compound having 5 or more acryloyloxy groups can be prepared by subjecting a compound having 5 or more hydroxyl group and a member selected from an acrylic acid, an acrylate, an acrylic halide, and an acrylic ester to an esterification reaction or an interesterification reaction. A compound having 5 or more methacryloyloxy groups can be prepared in the same manner. Each of the 5 or more radial polymerizable groups may be the same or different.

Specific examples of suitable combinations of R₁, R₂, R₃, R₄, R₅, and R₆ of the compound represented by the formula (1) include, but are not limited to, the following combinations:

(a) 3 acryloyloxy groups and 3 hydrogen groups;

(b) 4 acryloyloxy groups and 2 hydrogen groups;

(c) 5 acryloyloxy groups and 1 hydrogen group;

(d) 6 acryloyloxy groups;

(e) 3 methacryloyloxy groups and 3 hydrogen groups;

(f) 4 methacryloyloxy groups and 2 hydrogen groups;

(g) 5 methacryloyloxy groups and 1 hydrogen group; and

(h) 6 methacryloyloxy groups.

In particular, specific examples of suitable compounds represented by the formula (1) include the following compounds shown in Table 8, but are not limited thereto.

TABLE 8

| Formula | No. |
|---|---|
| 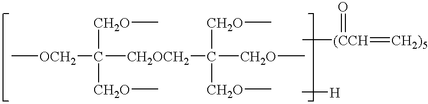 | (1-1) |
| 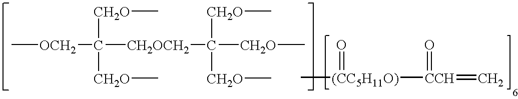 | (1-2) |
| 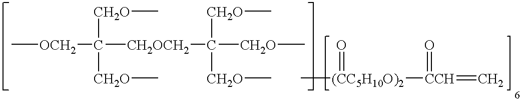 | (1-3) |
| 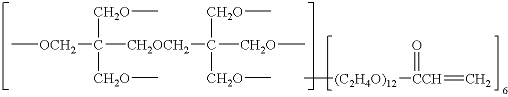 | (1-4) |
| 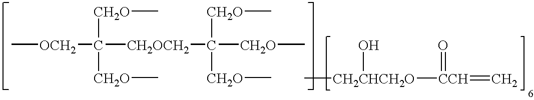 | (1-5) |
| 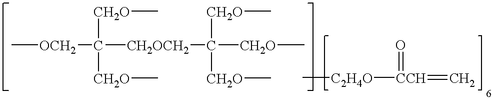 | (1-6) |
| 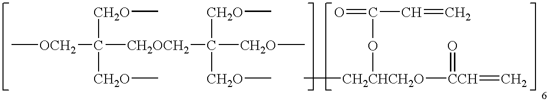 | (1-7) |
| 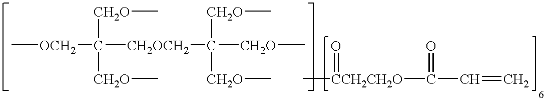 | (1-8) |
| 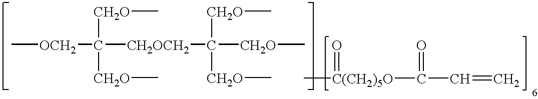 | (1-9) |

These compounds can be used alone or in combination.

These compounds can be prepared by esterification of polyols, and this method has high yield, low manufacturing cost, and high manufacturability. When 2 to 4 of the compounds are used in combination and a compound having 6 radical polymerizable functional groups is included therein, a mixture of a compound having 6 radical polymerizable functional groups which are esterified and a compound having 5 radical polymerizable functional groups and 1 hydrogen group which is unesterified may be used, because of high yield thereof. The mixture may include the compound having 6 radical polymerizable functional groups in an amount of from 20 to 99% by weight, more preferably from 30 to 97% by weight, and much more preferably from 40 to 95% by weight. When the compound having 5 radical polymerizable functional groups is used, the mixture may include the compound in an amount of from 20 to 99% by weight, more preferably from 30 to 97% by weight, and much more preferably from 40 to 95% by weight. When the compound having 4 radical polymerizable functional groups is used, the mixture may include the compound in an amount of from 0.01 to 30% by weight, more preferably from 0.1 to 20% by weight, and much more preferably from 3 to 5% by weight. When the compound having 3 radical polymerizable functional groups is used, the mixture may include the compound in an amount of from 0.01 to 30% by weight, more preferably from 0.1 to 20% by weight, and much more preferably from 3 to 5% by weight.

Specific examples of the mixtures of the above compounds include, but are not limited to, the following mixtures.

(a) A mixture of a compound having 6 acryloyloxy groups in an amount of from 30 to 70% by weight, and preferably from 40 to 60% by weight; and a compound having 5 acryloyloxy groups and 1 hydrogen group in an amount of from 30 to 70% by weight, and preferably from 40 to 60% by weight.

(b) A mixture of a compound having 6 acryloyloxy groups in an amount of from 30 to 65% by weight, and preferably from 40 to 55% by weight; a compound having 5 acryloyloxy groups and 1 hydrogen group in an amount of from 30 to 65% by weight, and preferably from 40 to 55% by weight; and at least one compound selected from the following compounds (i) to (iv) in an amount of from 0.01 to 5% by weight, preferably from 1 to 3% by weight:

(i) a compound having 1 acryloyloxy group and 5 hydrogen groups;

(ii) a compound having 2 acryloyloxy groups and 4 hydrogen groups;

(iii) a compound having 3 acryloyloxy groups and 3 hydrogen groups; and

(iv) a compound having 4 acryloyloxy groups and 2 hydrogen groups.

(c) A mixture of a compound having 6 methacryloyloxy groups in an amount of from 30 to 70% by weight, and preferably from 40 to 60% by weight; and a compound having 5 methacryloyloxy groups and 1 hydrogen group in an amount of from 30 to 70% by weight, and preferably from 40 to 60% by weight.

(b) A mixture of a compound having 6 methacryloyloxy groups in an amount of from 30 to 65% by weight, and preferably from 40 to 55% by weight; a compound having 5 methacryloyloxy groups and 1 hydrogen group in an amount of from 30 to 65% by weight, and preferably from 40 to 55% by weight; and at least one compound selected from the following compounds (v) to (viii) in an amount of from 0.01 to 5% by weight, preferably from 1 to 3% by weight:

(v) a compound having 1 methacryloyloxy group and 5 hydrogen groups;

(vi) a compound having 2 methacryloyloxy groups and 4 hydrogen groups;

(vii) a compound having 3 methacryloyloxy groups and 3 hydrogen groups; and

(viii) a compound having 4 methacryloyloxy groups and 2 hydrogen groups.

The outermost layer may include the radical polymerizable compound represented by the formula (1) in an amount of from 3 to 95% by weight, more preferably 5 to 80% by weight, and much more preferably from 10 to 70% by weight, based on total weight of the outermost layer. When the amount is not less than 3% by weight, three-dimensional cross-linking density of the outermost layer is too large, and therefore the resultant photoreceptor has dramatically better abrasion resistance compared to that using a related art thermoplastic resin. When the amount is not greater than 95% by weight, the outermost layer includes sufficient amount of the charge transport material, and therefore the electric property of the resultant photoreceptor hardly deteriorates.

When the outermost layer is formed, a radical polymerizable monomer and/or oligomer having 1 to 4 functional groups can be used in combination in order to control the viscosity of the coating liquid, to maintain the smoothness of the outermost layer, to reduce the likelihood or prevent occurrence of crack caused due to the cross-linking contraction, and to decrease the surface free energy. When too large an amount of a radical polymerizable monomer and/or oligomer having 1 or 2 functional groups is used, there is a concern that mechanical durability of the outermost layer deteriorates. Therefore, a radical polymerizable monomer and/or oligomer having 3 or more functional groups may be used. Any related art radical polymerizable compounds can be used. The outermost layer may include the radical polymerizable monomer and/or oligomer having 1 to 4 functional groups in an amount of from 1 to 80% by weight, more preferably from 5 to 60% by weight, and much more preferably from 10 to 40% by weight, based on total weight of the outermost layer. When the radical polymerizable monomer and/or oligomer having 1 to 4 functional groups is used for controlling the viscosity of the coating liquid, the radical polymerizable monomer and/or oligomer may have a viscosity not greater than 1,000 mPa·s, and more preferably 800 mPa·s, at a temperature of 25° C.

Specific examples of the radical polymerizable monomers having 1 to 4 functional groups include, but are not limited to, trimethylolpropane triacrylate (TMPTA), trimethylolpropane trimethacrylate, HPA modified trimethylolpropane triacrylate, EO modified trimethylolpropane triacrylate, PO modified trimethylolpropane triacrylate, caprolactone modified trimethylolpropane triacrylate, ECH modified trimethylolpropane triacrylate, HPA modified trimethylolpropane trimethacrylate, pentaerythritol triacrylate, pentaerythritol tetraacrylate (PEETA), glycerol triacrylate, ECH modified glycerol triacrylate, EO modified glycerol triacrylate, PO modified glycerol triacrylate, tris(acryloxyethyl)isocyanurate, alkyl modified dipentaerythritol tetraacrylate, alkyl modified dipentaerythritol triacrylate, dimethylolpropane tetraacrylate (DTMPTA), pentaerythritol ethoxy tetraacrylate, EO modified phosphoric acid triacrylate, 2,2,5,5-tetrahydroxymethylcyclopentanone tetraacrylate, 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxy triethylene glycol acrylate, phenoxy tetraethylene glycol acrylate, cetyl acrylate, isostearyl acrylate, stearyl acrylate, styrene monomer, 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentyl glycol diacrylate, EO modified bisphenol A diacrylate, and EO modified bisphenol F diacrylate, neopentyl glycol diacrylate. Among these, trimethylolpropane triacrylate (TMPTA), HPA modified trimethylolpropane triacrylate, EO modified trimethylolpropane triacrylate, PO modified trimethylolpropane triacrylate, and ECH modified trimethylolpropane triacrylate may be used. (“EO” represents “ethyl eneoxy”, “PO” represents “propyleneoxy”, “ECH” represents “epichlorohydrin”, and “HPA” represents “alkylene”.)

Specific examples of the radical polymerizable oligomers having 1 to 4 functional groups include, but are not limited to, epoxy acrylate oligomers, urethane acrylate oligomers, and polyester acrylate oligomers.

### Radical Polymerizable Compound Having Charge Transport Structure

The radical polymerizable compound having a charge transport structure for use in exemplary embodiments of the present invention has a positive hole transport structure (e.g., triarylamine, hydrazone, pyrazoline, carbazole) or an electron transport structure (e.g., condensed polycyclic quinone, diphenoquinone, electron-accepting aromatic rings having cyano group and nitro group); and a radical polymerizable functional group. The radical polymerizable functional group has a carbon-carbon double bond, and is not particularly limited.

Specific examples of the radical polymerizable functional groups include, but are not limited to, 1-substituted ethylene group and 1,1-substituted ethylene group.

The 1-substituted ethylene group can be represented by the following formula.

CH₂═CH—X₁—

X₁ represents an arylene group (e.g., phenylene group, naphthylene group) which may have a substituent group, an alkenylene group which may have a substituent group, —CO—, —COO—, —CON(R₂₀) (R₂₀ represents a hydrogen atom; an alkyl group such as methyl group and ethyl group; an aralkyl group such as benzyl group, naphthylmethyl group, and phenethyl group; or an aryl group such as phenyl group and naphthyl group), or —S—.

Specific examples of the 1-substituted ethylene groups include, but are not limited to, vinyl group, styryl group, 2-methyl-1,3-butadienyl group, vinyl carbonyl group, acryloyloxy group, acryloylamide group, and vinyl thioether group.

The 1,1-substituted ethylene group can be represented by the following formula:

CH₂═C(Y)—X₂—

Y represents an alkyl group which may have a substituent group, an aralkyl group which may have a substituent group, a phenyl group which may have a substituent group, an aryl group (e.g., naphthyl group), a halogen atom, a cyano group, a nitro group, an alkoxy group (e.g., methoxy group, ethoxy group), —COOR₂₁ (R₂₁ represents a hydrogen atom; an alkyl group, such as methyl group and ethyl group, which may have a substituent group; an aralkyl group, such as benzyl group and phenethyl group, which may have a substituent group; or an aryl group, such as phenyl group and naphthyl group, which may have a substituent group), —CONR₂₂R₂₃ (each of R₂₂ ad R₂₃ independently represents a hydrogen atom; an alkyl group, such as methyl group and ethyl group, which may have a substituent group; an aralkyl group, such as benzyl group, naphthylmethyl group, and phenethyl group, which may have a substituent group; or an aryl group, such as phenyl group and naphthyl group, which may have a substituent group); and X₁ represents the same group as X₂, a single bond, or an alkylene group. At least one of Y and X₂ is an oxycarbonyl group, a cyano group, an alkenylene group, or an aromatic ring.

Specific examples of the 1,1-substituted ethylene groups include, but are not limited to, α-chlorinated acryloyloxy group, methacryloyloxy group, α-cyano ethylene group, α-cyano acryloyloxy group, α-cyano phenylene group, and methacryloylamino group.

Specific examples of the substituent groups of X₁, X₂, and Y include, but are not limited to, a halogen atom, nitro group, cyano group, an alkyl group (e.g., methyl group, ethyl group), an alkoxy group (e.g., methoxy group, ethoxy group), an aryloxy group (e.g., phenoxy group), an aryl group (e.g., phenyl group, naphthyl group), and an aralkyl group (e.g., benzyl group, phenethyl group).

Among the above-mentioned radical polymerizable functional groups, acryloyloxy group and methacryloyloxy group are effective. In order that the resultant photoreceptor has good electric property for a long term, the radical polymerizable compound may have one radical polymerizable functional group. When the radical polymerizable compound has 2 or more functional groups, the charge transport structure is bound to the cross-linking structure at plural sites and fixed therein, and thereby an intermediate structure (a cation radical) cannot be stably formed when the charge is transported. As a result, the charge tends to be trapped, and causes deterioration of sensitivity and increase of residual potential. In this case, the resultant image density tends to decrease, and the characters in the resultant image tend to be thinner.

As the charge transport structure, a triarylamine structure is effective. When compounds represented by the following formulae (9) and (10) are used, the resultant photoreceptor has good sensitivity and electric property (such as residual potential) for a long term:

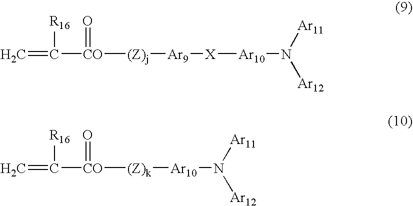

R₁₆ represents a hydrogen atom, a halogen atom, an alkyl group which may have a substituent group, an aralkyl group which may have a substituent group, an aryl group which may have a substituent group, a cyano group, a nitro group, an alkoxy group, —COOR₁₇ (R₁₇ represents a hydrogen atom, an alkyl group which may have a substituent group, an aralkyl group which may have a substituent group, or an aryl group which may have a substituent group), a halogenated carbonyl group, or —CONR₁₈R₁₉ (each of R₁₈ and R₁₉ independently represents a hydrogen atom, a halogen atom, an alkyl group which may have a substituent group, an aralkyl group which may have a substituent group, or an aryl group which may have a substituent group. Each of Ar₉ and Ar₁₀ independently represents a substituted or unsubstituted arylene group. Each of Ar₁₁ and Ar₁₂ independently represents a substituted or unsubstituted aryl group. X represents a single bond, a substituted or unsubstituted alkylene group, a substituted or unsubstituted cycloalkylene group, a substituted or unsubstituted alkylene ether group, an oxygen atom, a sulfur atom, or a vinylene group. Z represents a substituted or unsubstituted alkylene group, a substituted or unsubstituted alkylene ether group, or an alkyleneoxycarbonyl group. Each of j and k independently represents an integer of from 0 to 3.

Specific examples of the alkyl groups represented by R₁₆ include, but are not limited to, methyl group, ethyl group, propyl group, and butyl group. Specific examples of the aryl groups represented by R₁₆ include, but are not limited to, phenyl group and naphthyl group. Specific examples of the aralkyl groups represented by R₁₆ include, but are not limited to, benzyl group, phenethyl group, and naphthylmethyl group. Specific examples of the alkoxy groups represented by R₁₆ include, but are not limited to, methoxy group, ethoxy group, and propoxy group. These groups may be substituted with a halogen atom, a nitro group, a cyano group, an alkyl group (e.g., methyl group, ethyl group), an alkoxy group (e.g., methoxy group, ethoxy group), an aryloxy group (e.g., phenoxy group), an aryl group (e.g., phenyl group, naphthyl group), an aralkyl group (e.g., benzyl group, phenethyl group), etc.

Among the above groups represented by R₁₆, a hydrogen atom and a methyl group may be used.

Each of Ar₁₁ and Ar₁₂ independently represents a substituted or unsubstituted aryl group. Specific examples of the aryl groups include, but are not limited to, condensed polycyclic hydrocarbon groups, uncondensed cyclic hydrocarbon groups, and heterocyclic groups.

The condensed polycyclic hydrocarbon group may include a ring having 18 or less carbon atoms. Specific examples of such condensed polycyclic hydrocarbon groups include, but are not limited to, pentanyl group, indenyl group, naphthyl group, azulenyl group, heptalenyl group, biphenylenyl group, as-indacenyl group, s-indacenyl group, fluorenyl group, acenaphthylenyl group, pleiadenyl group, acenaphthenyl group, phenalenyl group, phenanthryl group, anthryl group, fluoranthenyl group, acephenanthrylenyl group, aceanthrylenyl group, triphenylenyl group, pyrenyl group, chrysenyl group, and naphthacenyl group.

Specific examples of the uncondensed cyclic hydrocarbon groups include, but are not limited to, monovalent groups derived from benzene, diphenyl ether, polyethylene diphenyl ether, diphenyl thioether, diphenyl sulfone, biphenyl, polyphenyl, diphenyl alkane, diphenyl alkene, diphenyl alkyne, triphenylmethane, distyrylbenzene, 1,1-diphenyl cycloalkane, polyphenyl alkane, and polyphenyl alkene. In addition, monovalent groups derived from polycyclic hydrocarbons such as 9,9-diphenyl fluorene can also be used.

Specific examples of the heterocyclic groups include, but are not limited to, monovalent groups derived from carbazole, dibenzofuran, dibenzothiophene, oxadiazole, thiazole, etc.

The aryl groups represented by Ar₁₁ and Ar₁₂ may have the following substituent groups.

(1) A halogen atom, a cyano group, a nitro group, etc.

(2) A straight-chain or branched-chain alkyl group having 1 to 12 carbon atoms, more preferably 1 to 8 carbon atoms, and much more preferably 1 to 4 carbon atoms, which may substituted with a fluorine atom; a hydroxyl group; a cyano group; an alkoxy group having 1 to 4 carbon atoms; or a phenyl group substituted with a halogen atom, an alkyl group having 1 to 4 carbon atoms, or an alkoxy group having 1 to 4 carbon atoms. Specific examples of the alkyl groups include, but are not limited to, methyl group, ethyl group, n-butyl group, i-propyl group, t-butyl group, s-butyl group, n-propyl group, trifluoromethyl group, 2-hydroxyethyl group, 2-ethoxyethyl group, 2-cyanoethyl group, 2-methoxyethyl group, benzyl group, 4-chlorobenzyl group, 4-methylbenzyl group, and 4-phenylbenzyl group.

(3) An alkoxy group (—OR₃₀, wherein R₃₀ represents an alkyl group defined in the above paragraph (2)). Specific examples of the alkoxy groups include, but are not limited to, methoxy group, ethoxy group, n-propoxy group, i-propoxy group, t-butoxy group, n-butoxy group, s-butoxy group, i-butoxy group, 2-hydroxyethoxy group, benzyloxy group, and trifluoromethoxy group.

(4) An aryloxy group. Specific examples of aryl groups include, but are not limited to, phenyl group and naphthyl group. The aryloxy group may substituted with an alkoxy group having 1 to 4 carbon atoms, an alkyl group having 1 to 4 carbon atoms, or a halogen atom. Specific examples of the aryloxy groups include, but are not limited to, phenoxy group, 1-naphthyloxy group, 2-naphthyloxy group, 4-methoxyphenoxy group, and 4-methylphenoxy group.

(5) An alkylmercapto group or an arylmercapto group. Specific examples of these groups include, but are not limited to, methylthio group, ethylthio group, phenylthio group, and p-methylphenylthio group.

(6) A substituent group represented by the following formula:

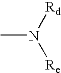

wherein each of Rd and Re independently represents a hydrogen atom, an alkyl group defined in the above paragraph (2), or an aryl group (e.g., phenyl group, biphenyl group, naphthyl group) which may substituted with an alkoxy group having 1 to 4 carbon atoms, an alkyl group having 1 to 4 carbon atoms, or a halogen atom; and wherein Rd and Re optionally share bond connectivity to form a ring. Specific examples of the above substituent groups include, but are not limited to, amino group, diethylamino group, N-methyl-N-phenylamino group, N,N-diphenylamino group, N,N-di(tolyl)amino group, dibenzylamino group, piperidino group, morpholino group, and pyrrolidino group.

(7) An alkylenedioxy group and an alkylenedithio group such as methylenedioxy group and methylenedithio group.

(8) A substituted or unsubstituted styryl group, a substituted or unsubstituted β-phenyl styryl group, diphenyl aminophenyl group, dinitrile aminophenyl group, etc.

Specific examples of the arylene groups represented by Ar₉ and Ar₁₋ include, but are not limited to, divalent groups derived from the aryl groups represented by Ar₁₁ and Ar₁₂.

X represents a single bond, a substituted or unsubstituted alkylene group, a substituted or unsubstituted cycloalkylene group, a substituted or unsubstituted alkylene ether group, an oxygen atom, a sulfur atom, or a vinylene group.

The substituted or unsubstituted alkylene group is a straight-chained or branched-chain alkylene group having 1 to 12 carbon atoms, preferably 1 to 8 carbon atoms, and more preferably 1 to 4 carbon atoms. These alkylene groups may have a fluorine atom, a hydroxyl group, a cyano group, an alkoxy group having 1 to 4 carbon atoms, a phenyl group, or a phenyl group substituted with a halogen atom, an alkyl group having 1 to 4 carbon atoms, or an alkoxy group having 1 to 4 carbon atoms. Specific examples of the substituted or unsubstituted alkylene groups include, but are not limited to, methylene group, ethylene group, n-butylene group, i-propylene group, t-butylene group, s-butylene group, n-propylene group, trifluoromethylene group, 2-hydroxyethylene group, 2-ethoxyethylene group, 2-cyanoethylene group, 2-mehoxyethylene group, benzylidene group, phenylethylene group, 4-chlorophenylethylene group, 4-methylphenylethylene group, and 4-biphenylethylene group.

The substituted or unsubstituted cycloalkylene group is a cyclic alkylene group having 5 to 7 carbon atoms which may have a fluorine atom, a hydroxyl group, an alkyl group having 1 to 4 carbon atoms, or an alkoxy group having 1 to 4 carbon atoms. Specific examples of the substituted or unsubstituted cycloalkylene groups include, but are not limited to, cyclohexylidene group, cyclohexylene group, and 3,3-dimethylcyclohexylidene group.

Specific examples of the substituted or unsubstituted alkylene ether groups include, but are not limited to, an alkyleneoxy group (e.g., ethyleneoxy group, propyleneoxy group); an alkylenedioxy group derived from ethylene glycol, propylene glycol, etc.; and di- or poly(oxyalkylene)oxy group derived from diethylene glycol, tetraethylene glycol, tripropylene glycol. The alkylene group of the alkylene ether group may have a substituent group, such as a hydroxyl group, a methyl group, and an ethyl group.

Specific examples of the vinylene groups include, but are not limited to, the following substituent groups:

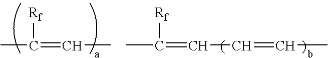

Rf represents a hydrogen atom, an alkyl group (defined in the above paragraph (2)), or an aryl group (the same aryl groups represented by Ar11 and Ar12); a represents an integer of 1 or 2; and b represents an integer of from 1 to 3.

Z represents a substituted or unsubstituted alkylene group, a substituted or unsubstituted alkylene ether group, or an alkyleneoxycarbonyl group.

Specific examples of the substituted or unsubstituted alkylene groups include, but are not limited to, the same alkylene groups represented by X.

Specific examples of the substituted or unsubstituted alkylene ether groups include, but are not limited to, the same alkylene ether groups represented by X.

Specific examples of the alkyleneoxycarbonyl groups include, but are not limited to, caprolactone modified groups.

As the monofunctional radical polymerizable compound having a charge transport structure, a compound represented by the following formula (11) may be used:

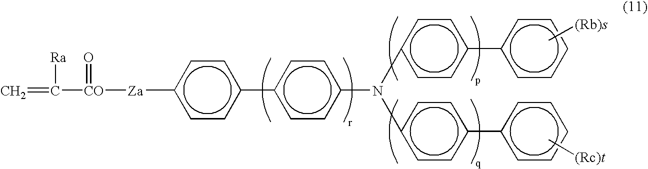

Each of r, p, and q independently represents an integer of 0 or 1. Each of s and t independently represents an integer of from 0 to 3. Ra represents a hydrogen atom or a methyl group. Each of Rb and Rc independently represents an alkyl group having 1 to 6 carbon atoms. Za represents a single bond, a methylene group, an ethylene group,

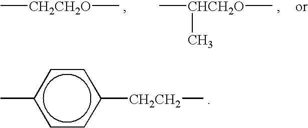

Among these compounds represented by the formula (11), compounds in which each of Rb and Rc independently represents a methyl group or an ethyl group may be used.

Each of the monofunctional radical polymerizable compounds having a charge transport structure represented by the formulae (9), (10), and (11) has a carbon-carbon double bond on its end. Since this carbon-carbon double bond opens when polymerized with the radical polymerizable compound having no charge transport structure represented by the formula (1), the monofunctional radical polymerizable compound having a charge transport structure hardly becomes the end of the resultant polymer. In other words, the monofunctional radical polymerizable compound having a charge transport structure is present in the main chain of the resultant polymer formed by reacting with the radical polymerizable compound having no charge transport structure represented by the formula (1), and further present in the cross-linking chain which connects each of the main chains. (The cross-linking chain includes an intermolecular cross-linking chain which connects a polymer with another polymer, and an intramolecular cross-linking chain which connects a folded portion of the main chain of a polymer with another portion of the main chain of the polymer located far from the folded portion.) Since the triarylamine structure of the monofunctional radical polymerizable compound is suspended from the main chain or the cross-linking chain through the intermediary of a functional group, such as carbonyl group, the triarylamine structure can flexibly take various configurations, even though the triarylamine structure is bulky because of having at least 3 aryl groups radially bound to the nitrogen atom. As a result, each of the triarylamine structures can be arranged to be adjacent to each other while taking a reasonable distance therebetween in the molecular, and the molecular has a little structural strain. When the resultant polymer is used for the outermost layer of a photoreceptor, it seems that the charge transport path is hardly broken off.

Specific examples of suitable monofunctional radical polymerizable compounds having a charge transport structure include the following compounds shown in Table 9, but are not limited thereto.

TABLE 9
Formula/No.

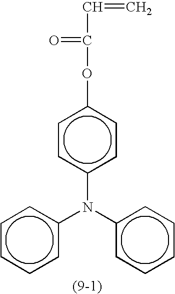

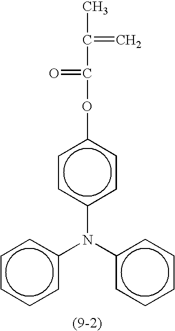

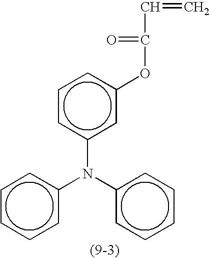

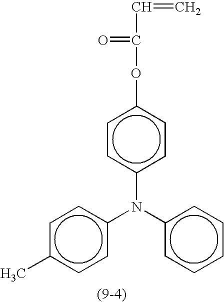

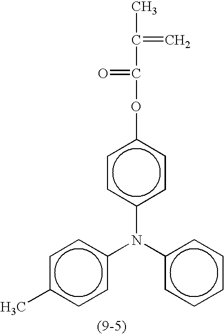

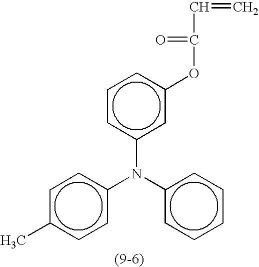

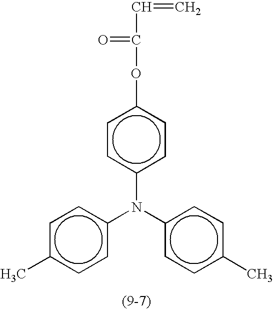

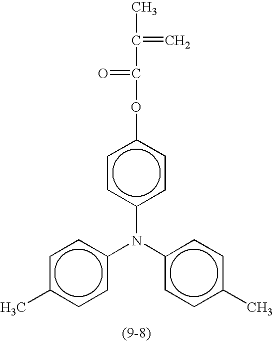

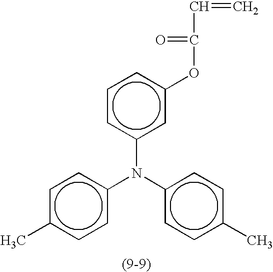

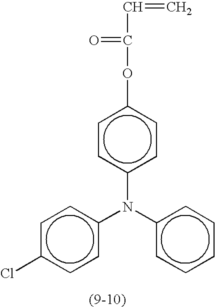

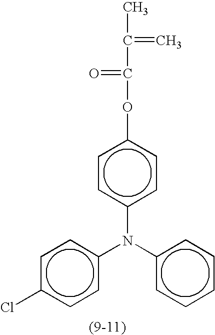

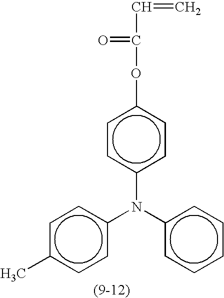

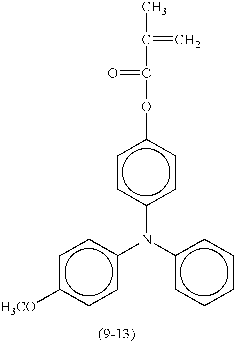

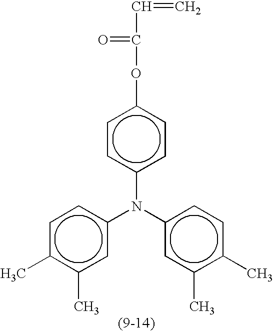

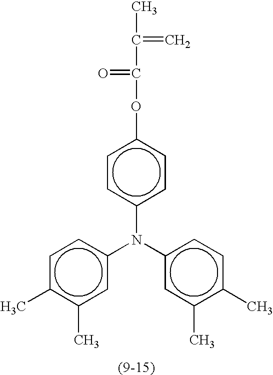

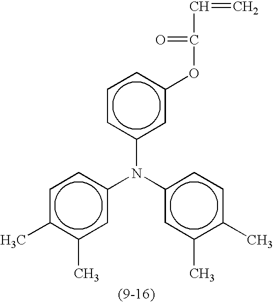

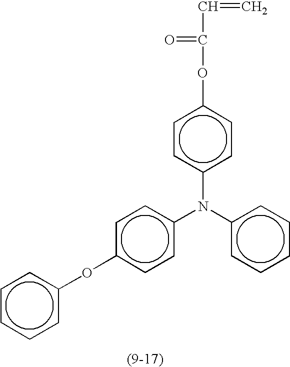

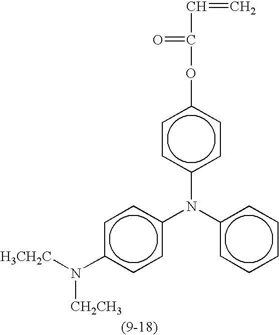

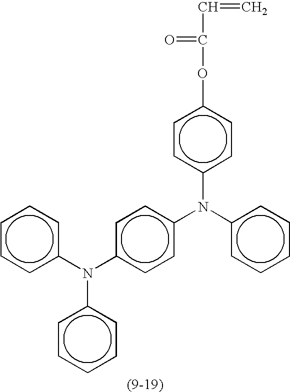

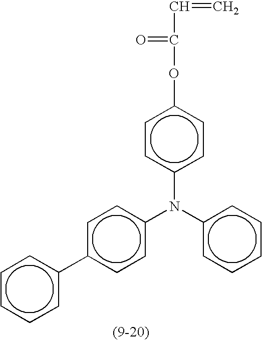

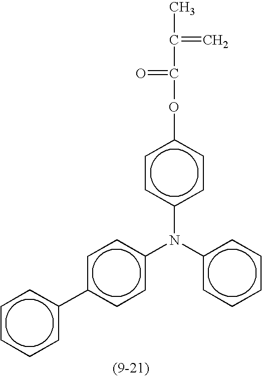

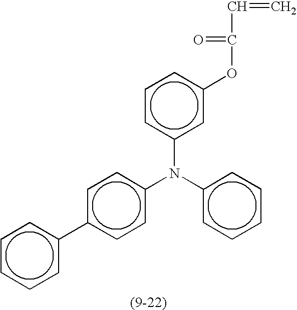

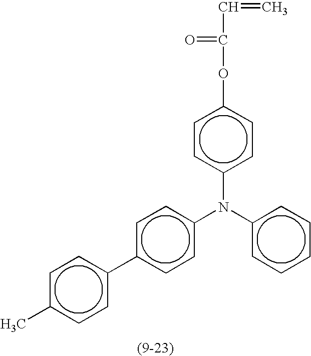

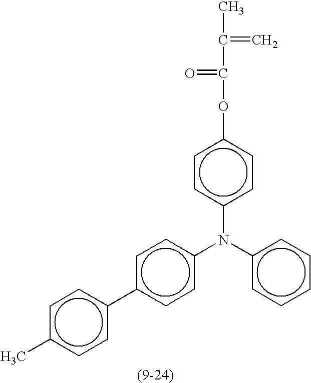

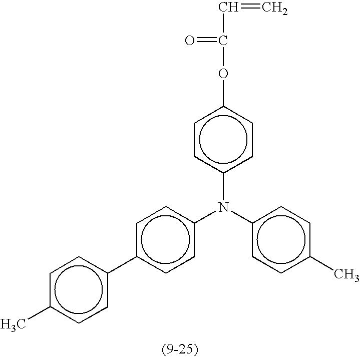

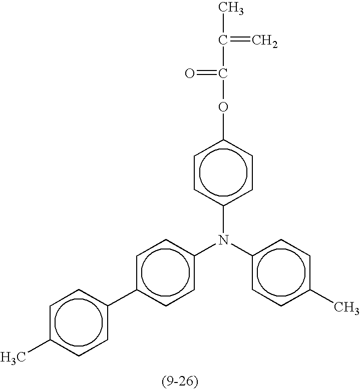

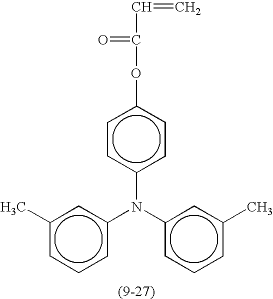

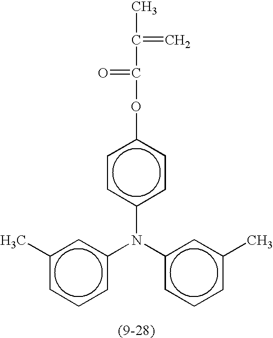

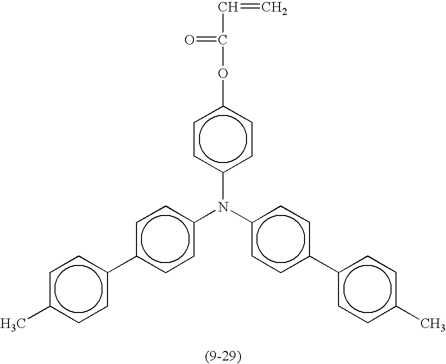

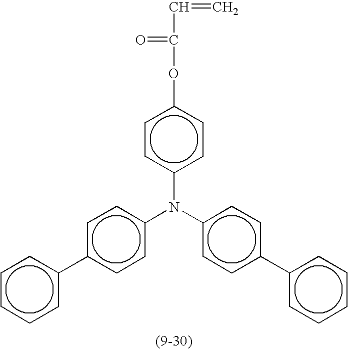

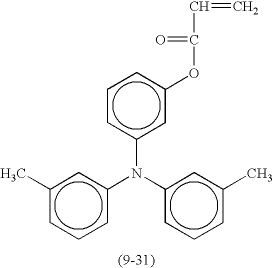

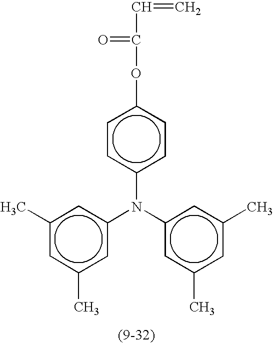

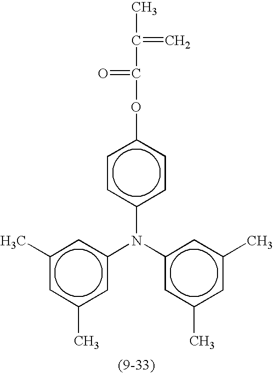

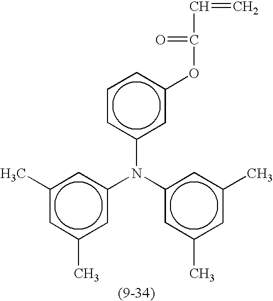

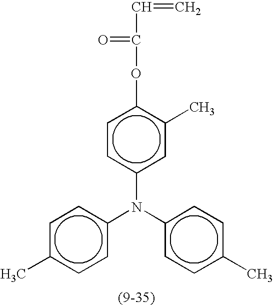

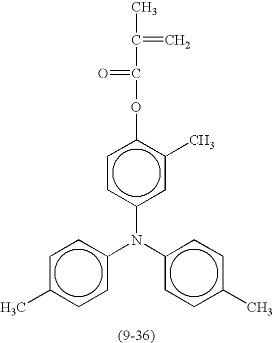

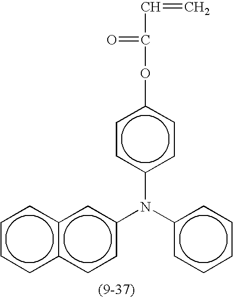

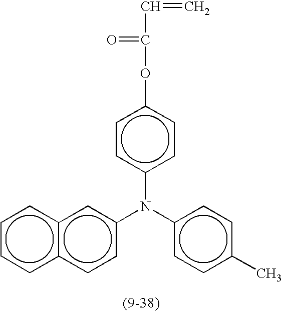

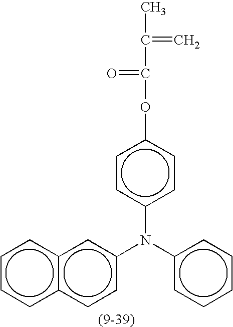

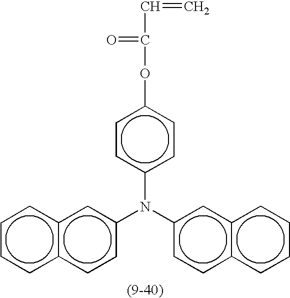

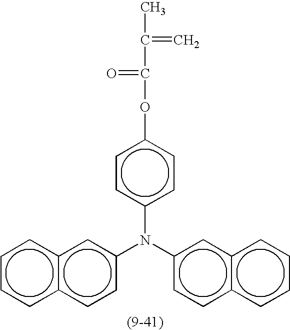

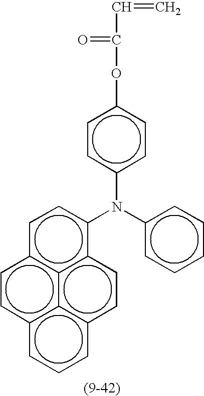

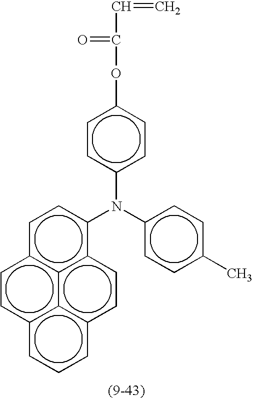

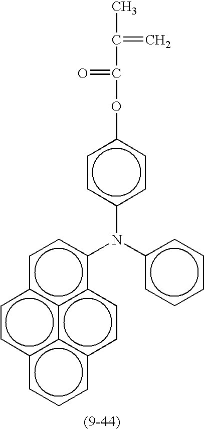

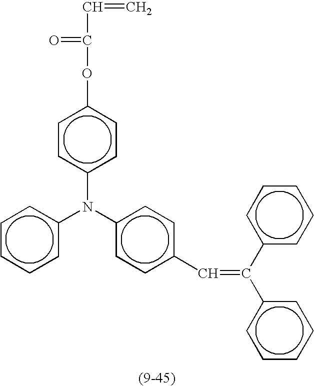

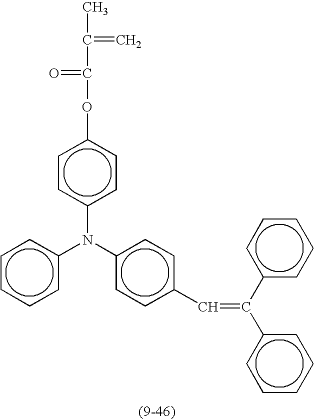

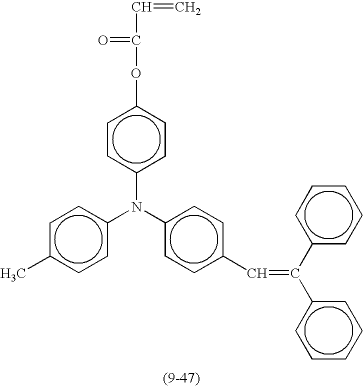

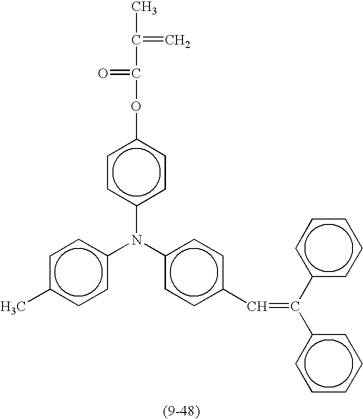

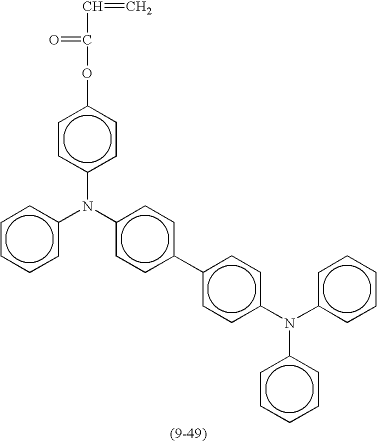

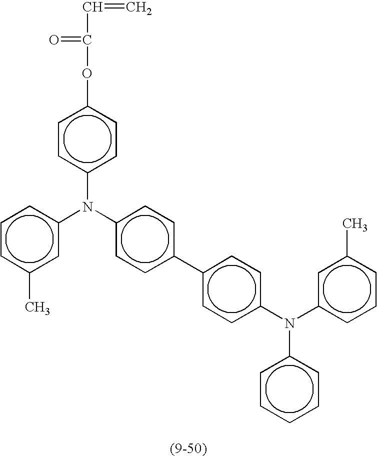

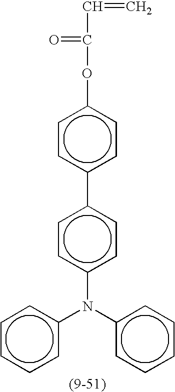

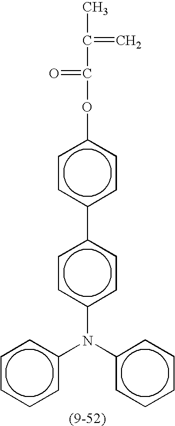

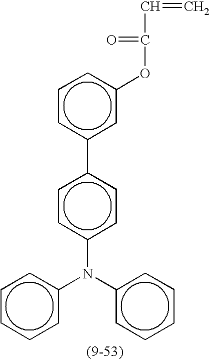

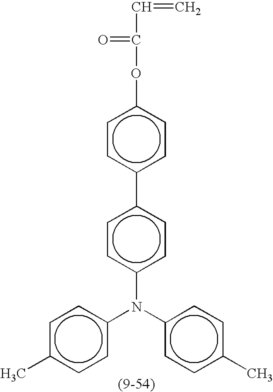

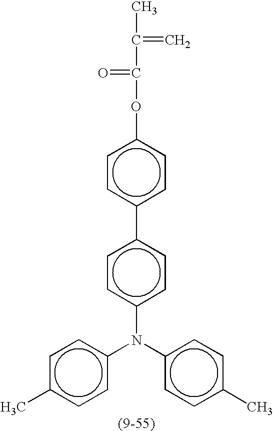

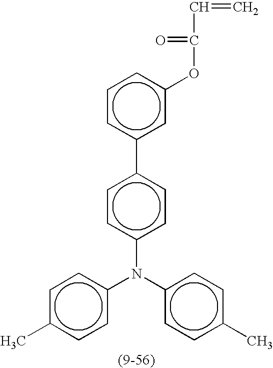

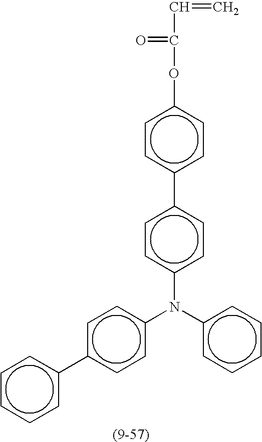

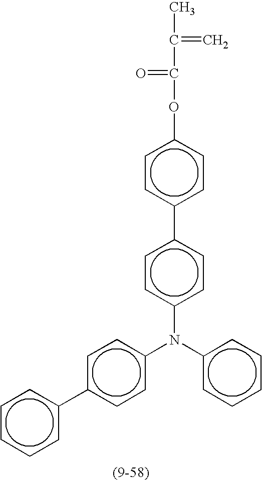

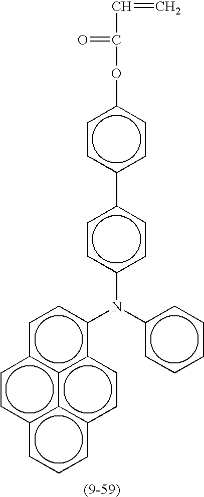

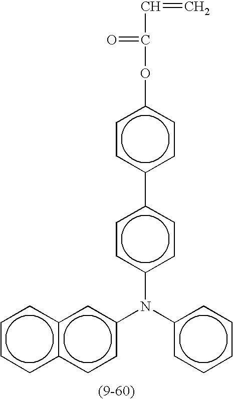

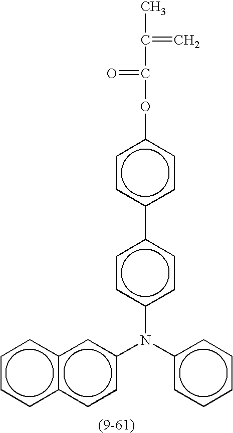

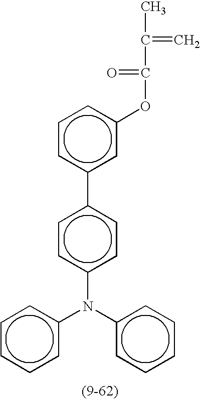

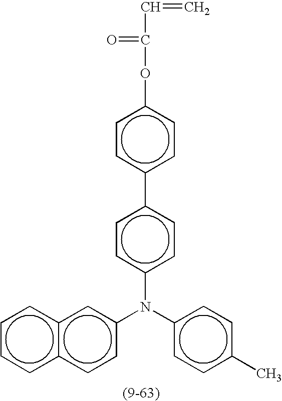

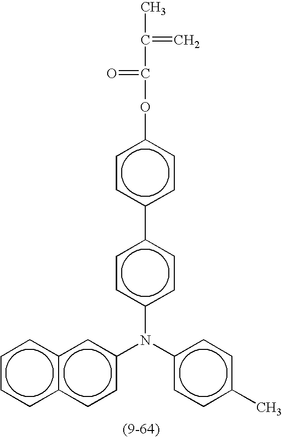

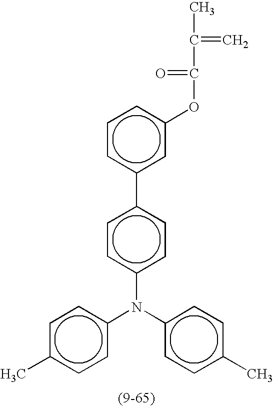

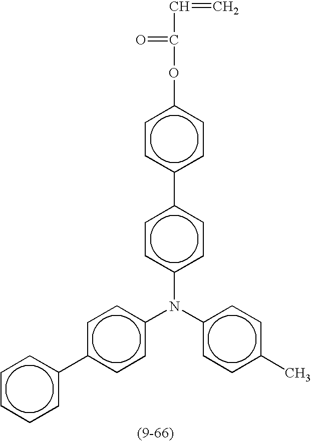

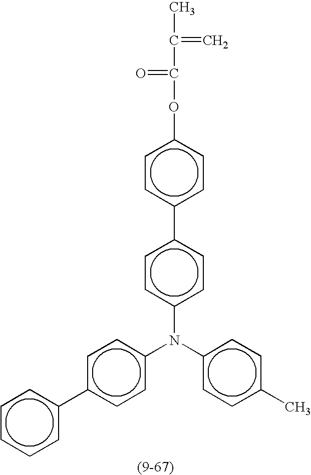

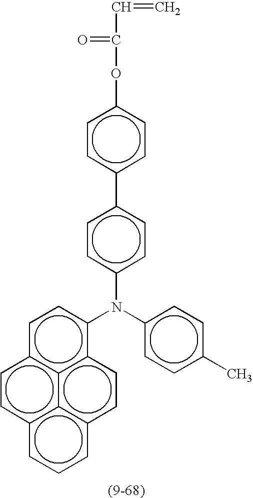

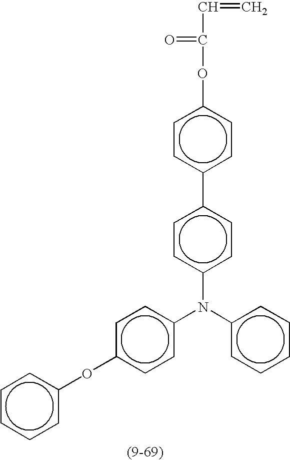

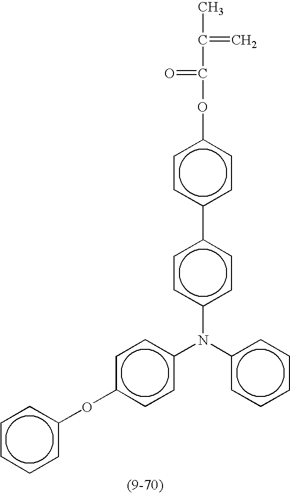

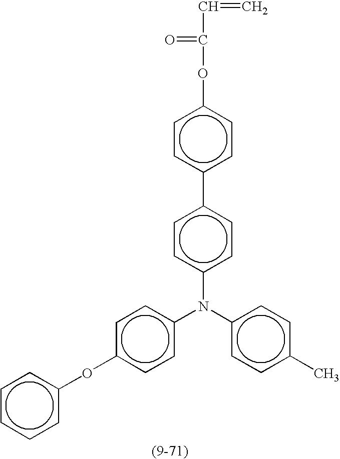

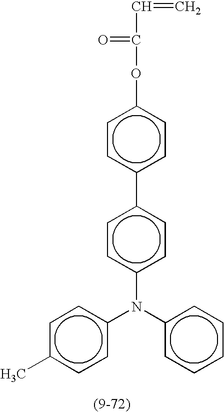

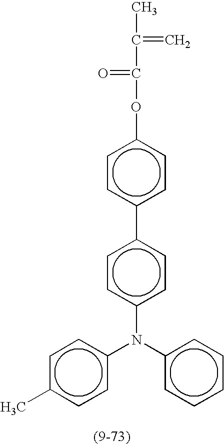

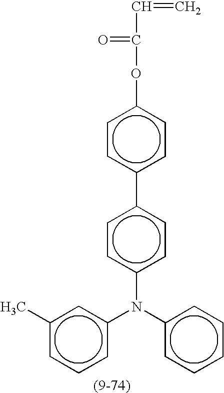

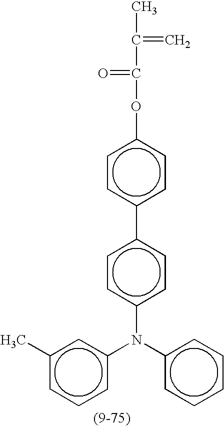

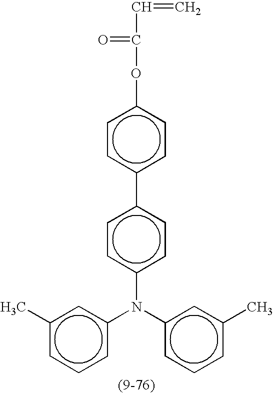

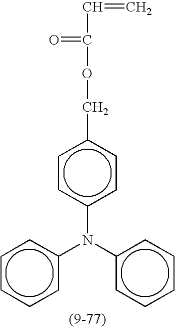

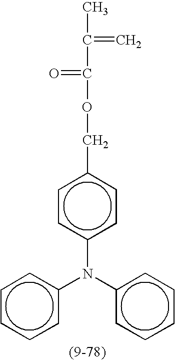

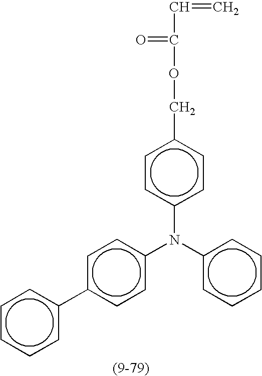

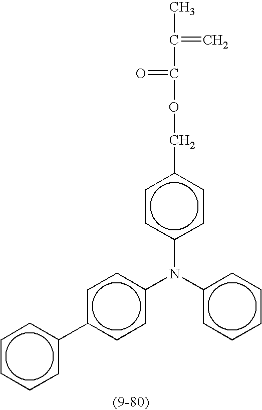

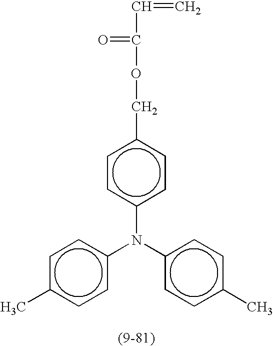

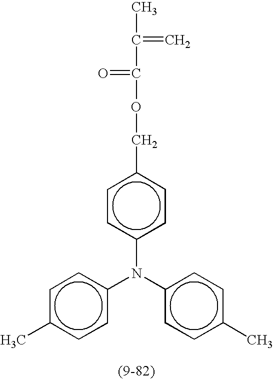

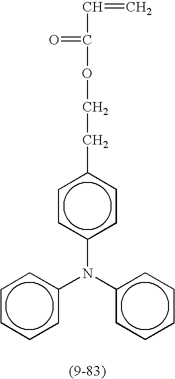

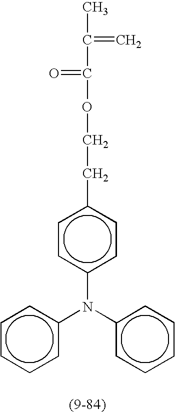

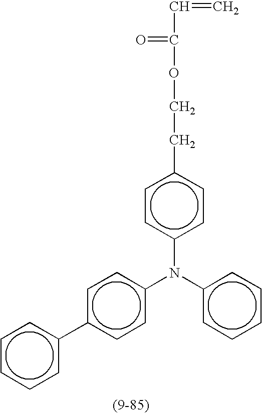

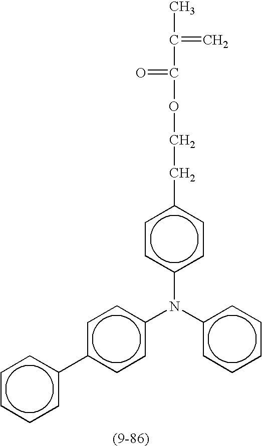

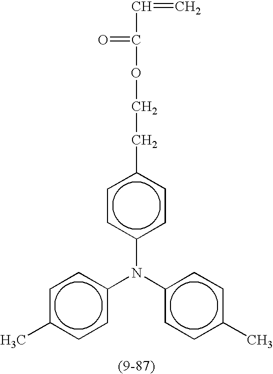

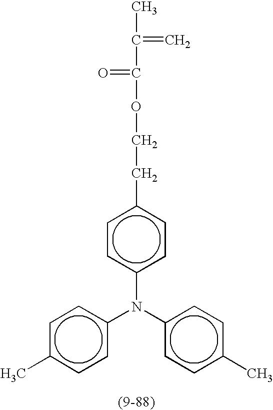

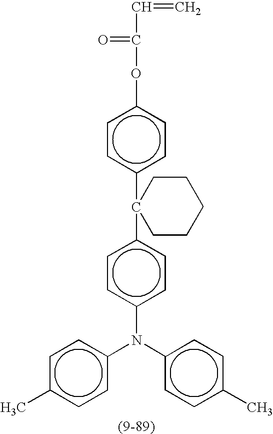

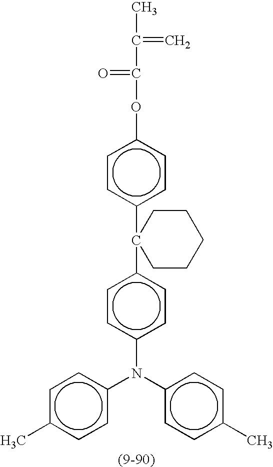

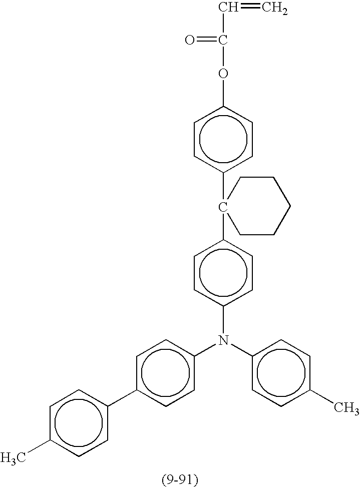

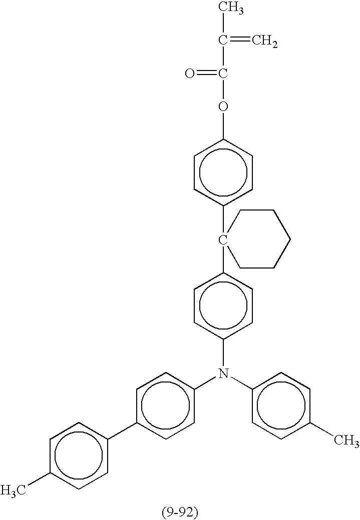

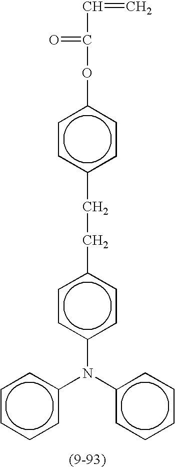

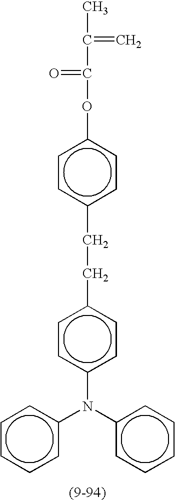

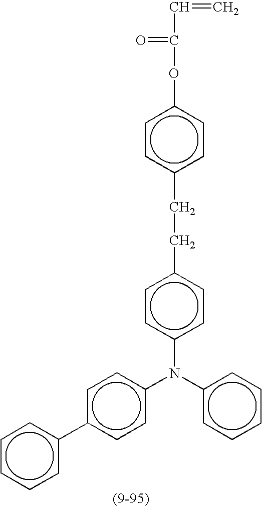

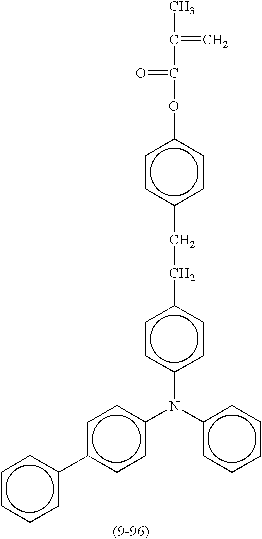

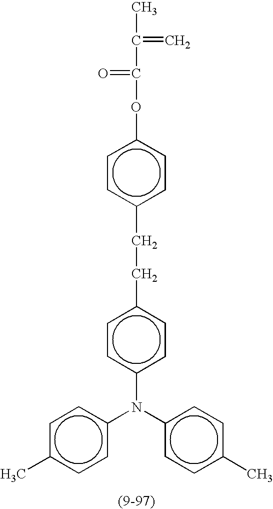

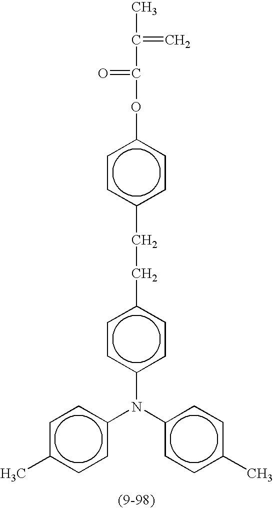

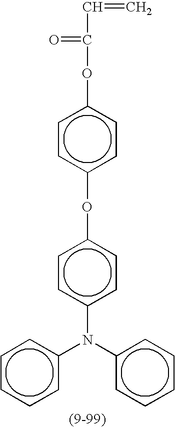

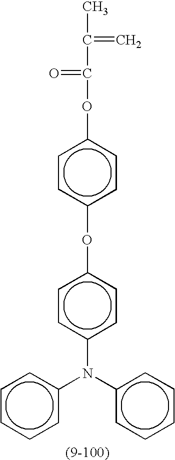

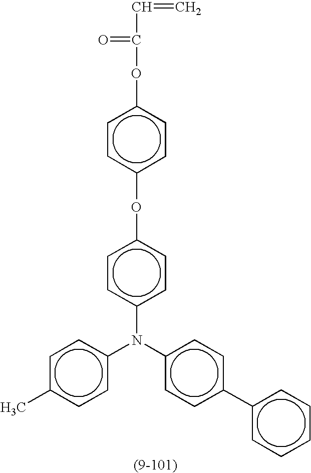

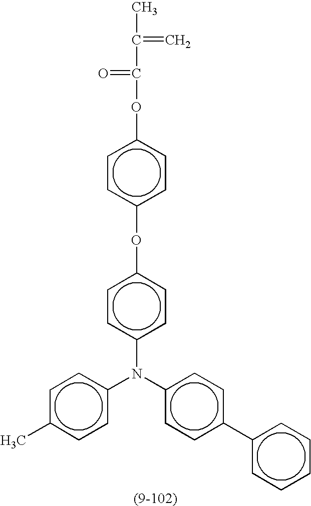

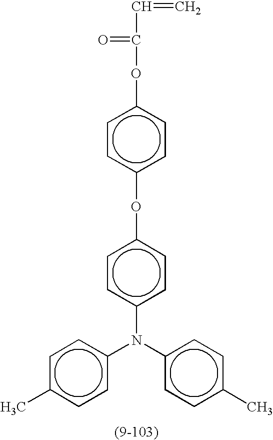

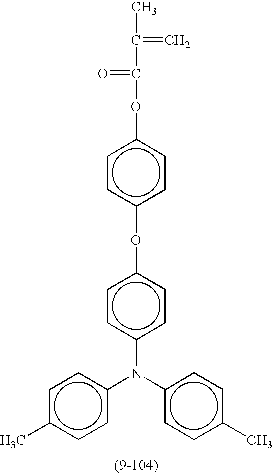

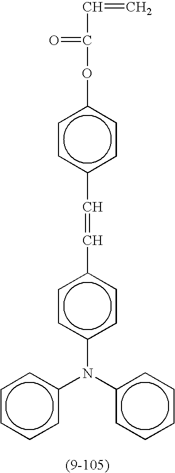

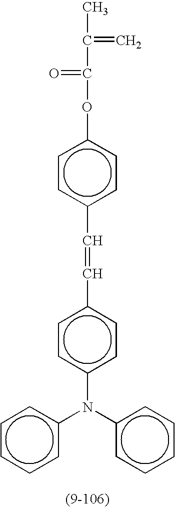

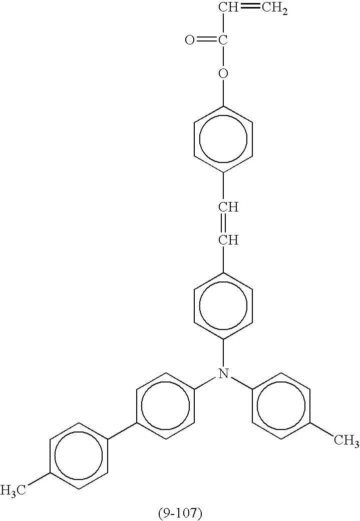

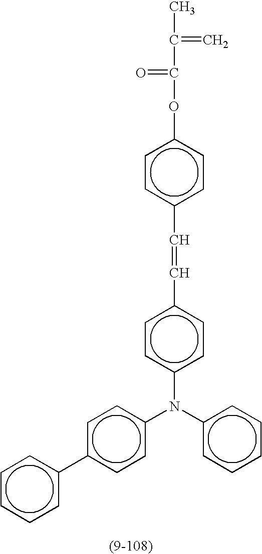

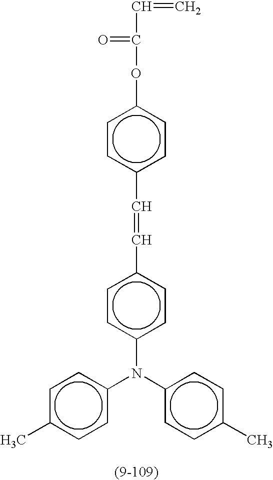

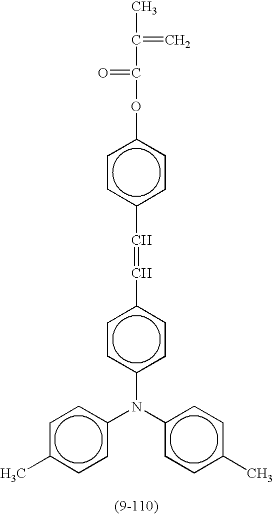

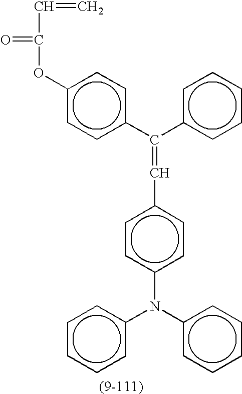

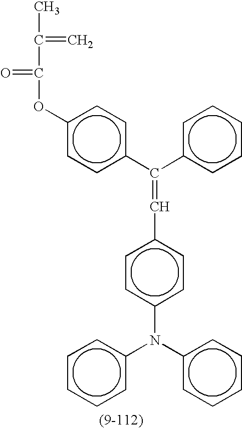

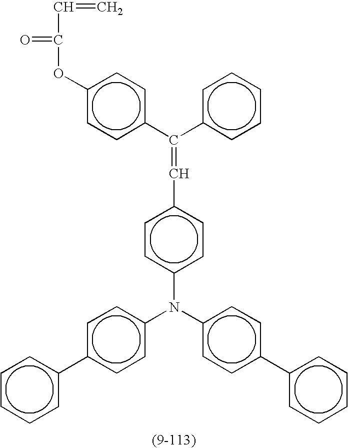

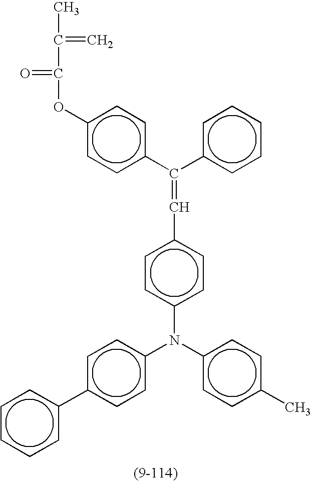

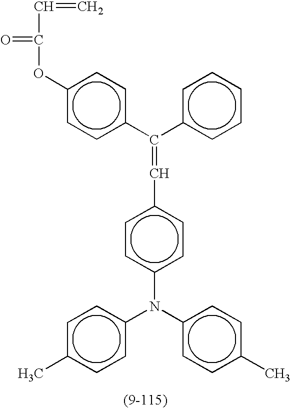

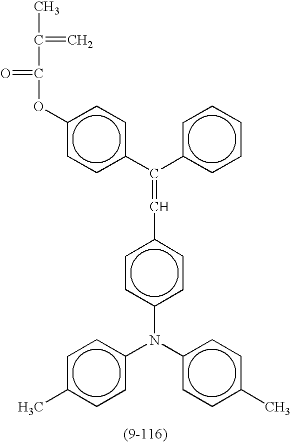

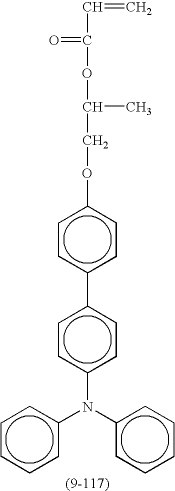

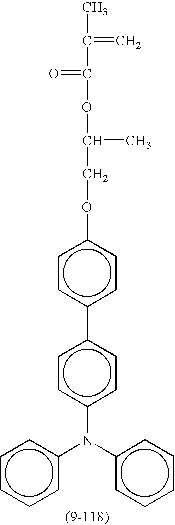

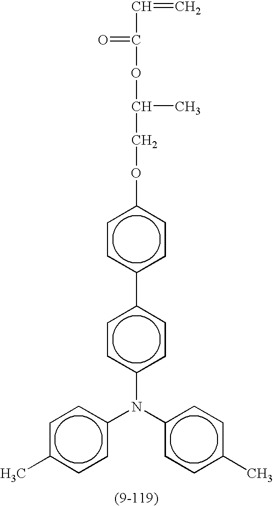

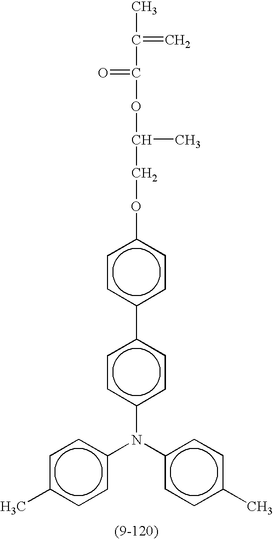

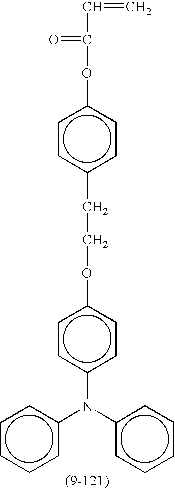

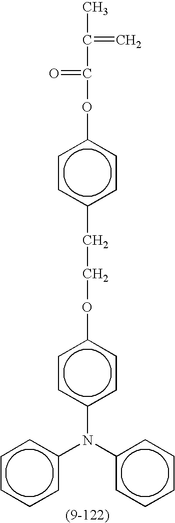

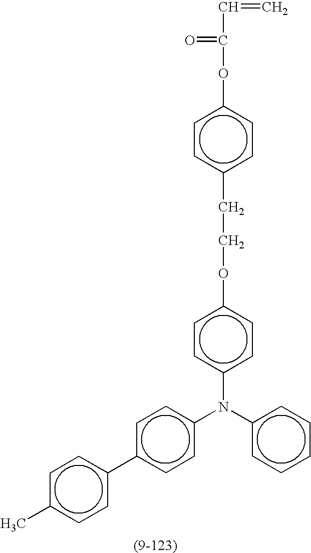

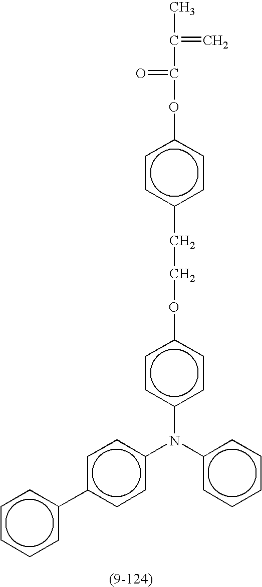

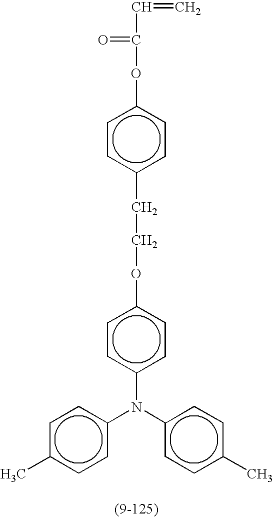

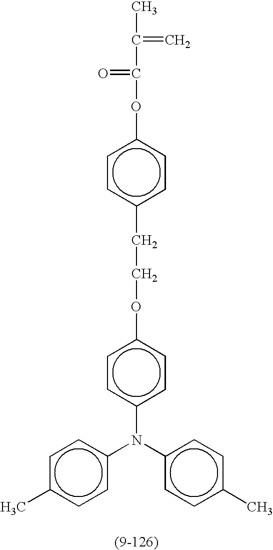

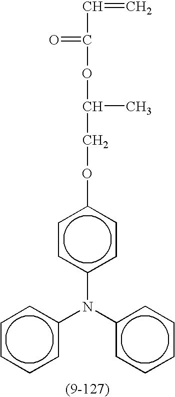

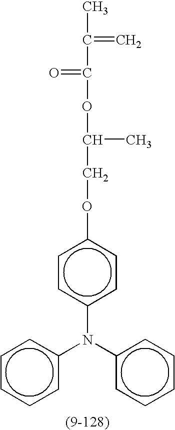

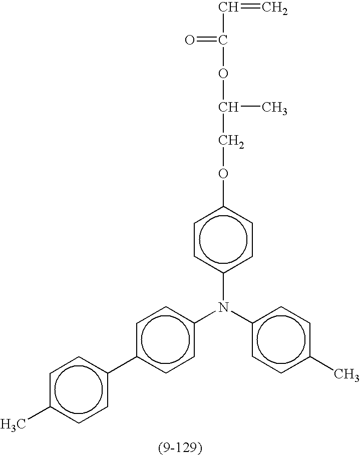

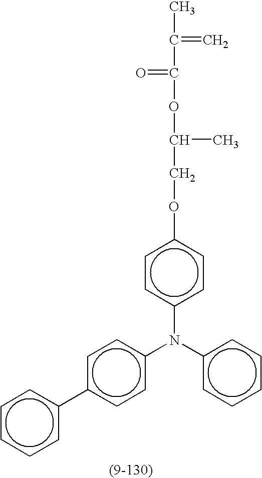

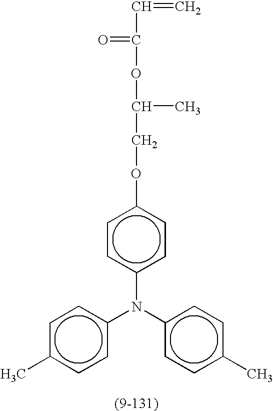

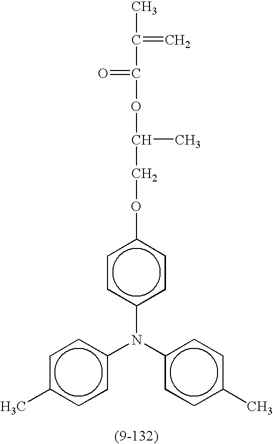

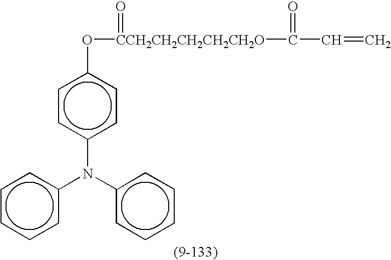

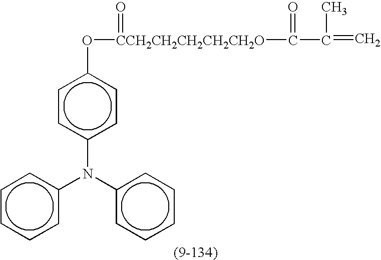

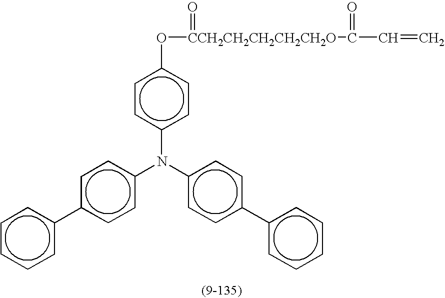

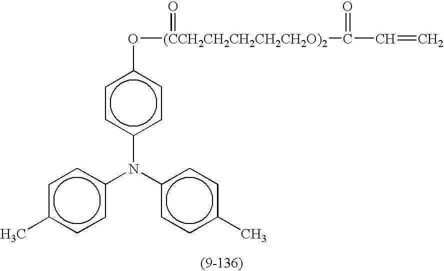

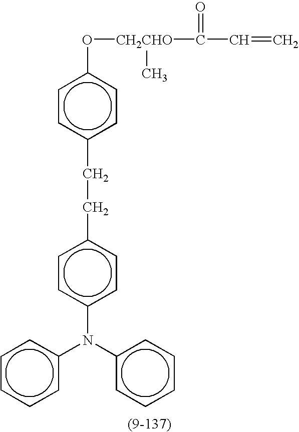

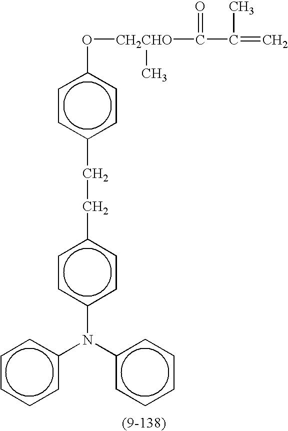

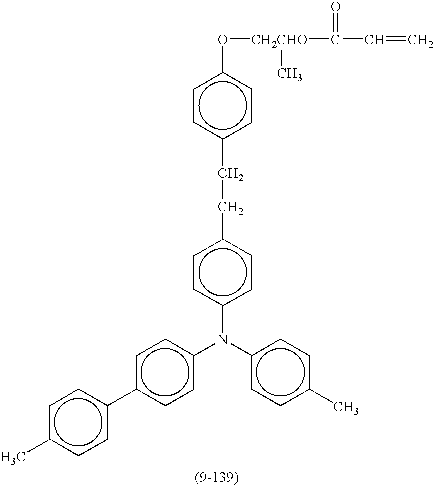

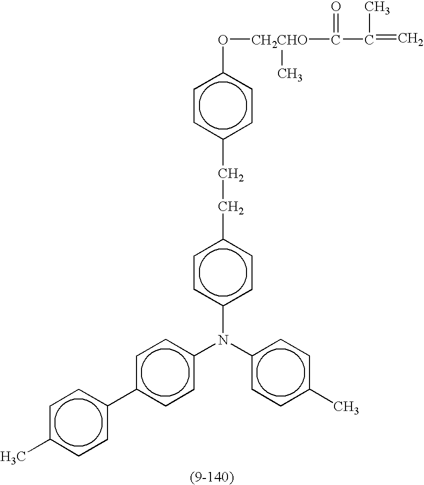

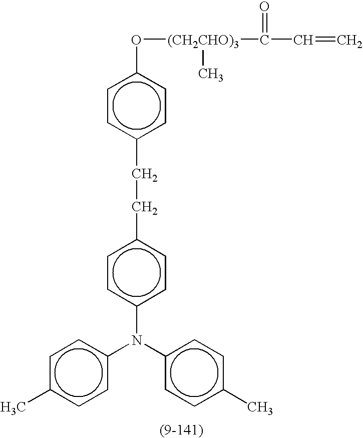

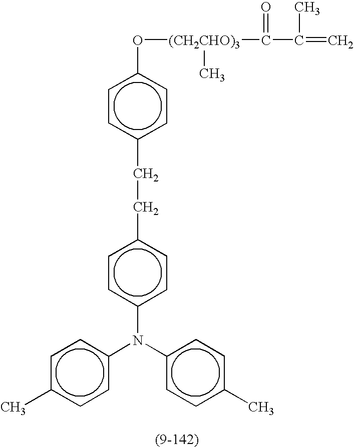

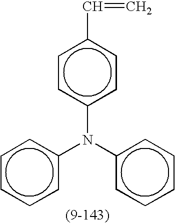

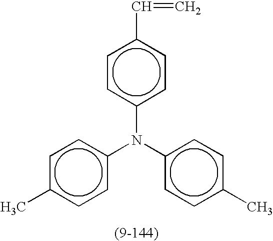

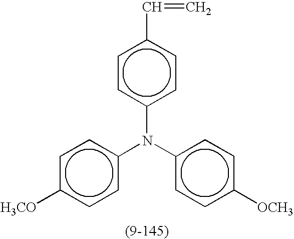

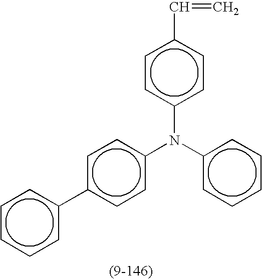

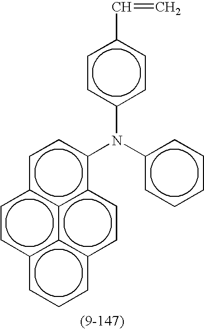

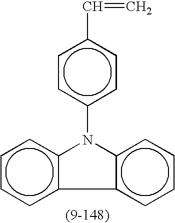

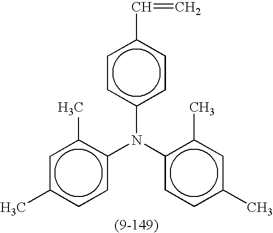

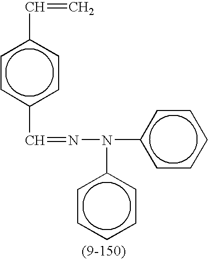

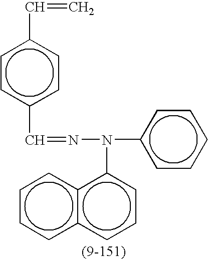

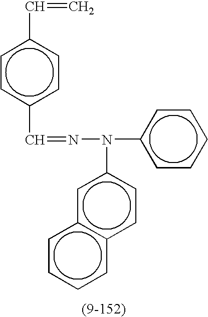

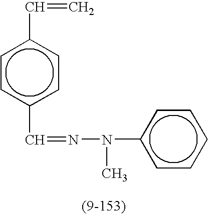

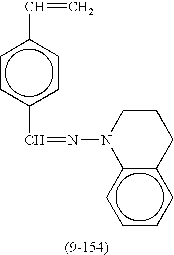

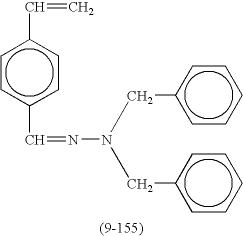

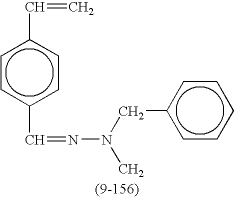

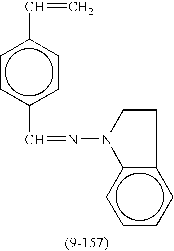

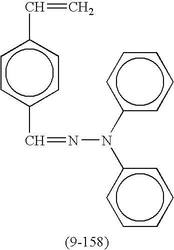

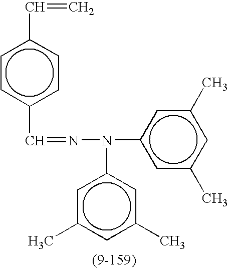

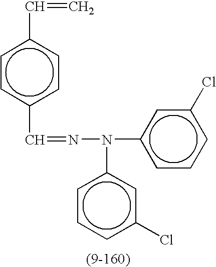

The outermost layer of the photoreceptor of exemplary embodiments of the present invention may include the monofunctional radical polymerizable compound in an amount of from 20 to 80% by weight, and preferably from 30 to 70% by weight, based on total weight of the outermost layer. When the amount is too small, the outermost layer has insufficient charge transport ability, and therefore electrical properties thereof deteriorate and deterioration of sensitivity after repeated use and increase of residual potential are caused. When the amount is too large, the outermost layer includes too small a quantity of the radical polymerizable compound having no charge transport structure represented by the formula (1). Therefore cross-linking density thereof decreases, resulting in deterioration of abrasion resistance. The optimal amount depends on the electrophotographic process in which the resultant photoreceptor used but when the amount is from 30 to 70% by weight, the resultant photoreceptor generally has both good electric property and good abrasion resistance.

### Polymerization Initiator

The outermost layer of the photoreceptor of exemplary embodiments of the present invention include a cured product formed by subjecting the radical polymerizable compound having no charge transport structure represented by the formula (1) and the radical polymerizable compound (for example, monofunctional) having a charge transport structure to a cross-linking reaction, upon application of at least one member selected from heat, light, and ionizing radiation. When the cross-linking reaction is performed upon application of heat or light, a polymerization initiator can be used to efficiently proceed the reaction. When the cross-linking reaction is performed upon application of ionizing radiation, a polymerization initiator is not necessarily used. However, a polymerization initiator can be used when the residual unreacted components are subjected to a cross-linking reaction upon application of heat or light in the succeeding process.

Specific examples of heat polymerization initiators include, but are not limited to, peroxide initiators (e.g., 2,5-dimethylhexane-2,5-dihydroperoxide, dicumyl peroxide, benzoyl peroxide, t-butyl cumyl peroxide, 2,5-dimethyl-2,5-di(peroxybenzoyl)hexyne-3, di-t-butyl peroxide, t-butyl hydroperoxide, cumene hydroperoxide, lauroyl peroxide), and azo initiators (e.g., azobis isobutyl nitrile, azobis cyclohexane carbonitrile, azobis methyl isobutyrate, azobis isobutyl amidine hydrochloride, 4,4′-azobis-4-cyano valeric acid).

Specific examples of photo polymerization initiators include, but are not limited to, acetophenone or ketal initiators (e.g., diethoxy acetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methy-2-morpholino(4-methylthiophenyl)propane-1-one, 1-phenyl-1,2-propanedione-2-(o-ethoxycarbonyl)oxime); benzoin ether initiators (e.g., benzoin, benzoin methyl ether, benzoin ethyl ether, benzoin isobutyl ether, benzoin isopropyl ether); benzophenone initiators (e.g., benzophenone, 4-hydroxy benzophenone, methyl o-benzoyl benzoate, 2-benzoyl naphthalene, 4-benzoyl biphenyl, 4-benzoyl phenyl ether, acrylic benzophenone, 1,4-benzoyl benzene); thioxanthone initiators (e.g., 2-isopropyl thioxanthone, 2-chloro thioxanthone, 2,4-dimethyl thioxanthone, 2,4-diethyl thioxanthone, 2,4-dichloro thioxanthone); titanocene initiators (e.g., bis(cyclopentadienyl)-di-chloro-titanium, bis(cyclopentadienyl)-di-phenyl-titanium, bis(cyclopentadienyl)-bis(2,3,4,5,6-pentafluorophenyl)-titanium, bis(cyclopentadienyl)-bis(2,6-difluoro-3-(pyrrol-1-yl)phenyl)-titanium); and ethyl anthraquinone, 2,4,6-trimethylbenzoyl diphenylphosphine oxide, 2,4,6-trimethylbenzoyl phenylethoxyphosphine oxide, bis(2,4,6-trimethylbenzoyl)phenylphosphine oxide, bis(2,4-dimethoxybenzoyl)-2,4,4-trimethylpentylphosohine oxide, methylphenyl glyoxylate, 9,10-phenanthrene, acridine compounds, triazine compounds, and imidazole compounds.

Photo polymerization accelerators, such as triethanolamine, methyl diethanolamine, ethyl 4-dimethylamino benzoate, isoamyl 4-dimethylamino benzoate, (2-dimethylamino)ethyl benzoate, and 4,4′-dimethylamino benzophenone, can be used in combination with the above photo polymerization initiators.

These polymerization initiators can be used alone or in combination. The content of the polymerization initiator is 0.5 to 40 parts by weight, preferably 1 to 20 parts by weight, based on 100 parts by weight of the radical polymerizable compounds.

### Filler

The outermost layer of the photoreceptor of an exemplary embodiment of the present invention may optionally include a particulate filler so as to enhance abrasion resistance thereof.

The filler may have an average primary particle diameter of from 0.01 to 0.5 μm in terms of enhancing transmittance and abrasion resistance of the outermost layer. When the average primary particle diameter is too small, the filler cannot be well dispersed, and therefore abrasion resistance cannot be enhanced. When the average primary particle diameter is too large, the filler particles tend to settle down in the dispersion thereof, and toner films tend to be formed on the resultant layer.

As the content of the filler increases, abrasion resistance thereof increases. However, when the content is too large, residual potential tends to increase and transmittance decreases. The outermost layer typically includes the filler in an amount not greater than 50% by weight, and preferably not greater than 30% by weight.

Further, the filler is may be surface-treated with at least one surface treatment agent to enhance dispersibility thereof. When the filler is not well dispersed, residual potential increases, transmittance of the layer decreases, the layer cannot be uniformly coated, and abrasion resistance deteriorates. Any related art surface treatment agents can be used including a surface treatment agent which can keep insulation of the filler.

The content of the surface treatment agent depends on the average primary diameter of the filler used but is typically from 3 to 30% by weight, and preferably from 5 to 20% by weight, based on total weight of the filler. When the content is too small, the filler cannot be well dispersed. When the content is too large, residual potential extremely increases.

Of course, plural fillers can be used in combination.

### Other Additives

The coating liquid of the outermost layer may optionally include other additives, such as a plasticizer (for the purpose of stress relaxation and enhancement of adhesiveness), a leveling agent, a non-radical polymerizable low-molecular-weight charge transport material, etc. Any related art additives can be used, and are not particularly limited. Specific examples of the plasticizers include, but are not limited to, dibutyl phthalate and dioctyl phthalate. The coating liquid typically includes the plasticizer in an amount not greater than 20 parts by weight, and preferably not greater than 10 parts by weight, based on 100 parts by weight of the solid content of the coating liquid. Specific examples of the leveling agents include, but are not limited to, silicone oils (e.g., dimethyl silicone oil, methyl phenyl silicone oil), polymers and oligomers having a side chain including a perfluoroalkyl group. The coating liquid may include the leveling agent in an amount not greater than 3 parts by weight, based on total weight of the solid content of the coating liquid.

### Preparation of Outermost Layer

The outermost layer of the photoreceptor of an exemplary embodiment of the present invention is formed by applying a coating liquid including a radical polymerizable compound having no charge transport structure represented by the formula (1) and a radical polymerizable compound (for example monofunctional) having a charge transport structure on the photosensitive layer (to be described later), and then subjecting to curing. When the radical polymerizable compounds are liquid, other components are dissolved therein and the solution can be used as the coating liquid as it is. Typically, the components are dissolved in a solvent to prepare the coating liquid. Any related art solvents can be used, and are not particularly limited. Specific examples of the solvents include, but are not limited to, alcohols (e.g., methanol, ethanol, propanol, butanol), ketones (e.g., acetone, methyl ethyl ketone, methyl isobutyl ketone, cyclohexanone), esters (e.g., ethyl acetate, butyl acetate), ethers (e.g., tetrahydrofuran, dioxane, propyl ether), halogenated solvents (e.g., dichloromethane, dichloroethane, trichloroethane, chlorobenzene), aromatic solvents (e.g., benzene, toluene, xylene), and cellosolves (e.g., methyl cellosolve, ethyl cellosolve, cellosolve acetate). These solvents can be used alone or in combination.

The outermost layer can be formed by any known coating methods, and are not particularly limited. A suitable solvent can be selected according to the viscosity of a coating liquid, a targeted thickness of the layer, etc. Specific examples of the coating methods include, but are not limited to, a dip coating method, a spray coating method, a bead coating method, and a ring coating method.

In exemplary embodiments of the present invention, the applied coating liquid is subjected to curing (i.e., cross-linking) by applying energy thereto to form a cured outermost layer. As the applying energy, heat energy, light energy, and ionizing radiation energy can be used. Since the ionizing radiation energy is deeply infiltrate and has strong intensity, the constituent materials of the photoreceptor tends to be deteriorated and therefore electrophotographic property thereof deteriorates. For this reason, heat energy and light energy may be used. When the light energy is used, the amount of a solvent used in manufacturing process and the amount of energy used for curing can be decreased. In addition, the strength of the resultant layer increases. These energies can be used alone or in combination.

As the heat energy, gases such as air and nitrogen, heat media, infrared ray, electromagnetic wave, etc., are heated and then applied to the coated surface or the backside thereof. The heating temperature may be not less than 100° C. and not greater than 170° C. When the heating temperature is too low, the reaction rate is too slow, and therefore productivity decreases. Further, unreacted materials tend to remain in the resultant layer. When the heating temperature is too high, the resultant layer largely contracts when cross-linked, and may come to resemble an orange peel. Cracking may appear on the layer and the layer tends to peel off from the adjacent layer. If volatile components present in the photosensitive layer are sprayed, electric property of the resultant photoreceptor deteriorates. When a resin which largely contracts when cross-linked is used, the resin may be pre-cross-linked at a low temperature of less than 100° C., and then finally cross-linked at a high temperature of not less than 100° C.

As the light energy, light sources, such as ultrahigh pressure mercury lamp, high pressure mercury lamp, low pressure mercury lamp, carbon-arc lamp, and xenon-arc metal halide lamp can be used. The light source may be selected considering the light absorption properties of the radical polymerizable compound having no charge transport structure, the radical polymerizable compound (for example monofunctional) having a charge transport structure, and a polymerization initiator used. The light source may emit a light with an illuminance of from 50 to 2,000 W/cm2 at a wavelength of 365 nm. The light source may emit a light with an illuminance mentioned above at the maximum wavelength. When the illuminance is too small, it takes too long a time for the curing, resulting in decreasing of productivity. When the illuminance is too large, the resultant layer largely contracts when cross-linked, and may come to resemble an orange peel. Cracking may appear on the layer and the layer tends to peel off from the adjacent layer.

The ionizing radiation is a radiation which can ionize a substance. Specific examples of the ionizing radiations include direct ionizing radiations, such as alpha ray and electron ray, and indirect ionizing radiations, such as X-ray and neutron ray. Any related art ionizing radiations can be used for the present invention but an electron ray may be used considering effects on the human body. Specific examples of electron ray irradiation devices include, but are not limited to, electron ray accelerators, such as Cockcroft-Walton accelerator, Van de Graff accelerator, resonance transformer accelerator, insulated core transformer accelerator, linear accelerator, Dynamitron accelerator, and high-frequency accelerator.

The electron ray irradiation device may irradiate an electron having an energy level of from 100 to 1,000 keV, preferably from 100 to 300 keV, at an irradiation dose of from 0.1 to 30 Mrad. When the irradiation dose is too small, the electron ray cannot reach inside of the outermost layer, and therefore deep portion of the layer cannot be sufficiently cross-linked. When the irradiation dose is too large, the electron ray may reach to the charge transport layer and the charge generation layer (to be mentioned later) and deteriorates the constituent materials thereof.

When the ionizing radiation is irradiated, heat ray is generated from the irradiation device, and thereby the surface temperature of the photoreceptor increases. When the surface temperature is too high, the outermost layer tends to largely contract and low-molecular-weight components present in the adjacent layer tend to move to the outermost layer, resulting in inhibition of the curing and deterioration of electric property of the photoreceptor. When the ionizing radiation is irradiated, the surface of the photoreceptor typically has a temperature not greater than 100° C., and preferably not greater than 80° C. If the surface needs to be cooled, the inside of the photoreceptor can be cooled using a cooling agent, or cooled gas or liquid.

The cured outermost layer is optionally heated after the curing. For example, when a large amount of residual solvent is present in the layer, the residual solvent may be volatilized and removed upon application of heat so as to reduce the likelihood or prevent deterioration of the electrical properties of the photoreceptor.

The outermost layer may have a thickness of from 1 to 15 μm, and more preferably from 3 to 10 μm, from the viewpoint of protecting the photosensitive layer. When the outermost layer is too thin, the photosensitive layer cannot be protected from mechanical abrasion made by contacting members and contact discharge performed by a charger. In addition, the layer is hardly leveled and may come to resemble an orange peel. When the outermost layer is too thick, charges tend to diffuse, and thereby the resultant image reproducibility decreases.

### Adhesion Layer

An adhesion layer is optionally formed between the outermost layer and the photosensitive layer for the purpose of reducing the likelihood or preventing the layers from peeing off from each other.

The adhesion layer can be formed using the above-mentioned radical polymerizable compounds, non-cross-linked polymer compounds, etc. Specific examples of the non-cross-linked polymers include, but are not limited to, polyamides, polyurethanes, epoxy resins, polyketones, polycarbonates, silicone resins, acrylic resins, polyvinyl butyrals, polyvinyl formals, polyvinyl ketones, polystyrenes, poly-N-vinylcarbazoles, polyacrylamides, polyvinyl benzals, polyesters, phenoxy resins, vinyl chloride-vinyl acetate copolymers, polyvinyl acetates, polyphenylene oxides, polyvinyl pyridines, cellulose resins, casein, polyvinyl alcohols, polyvinyl pyrrolidones. Each of these non-cross-linked polymer compounds and the radical polymerizable compounds can be used alone or in combination, respectively. Of course, a non-cross-linked polymer compound and a radical polymerizable compound can be used in combination as long as there is good adhesiveness. The charge transport materials used for the exemplary embodiments of the present invention can also be used in combination. In addition, any additives enhancing adhesiveness can be used in combination.

The adhesion layer is formed by applying a coating liquid in which the layer components are dissolved or dispersed in a solvent, such as tetrahydrofuran, dioxane, dichloroethane, and cyclohexane, using a coating method, such as a dip coating method, a spray coating method, a bead coating method, and a ring coating method. The adhesion layer typically has a thickness of from 0.1 to 5 μm, and preferably from 0.1 to 3 μm.

### Photosensitive Layer

As mentioned above, the photosensitive layer may be either multi-layered or single-layered. A multi-layered photosensitive layer typically includes a charge generation layer and a charge transport layer. A single-layered photosensitive layer typically has both charge generation ability and charge transport ability. These photosensitive layers will be explained in detail.

### Charge Generation Layer

The charge generation layer includes a charge generation material having a function of generating a charge as a main component, and optionally includes a binder resin in combination. As the charge generation material, inorganic materials and organic materials can be used.

Specific examples of the inorganic materials include, but are not limited to, crystalline selenium, amorphous selenium, selenium-tellurium compounds, selenium-tellurium-halogen compounds, and amorphous silicon. Specifically, amorphous silicon in which dangling bonds are terminated with a hydrogen atom or a halogen atom, and that doped with a boron atom or a phosphorous atom may be used.

Specific examples of the organic materials include, but are not limited to, phthalocyanine pigments (e.g., metal phthalocyanine, metal-free phthalocyanine), azulenium salt pigments, squaric acid methyne pigments, azo pigments having a carbazole skeleton, azo pigments having a triarylamine skeleton, azo pigments having a diphenylamine skeleton, azo pigments having a dibenzothiophene skeleton, azo pigments having a fluorenone skeleton, azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone and polycyclic quinone pigments, quinonimine pigments, diphenylmethane and triphenylmethane pigments, benzoquinone and naphthoquinone pigments, cyanine and azomethine pigments, indigoid pigments, bisbenzimidazole pigments, etc. These charge generation materials can be used alone or in combination.

Specific examples of the binder resins include, but are not limited to, polyamides, polyurethanes, epoxy resins, polyketones, polycarbonates, silicone resins, acrylic resins, polyvinyl butyrals, polyvinyl formals, polyvinyl ketones, polystyrenes, poly-N-vinylcarbazoles, polyacrylamides, polyvinyl benzals, polyesters, phenoxy resins, vinyl chloride-vinyl acetate copolymers, polyvinyl acetates, polyphenylene oxides, polyvinyl pyridines, cellulose resins, casein, polyvinyl alcohols, and polyvinyl pyrrolidones. These binder resins can be used alone or in combination. The charge generation layer may include the binder resin in an amount of from 0 to 500 parts by weight, and more preferably from 10 to 300 parts by weight, based on 100 parts by weight of the charge generation material.

The charge generation layer is typically formed by a vacuum thin layer manufacturing method or a casting method using a liquid dispersion. Specific examples of the vacuum thin layer manufacturing methods include, but are not limited to, a vacuum deposition method, a glow discharge polymerization method, an ion plating method, a sputtering method, a reactive sputtering method, and a CVD method. The vacuum thin layer manufacturing method can well form a layer of the above inorganic and organic charge generation materials. When the charge generation layer is formed by a casting method, a dispersion in which the above inorganic or organic charge generation material, optionally together with the binder resin, are dispersed in a solvent, such as tetrahydrofuran, dioxane, dioxolane, toluene, dichloromethane, monochlorobenzene, dichloroethane, cyclohexanone, cyclopentanone, anisole, xylene, methyl ethyl ketone, acetone, ethyl acetate, and butyl acetate, using a ball mill, an attriter, a sand mill, a bead mill, etc. is diluted as appropriate and then applied. The dispersion optionally includes a leveling agent, such as dimethyl silicone oil, methylphenyl silicone oil. Specific examples of the casting methods include any known coating methods, such as a dip coating method, a spray coating method, a bead coating method, and a ring coating method.

The charge generation layer typically has a thickness of from 0.01 to 5 μm, and preferably from 0.05 to 2 μm.

### Charge Transport Layer

The charge transport layer has a function of transporting a charge, and includes a charge transport material and a binder resin as main components.

As the charge transport materials, electron transport materials and positive-hole transport materials can be used.

Specific examples of the electron transport materials include, but are not limited to, electron accepting materials, such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, and 1,3,7-trinitrodibenzothiophene-5,5-dioxide. These can be used alone or in combination.

Specific examples of the positive-hole transport materials include, but are not limited to, poly-N-vinylcarbazoles and derivatives thereof, poly-γcarbazolylethyl glutamate and derivatives thereof, condensates of pyrene and formaldehyde and derivatives thereof, polyvinyl pyrene, polyvinyl phenanthrene, polysilane, oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, and enamine derivatives. These can be used alone or in combination.

Specific examples of the binder resins include, but are not limited to, thermoplastic and thermosetting resins, such as polystyrenes, styrene-acrylonitrile copolymers, styrene-butadiene copolymers, styrene-maleic anhydride copolymers, polyesters, polyvinyl chlorides, vinyl chloride-vinyl acetate copolymers, polyvinyl acetates, polyvinyl chlorides, polyarylate resins, phenoxy resins, polycarbonates, cellulose acetate resins, ethylcellulose resins, polyvinyl butyrals, polyvinyl formals, polyvinyl toluenes, poly-N-vinylcarbazoles, acrylic resins, silicone resins, epoxy resins, melamine resins, urethane resins, phenol resins, and alkyd resins. In addition, polymeric charge transport materials, such as polycarbonates polyesters, polyurethanes, polyethers, polysiloxanes, and acrylic resins having an arylamine skeleton, a benzidine skeleton, a hydrazone skeleton, a carbazole skeleton, a stilbene skeleton, or a pyrazoline skeleton; and polymeric materials having a polysilane skeleton can be used.

The charge transport layer preferably includes the charge transport material in an amount of from 20 to 300 parts by weight, and more preferably 40 to 150 parts by weight, based on 100 parts by weight of the binder resin. The polymeric charge transport material can be used alone or in combination with the binder resin.

Specific examples of the solvents used for the charge transport layer coating liquid include, but are not limited to, tetrahydrofuran, dioxane, toluene, dichloromethane, monochlorobenzene, dichloroethane, cyclohexanone, methyl ethyl ketone, and acetone. These solvents can be used alone or in combination.

A plasticizer and/or a leveling agent may be optionally added to the charge transport layer. Specific examples of the plasticizers include, but are not limited to, typical plasticizers used for general resins, such as dibutyl phthalate and dioctyl phthalate. The charge transport layer preferably includes the plasticizer in an amount of from 0 to 30 parts by weight, based on 100 parts by weight of the binder resin. Specific examples of the leveling agents include, but are not limited to, silicone oils (e.g., dimethyl silicone oil, methyl phenyl silicone oil), polymers and oligomers having a side chain including a perfluoroalkyl group. The charge transport layer may include the leveling agent in an amount of from 0 to 1 part by weight, based on 100 parts by weight of the binder resin.

The charge transport layer preferably has a thickness not greater than 30 μm, and more preferably not greater than 25 μm, from the viewpoint of resolution and responsibility thereof. The minimum thickness is preferably not less than 5 μm, but it depends on the system (especially the charging potential) for which the photoreceptor is used.

### Single-Layered Photosensitive Layer

The single-layered photosensitive layer (hereinafter referred to as photosensitive layer) simultaneously has functions of generating and transporting a charge. The photosensitive layer can be formed by applying a coating liquid in which a charge generation material, a charge transport material, and a binder resin are dissolved or dispersed in a solvent, followed by drying. The coating liquid may optionally includes a plasticizer, a leveling agent, an oxidation inhibitor, etc.

Specific examples of the binder resins include the above-mentioned binder resins used for the charge transport layer and the charge generation layer. These can be used alone or in combination. The above-mentioned polymeric charge transport materials can also be used. The photosensitive layer may include the charge generation material in an amount of from 5 to 40 parts by weight; and the charge transport material in an amount of from 0 to 190 parts by weight, and more preferably from 50 to 150 parts by weight, based on 100 parts by weight of the binder resin. The photosensitive layer can be formed by applying a coating liquid in which a charge generation material, a charge transport material, and a binder resin are dissolved or dispersed in a solvent (e.g., tetrahydrofuran, dioxane, dichloroethane, cyclohexane), by using a coating method, such as a dip coating method, a spray coating method, a bead coating method, and a ring coating method.

The photosensitive layer preferably has a thickness of from 5 to 25 μm.

### Undercoat Layer

The photoreceptor of an exemplary embodiment of the present invention may optionally include an undercoat layer between the electroconductive substrate and the photosensitive layer. The undercoat layer generally includes a resin as a main component. The resin may be insoluble in typical organic solvents because photosensitive layers are coated thereon using organic solvents. Specific examples of such resins include, but are not limited to, water-soluble resins (e.g., polyvinyl alcohols, casein, sodium polyacrylates), alcohol-soluble resins (e.g., copolymerized nylons, methoxymethylated nylons), and indurative resins (e.g., polyurethanes, melamine resins, phenol resins, alkyd-melamine resins, epoxy resins) which can form a three-dimensional network structure, etc. The undercoat layer optionally includes a fine powder of metal oxides (e.g., titanium oxide, silica, alumina, zirconium oxide, tin oxide, indium oxide) for the purpose of reducing the likelihood or preventing occurrence of moiré and decreasing residual potential.

The undercoat layer can be formed by a typical coating method using a solvent. In addition, metal oxide layers formed by sol-gel method using silane coupling agents, titanium coupling agents, chromium coupling agents, etc.; Al2O3 layers formed by anodic oxidation; and layers of organic materials (e.g., poly-para-xylylene (i.e., parylene)) or inorganic materials (e.g., SnO₂, TiO₂, ITO, CeO₂) formed by a vacuum thin-layer manufacturing method can be used as the undercoat layer.

The undercoat layer may have a thickness of from 0 to 5 μm.

### Other Additives

For the purpose of enhancing environmental resistance, especially preventing deterioration of sensitivity and increase of residual potential, each of the outermost layer, the photosensitive layer, the charge generation layer, the charge transport layer, and the undercoat layer may include an oxidation inhibitor.

Specific examples of the oxidation inhibitors include, but are not limited to, the following compounds (1) to (5).

(1) Phenol compounds, such as 2,6-di-t-butyl-p-cresol, butylated hydroxyanisol, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherols.

(2) p-Phenylenediamines, such as N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

(3) Hydroquinones, such as 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

(4) Organic sulfur compounds, such as dilauryl-3,3′-thiodipropionate, distearyl-3,3′-thiodipropionate, and ditetradecyl-3,3′-thiodipropionate.

(5) Organic phosphorus compounds, such as triphenylphosphine, tri(nonylphenyl)phosphine, tri(dinonylphenyl)phosphine, tricresylphosphine, and tri(2,4-dibutylphenoxy)phosphine.

These compounds are known as oxidation inhibitors used for rubbers, plastics, and oils and fats, and can be commercially available.

The layer includes the oxidation inhibitor in an amount of from 0.01 to 10 parts by weight, based on total weight of the layer.

### Electroconductive Substrate

As the electroconductive substrate, materials having a volume resistivity of not greater than 10¹⁰ Ω·cm may be used. Specific examples of such materials include, but are not limited to, plastic films, plastic cylinders, and papers which are covered with a thin layer of a metal (e.g., aluminum, nickel, chromium, nichrome, copper, gold, silver, platinum) or a metal oxide (e.g., tin oxide, indium oxide) formed by vapor deposition or sputtering; and plates of aluminum, aluminum alloy, nickel, stainless, etc., and tubes thereof prepared by extruding or drawing them, followed by surface treatment, such as cutting, superfinishing, and grinding. In addition, endless nickel belts and endless stainless belts disclosed in JP-A 52-36016 can also be used for the electroconductive substrate.

The above substrates coated with a binder resin in which an electroconductive powder is dispersed can also be used. Specific examples of the electroconductive powders include, but are not limited to, carbon black, acetylene black, metal powers (e.g., aluminum, nickel, iron, nichrome, copper, zinc, silver), and metal oxide powders (e.g., electroconductive tin oxide, ITO). Specific examples of the binder resins used for dispersing the electroconductive powder include, but are not limited to, thermoplastic, thermosetting, and photocrosslinking resins, such as polystyrenes, styrene-acrylonitrile copolymers, styrene-butadiene copolymers, styrene-maleic anhydride copolymers, polyesters, polyvinyl chlorides, vinyl chloride-vinyl acetate copolymers, polyvinyl acetates, polyvinylidene chloride, polyarylate resins, phenoxy resins, polycarbonates, cellulose acetate resins, ethylcellulose resins, polyvinyl butyrals, polyvinyl formals, polyvinyl toluenes, poly-N-vinylcarbazoles, acrylic resins, silicone resins, epoxy resins, melamine resins, urethane resins, phenol resins, and alkyd resins. Such an electroconductive layer can be formed by applying a coating liquid in which an electroconductive powder and a binder resin are dissolved or dispersed in a solvent (e.g., tetrahydrofuran, dichloromethane, methyl ethyl ketone, toluene).

Further, cylinders having an electroconductive layer thereon formed of a heat-shrinkable tube of a polyvinyl chloride, a polypropylene, a polyester, a polystyrene, a polyvinyl chloride, a polyethylene, a chlorinated rubber, a polytetrafluoroethylene fluorocarbon resin, etc., including the electroconductive powder can be used as the electroconductive substrate of an exemplary embodiment of the present invention.

### Protective Material

For the purpose of decreasing surface energy of the photoreceptor to enhance cleanability and protecting the photoreceptor from electrical and mechanical hazard, a protective material can be applied to the surface of the photoreceptor.

Any related art materials that can be uniformly applied to the surface of the photoreceptor can be used. Specific examples of the protective materials include, but are not limited to, waxes, silicone oils, and fatty acid salts. Fatty acid salts may be used because these can be uniformly applied to the surface of the photoreceptor without causing deterioration of electric property thereof. Specific examples of the fatty acid metal salts include, but are not limited to, salts of fatty acids (e.g., undecylic acid, lauric acid, tridecylic acid, myristic acid, palmitic acid, pentadecylic acid, stearic acid, heptadecylic acid, arachidic acid, montanic acid, oleic acid, archidonic acid, caprylic acid, caproic acid) and metals (e.g., zinc, iron, copper, magnesium, aluminum, calcium).

Among these, a material having a lamella crystal, such as zinc stearate may be used. The lamella crystal has a layered structure in which an amphipathic molecule is self-assembled. When a shearing force is applied thereto, each of the layers tends to slide and the crystal structure is broken. By this action, a friction factor of the surface decreases. From the viewpoint of protection of the surface of the photoreceptor, such a lamella crystal can uniformly cover the surface of the photoreceptor when a shearing force is applied thereto.

A method for applying the protective material is not limited. Specific examples of the applying methods include, but are not limited to, a method in which a protective material is previously applied to a contacting member, such as a cleaning member, and a method in which an application member is included in a process cartridge. The latter method may be used because the protective material can be stably applied for a long period of the time.

### Image Forming Apparatus

The image forming apparatus of an exemplary embodiment of the present invention includes the photoreceptor of an exemplary embodiment of the present invention, a charging mechanism, an irradiating mechanism, a developing mechanism, and a transfer mechanism, and optionally includes a fixing mechanism and a cleaning mechanism.

An image forming apparatus in which an electrostatic latent image is directly transferred onto a transfer medium does not necessarily include the above mechanism arranged around the photoreceptor.

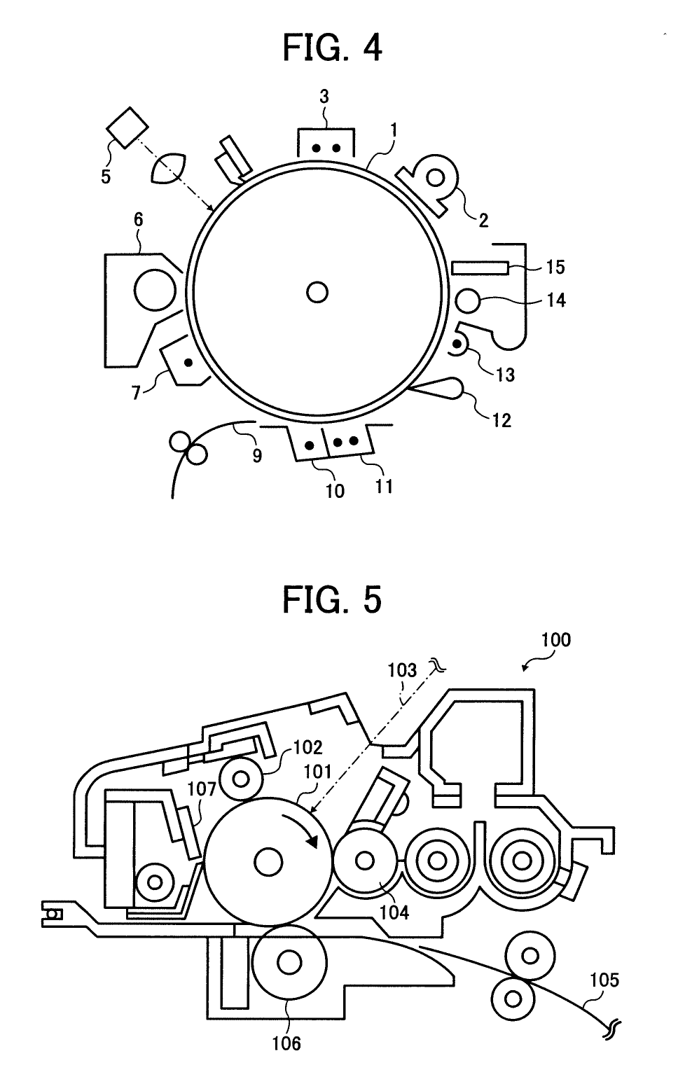

FIG. 4 is a schematic view illustrating an exemplary embodiment of the image forming apparatus of the present invention. A photoreceptor 1 is uniformly charged with a charger 3. As the charging mechanism, any related art chargers such as a corotron device, a scorotron device, a solid discharging element, a needle electrode device, a roller charging device, and an electroconductive brush device can be used.

Next, the charged photoreceptor 1 is irradiated with an irradiator 5 to form an electrostatic latent image thereon. As a light source of the irradiator 5, illuminants, such as a fluorescent lamp, a tungsten lamp, a halogen lamp, a mercury lamp, a sodium lamp, a light emitting diode (LED), a laser diode (LD), and an electroluminescent lamp (EL) can be used. In order to obtain light having a desired wavelength range, filters, such as a sharp-cut filter, a band pass filter, a near-infrared cutting filter, a dichroic filter, an interference filter, and a color temperature converting filter can be used.

Next, the electrostatic latent image formed on the photoreceptor 1 is visualized with a developing device 6 to form a toner image thereon. Developing methods are classified into one-component developing methods and two-component developing methods each using a dry toner, and wet developing methods using a wet toner. When the photoreceptor 1 is positively (negatively) charged and then irradiated with light containing image information, a positively (negatively) charged electrostatic latent image is formed on the photoreceptor 1. When the electrostatic latent image is developed with a negatively (positively) charged toner, a positive image is produced. In contrast, when the electrostatic latent image is developed with a positively (negatively) charged toner, a negative image is produced.

The toner image formed on the photoreceptor 1 is then transferred onto a transfer medium 9 using a transfer charger 10. In order to sufficiently perform the transfer process, a pre-transfer charger 7 may be used. As the transfer mechanism, an electrostatic transfer device using a transfer charger and a bias roller; mechanical transfer devices, such as an adhesion transfer device and a pressure transfer device; and a magnetic transfer device can be used. As the electrostatic transfer device, the above-mentioned chargers can be used.

Next, the transfer medium 9 is separated from the photoreceptor 1 using a separation charger 11 and a separation pick 12. As the separation mechanism, an electrostatic adsorption induction separator, a side-to-end belt separator, a grip end transporter, a curvature separator, etc., can be used. As the separation charger 11, the above-mentioned chargers can be used.

Residual toner particles remaining on the surface of the photoreceptor 1 after the toner image is transferred are removed with a fur brush 14 and a cleaning blade 15. In order to sufficiently clean the surface, a pre-cleaning charger 13 may be used. As the cleaning mechanism, a web cleaner, a magnet brush cleaner, etc. can be used. These can be used alone or in combination.

A discharging mechanism is optionally arranged so as to remove the electrostatic latent image formed on the photoreceptor 1. As the discharging mechanism, a discharging lamp 2 and a discharging charger can be used. As the discharging lamp 2, the above-mentioned illuminants can be used. As the discharging charger, the above-mentioned chargers can be used.

As a reading mechanism, a paper feeding mechanism, a fixing mechanism, a paper ejecting mechanism, etc., which are not arranged close to the photoreceptor, any related art means can be used.

### Process Cartridge

FIG. 5 is a schematic view illustrating an exemplary embodiment of the process cartridge of the present invention.

The process cartridge typically includes a photoreceptor and at least one member selected from a charging mechanism, a developing mechanism, a transfer mechanism, a cleaning mechanism, and a discharging mechanism, and is detachably attachable to an image forming apparatus.

A photoreceptor 101 is charged with a charging means 102 and then irradiated with an irradiating mechanism 103 to form an electrostatic latent image thereon, while rotating in the direction indicated by an arrow. The electrostatic latent image is developed with a developing mechanism 104 to form a toner image. The toner image is transferred onto a transfer medium 105 using a transfer mechanism 106, and then the transfer medium 105 is ejected. The surface of the photoreceptor 101 is cleaned with a cleaning mechanism 107 after the toner image is transferred, and then discharged with a discharging mechanism (not shown) to prepare for the next image forming operation.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

On an aluminum cylinder having a diameter of 30 mm, an undercoat layer coating liquid, a charge generation layer coating liquid, a charge transport layer coating liquid having the following compositions were coated in this order, followed by drying. Thus, an undercoat layer having a thickness of 3.5 μm, a charge generation layer having a thickness of 0.2 μm, and a charge transport layer having a thickness of 18 μm were prepared.

Undercoat Layer Coating Liquid

| | |
|---|---|
| Alkyd resin | 6 parts |
| (BECKOSOL ® 1307-60-EL from Dainippon | |
| Ink and Chemicals, Incorporated) | |
| Melamine resin | 4 parts |
| (SUPER BECKAMINE ® G-821-60 from | |
| Dainippon Ink and Chemicals, Incorporated) | |
| Titanium oxide | 40 parts |
| Methyl ethyl ketone | 50 parts |

Charge Generation Layer Coating Liquid

| | | |
|---|---|---|
| Bisazo pigment having the following formula (i) | 2.5 | parts |

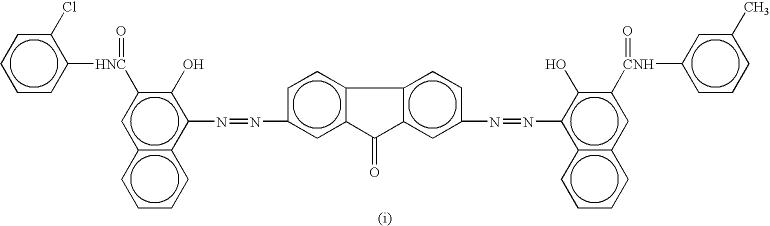

| | | |
|---|---|---|
| Polyvinyl butyral | 0.5 | parts |
| (XYHL from UCC) | | |
| Cyclohexanone | 200 | parts |
| Methyl ethyl ketone | 80 | parts |

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having the | 7 | parts |
| following formula (ii) | | |

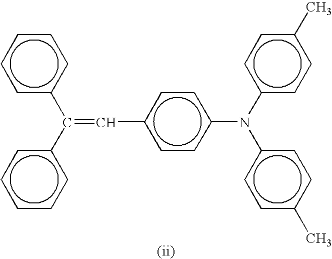

| | | |
|---|---|---|
| Tetrahydrofuran | 100 | parts |
| 1% tetrahydrofuran solution of silicone oil | 1 | part |
| (KF50-100CS from Shin-Etsu Chemical Co., Ltd.) | | |

Next, an outermost layer coating liquid having the following composition was coated on the above-prepared layers, and then subjected to a cross-linking reaction by irradiating a light having an illuminance of 500 mW/cm for 20 seconds using a metal halide lamp. Thus, a cross-linked outermost layer having a thickness of 5.5 μm was prepared.

Outermost Layer Coating Liquid

| | | |
|---|---|---|
| Radical polymerizable compound having no charge | 95 | parts |
| transport structure | | |

(Dipentaerythritol hexaacrylate (KAYARAD DPHA from Nippon
Kayaku Co., Ltd.) having the following formula (iii))

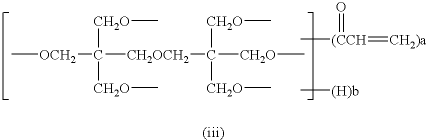

(wherein a compound in which a = 5 and b = 1 and a compound in
which a = 6 and b = 0 were mixed at a mixing ratio of 1/1 by weight)

| | | |
|---|---|---|
| Monofunctional radical polymerizable compound having a | 95 | parts |
| charge transport structure having the formula (9-54) | | |
| Arylmethane compound having the formula (5-1) | 6 | parts |
| Photo polymerization initiator | 10 | parts |
| (1-Hydroxycyclohexyl phenyl ketone, IRGACURE ® I-184 | | |
| from Ciba Specialty Chemicals) | | |
| Tetrahydrofuran | 1200 | parts |

The above-prepared layers were then dried for 30 minutes at 130° C. Thus, a photoreceptor (1) including the electroconductive substrate, the undercoat layer, the charge generation layer, the charge transport layer, and the outermost layer was prepared.

### Example 2

The procedure for preparation of the photoreceptor in Example 1 was repeated except that the radical polymerizable compound having no charge transport structure was replaced with a caprolactone modified dipentaerythritol hexaacrylate (KAYARAD DPCA-120 from Nippon Kayaku Co., Ltd.) having the following formula (iv).

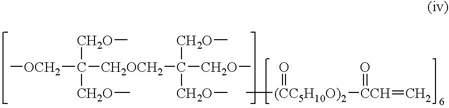

Thus, a photoreceptor (2) was prepared.

### Example 3

The procedure for preparation of the photoreceptor in Example 1 was repeated except that the radical polymerizable compound having no charge transport structure was replaced with a mixture in which the dipentaerythritol hexaacrylate (KAYARAD DPHA from Nippon Kayaku Co., Ltd.) having the formula (iii) and a trimethylolpropane triacrylate (TMPTA from Tokyo Chemical Industry Co., Ltd.) having the following formula (v) were mixed at a mixing ratio of 1/1 by weight.

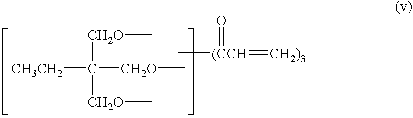

Thus, a photoreceptor (3) was prepared.

### Example 4

The procedure for preparation of the photoreceptor in Example 1 was repeated except that the radical polymerizable compound having no charge transport structure was replaced with a mixture in which the caprolactone modified dipentaerythritol hexaacrylate (KAYARAD DPCA-120 from Nippon Kayaku Co., Ltd.) having the formula (Iv) and the trimethylolpropane triacrylate (TMPTA from Tokyo Chemical Industry Co., Ltd.) having the formula (v) were mixed at a mixing ratio of 1/1 by weight.

Thus, a photoreceptor (4) was prepared.

### Examples 5 to 8

The procedures for preparations of the photoreceptors in Examples 1 to 4 were repeated except that the arylmethane compound was replaced with the arylmethane compound having the formula (6-1).

Thus, photoreceptors (5) to (8) were prepared, respectively.

### Examples 9 to 12

The procedures for preparations of the photoreceptors in Examples 1 to 4 were repeated except that the arylmethane compound was replaced with the arylmethane compound having the formula (7-1).

Thus, photoreceptors (9) to (12) were prepared, respectively.

### Examples 13 to 16

The procedures for preparations of the photoreceptors in Examples 1 to 4 were repeated except that the arylmethane compound was replaced with the arylmethane compound having the formula (8-1).

Thus, photoreceptors (13) to (16) were prepared, respectively.

### Examples 17 to 20

The procedures for preparations of the photoreceptors in Examples 1 to 4 were repeated except that the arylmethane compound was replaced with the compound having the formula (2-1).

Thus, photoreceptors (17) to (20) were prepared, respectively.

### Examples 21 to 24

The procedures for preparations of the photoreceptors in Examples 1 to 4 were repeated except that the arylmethane compound was replaced with the compound having the formula (3-1).

Thus, photoreceptors (21) to (24) were prepared, respectively.

### Examples 25 to 28

The procedures for preparations of the photoreceptors in Examples 1 to 4 were repeated except that the arylmethane compound was replaced with a mixture in which the compound having the formula (2-1) and the compound having the formula (3-1) were mixed at a mixing ratio of 1/1 by weight.

Thus, photoreceptors (25) to (28) were prepared, respectively.

### Examples 29 to 32

The procedures for preparations of the photoreceptors in Examples 1 to 4 were repeated except that the arylmethane compound was replaced with the compound having the formula (4-2).

Thus, photoreceptors (29) to (32) were prepared, respectively.

### Examples 33 to 36

The procedures for preparations of the photoreceptors in Examples 1 to 4 were repeated except that the arylmethane compound was replaced with the compound having the formula (4-4).

Thus, photoreceptors (33) to (36) were prepared, respectively.

### Examples 37 to 40

The procedures for preparations of the photoreceptors in Examples 1 to 4 were repeated except that the arylmethane compound was replaced with the compound having the formula (4-17).

Thus, photoreceptors (37) to (40) were prepared, respectively.

### Example 41

The procedure for preparation of the photoreceptor in Example 4 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having | 7 | parts |
| the formula (ii) | | |
| Arylmethane compound having the formula (5-1) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (a mixture in which the caprolactone | |
| modified dipentaerythritol hexaacrylate (KAYARAD | |
| DPCA-120 from Nippon Kayaku Co., Ltd.) having the | |
| formula (iv) and the trimethylolpropane triacrylate (TMPTA | |
| from Tokyo Chemical Industry Co., Ltd.) having the | |
| formula (v) were mixed at a mixing ratio of 1/1 by weight) | |
| Monofunctional radical polymerizable compound having a | 95 parts |
| charge transport structure having the formula (9-54) | |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (41) was prepared.

### Example 42

The procedure for preparation of the photoreceptor in Example 41 was repeated except that the arylmethane compound was replaced with the arylmethane compound having the formula (6-1).

Thus, a photoreceptor (42) was prepared.

### Example 43

The procedure for preparation of the photoreceptor in Example 41 was repeated except that the arylmethane compound was replaced with the arylmethane compound having the formula (7-1).

Thus, a photoreceptor (43) was prepared.

### Example 44

The procedure for preparation of the photoreceptor in Example 41 was repeated except that the arylmethane compound was replaced with the arylmethane compound having the formula (8-1).

Thus, a photoreceptor (44) was prepared.

### Example 45

The procedure for preparation of the photoreceptor in Example 1 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having | 7 | parts |
| the formula (ii) | | |
| Compound having the formula (2-1) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (Dipentaerythritol hexaacrylate | |
| (KAYARAD DPHA from Nippon Kayaku Co., Ltd.) | |
| having the formula (iii)) | |
| Monofunctional radical polymerizable compound having a | 95 parts |
| charge transport structure having the formula (9-54) | |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (45) was prepared.

### Example 46

The procedure for preparation of the photoreceptor in Example 45 was repeated except that the radical polymerizable compound having no charge transport structure was replaced with the caprolactone modified dipentaerythritol hexaacrylate (KAYARAD DPCA-120 from Nippon Kayaku Co., Ltd.) having the formula (iv).

Thus, a photoreceptor (46) was prepared.

### Example 47

The procedure for preparation of the photoreceptor in Example 45 was repeated except that the radical polymerizable compound having no charge transport structure was replaced with a mixture in which the caprolactone modified dipentaerythritol hexaacrylate (KAYARAD DPCA-120 from Nippon Kayaku Co., Ltd.) having the formula (Iv) and the trimethylolpropane triacrylate (TMPTA from Tokyo Chemical Industry Co., Ltd.) having the formula (v) were mixed at a mixing ratio of 1/1 by weight.

Thus, a photoreceptor (47) was prepared.

### Example 48

The procedure for preparation of the photoreceptor in Example 47 was repeated except that the compound having the formula (2-1) was replaced with the compound having the formula (3-1).

Thus, a photoreceptor (48) was prepared.

### Example 49

The procedure for preparation of the photoreceptor in Example 47 was repeated except that the compound having the formula (2-1) was replaced with a mixture in which the compound having the formula (2-1) and the compound having the formula (3-1) were mixed at a mixing ratio of 1/1 by weight.

Thus, a photoreceptor (49) was prepared.

### Example 50

The procedure for preparation of the photoreceptor in Example 32 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having | 7 | parts |
| the formula (ii) | | |
| Compound having the formula (4-2) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (a mixture in which the caprolactone | |
| modified dipentaerythritol hexaacrylate (KAYARAD | |
| DPCA-120 from Nippon Kayaku Co., Ltd.) having the | |
| formula (iv) and the trimethylolpropane triacrylate | |
| (TMPTA from Tokyo Chemical Industry Co., Ltd.) having | |
| the formula (v) were mixed at a mixing ratio of 1/1 | |
| by weight) | |
| Monofunctional radical polymerizable compound having a | 95 parts |
| charge transport structure having the formula (9-54) | |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (50) was prepared.

### Example 51

The procedure for preparation of the photoreceptor in Example 50 was repeated except that the compound having the formula (4-2) was replaced with the compound having the formula (4-4).

Thus, a photoreceptor (51) was prepared.

### Example 52

The procedure for preparation of the photoreceptor in Example 50 was repeated except that the compound having the formula (4-2) was replaced with the compound having the formula (4-17).

Thus, a photoreceptor (52) was prepared.

### Example 53

The procedure for preparation of the photoreceptor in Example 1 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having | 7 | parts |
| the formula (ii) | | |
| Arylmethane compound having the formula (5-1) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (a mixture in which the caprolactone | |
| modified dipentaerythritol hexaacrylate (KAYARAD | |
| DPCA-120 from Nippon Kayaku Co., Ltd.) having the | |
| formula (iv) and the trimethylolpropane triacrylate (TMPTA | |
| from Tokyo Chemical Industry Co., Ltd.) having the | |
| formula (v) were mixed at a mixing ratio of 1/1 by weight) | |
| Monofunctional radical polymerizable compound having | 95 parts |
| a charge transport structure having the formula (9-54) | |
| Arylmethane compound having the formula (5-1) | 6 parts |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (53) was prepared.

### Example 54

The procedure for preparation of the photoreceptor in Example 1 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having the | 7 | parts |
| formula (ii) | | |
| Compound having the formula (2-1) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (Dipentaerythritol hexaacrylate | |
| (KAYARAD DPHA from Nippon Kayaku Co., Ltd.) | |
| having the formula (iii)) | |
| Monofunctional radical polymerizable compound having | 95 parts |
| a charge transport structure having the formula (9-54) | |
| Compound having the formula (2-1) | 6 parts |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (54) was prepared.

### Example 55

The procedure for preparation of the photoreceptor in Example 54 was repeated except that the compound having the formula (2-1) was replaced with the compound having the formula (3-1).

Thus, a photoreceptor (55) was prepared.

### Example 56

The procedure for preparation of the photoreceptor in Example 1 was repeated except that the charge transport layer coating liquid and the outermost layer coating liquid were replaced with the following coating liquids, respectively.

Charge Transport Layer Coating Liquid

| | | |
|---|---|---|
| Bisphenol Z polycarbonate | 10 | parts |
| (PANLITE ® TS-2050 from Teijin Chemicals Ltd.) | | |
| Low-molecular-weight charge transport material having | 7 | parts |
| the formula (ii) | | |
| Compound having the formula (4-2) | 0.2 | parts |
| Tetrahydrofuran | 100 | parts |
| 1% tetrahydrofuran solution of silicone oil | 1 | part |
| (KF50-100CS from Shin-Etsu Chemical Co., Ltd.) | | |

Outermost Layer Coating Liquid

| | |
|---|---|
| Radical polymerizable compound having no charge | 95 parts |
| transport structure (a mixture in which the caprolactone | |
| modified dipentaerythritol hexaacrylate (KAYARAD | |
| DPCA-120 from Nippon Kayaku Co., Ltd.) having the | |
| formula (iv) and the trimethylolpropane triacrylate (TMPTA | |
| from Tokyo Chemical Industry Co., Ltd.) having the | |
| formula (v) were mixed at a mixing ratio of 1/1 by weight) | |
| Monofunctional radical polymerizable compound having a | 95 parts |
| charge transport structure having the formula (9-54) | |
| Compound having the formula (4-2) | 6 parts |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a photoreceptor (56) was prepared.

### Example 57

The procedure for preparation of the photoreceptor in Example 4 was repeated except that the radical polymerizable compound having a charge transport structure was replaced with a compound having a charge transport structure having the following formula (vi).

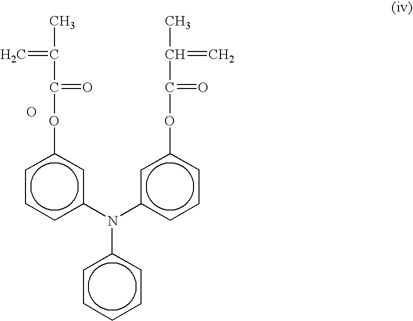

Thus, a photoreceptor (57) was prepared.

### Example 58

The procedure for preparation of the photoreceptor in Example 17 was repeated except that the radical polymerizable compound having a charge transport structure was replaced with the compound having a charge transport structure having the formula (vi).

Thus, a photoreceptor (58) was prepared.

### Example 59

The procedure for preparation of the photoreceptor in Example 29 was repeated except that the radical polymerizable compound having a charge transport structure was replaced with the compound having a charge transport structure having the formula (vi).

Thus, a photoreceptor (59) was prepared.

### Example 60

The procedure for preparation of the photoreceptor in Example 4 was repeated except that the photo polymerization initiator was replaced with a heat polymerization initiator 1,1′-azobis(1-acetoxy-1-phenylethane) (OTAZO-15 from Otsuka Chemical Co., Ltd.), and the outermost layer was subjected to a cross-linking reaction by heating the layers for 60 minutes at 135° C.

Thus, a photoreceptor (60) was prepared.

### Example 61

The procedure for preparation of the photoreceptor in Example 20 was repeated except that the photo polymerization initiator was replaced with a heat polymerization initiator 1,1′-azobis(1-acetoxy-1-phenylethane) (OTAZO-15 from Otsuka Chemical Co., Ltd.), and the outermost layer was subjected to a cross-linking reaction by heating the layers for 60 minutes at 135° C.

Thus, a photoreceptor (61) was prepared.

### Example 62

The procedure for preparation of the photoreceptor in Example 31 was repeated except that the photo polymerization initiator was replaced with a heat polymerization initiator 1,1′-azobis(1-acetoxy-1-phenylethane) (OTAZO-15 from Otsuka Chemical Co., Ltd.), and the outermost layer was subjected to a cross-linking reaction by heating the layers for 60 minutes at 135° C.

Thus, a photoreceptor (62) was prepared.

### Example 63

The procedure for preparation of the photoreceptor in Example 4 was repeated except that the photo polymerization initiator was not added, and the outermost layer is subjected to a cross-linking reaction by irradiating an electron ray at an acceleration voltage of 150 keV and an exposure dose of 5 Mrad, followed by heating for 30 minutes at 130° C.

Thus, a photoreceptor (63) was prepared.

### Example 64

The procedure for preparation of the photoreceptor in Example 20 was repeated except that the photo polymerization initiator was not added, and the outermost layer is subjected to a cross-linking reaction by irradiating an electron ray at an acceleration voltage of 150 keV and an exposure dose of 5 Mrad, followed by heating for 30 minutes at 130° C.

Thus, a photoreceptor (64) was prepared.

### Example 65

The procedure for preparation of the photoreceptor in Example 31 was repeated except that the photo polymerization initiator was not added, and the outermost layer was subjected to a cross-linking reaction by irradiating an electron ray at an acceleration voltage of 150 keV and an exposure dose of 5 Mrad, followed by heating for 30 minutes at 130° C.

Thus, a photoreceptor (65) was prepared.

### Comparative Example 1

The procedure for preparation of the photoreceptor in Example 1 was repeated except that the outermost layer coating liquid was replaced with the following outermost layer coating liquid.

Outermost Layer Coating Liquid

| | |
|---|---|
| Radical polymerizable compound having no charge charge | 95 parts |
| transport structure (Dipentaerythritol hexaacrylate | |
| (KAYARAD DPHA from Nippon Kayaku Co., Ltd.) | |
| having the formula (iii)) | |
| Monofunctional radical polymerizable compound having | 95 parts |
| a charge transport structure having the formula (9-54) | |
| Photo polymerization initiator | 10 parts |
| (1-Hydroxycyclohexyl phenyl ketone, IRGACURE ® I-184 | |
| from Ciba Specialty Chemicals) | |
| Tetrahydrofuran | 1200 parts |

Thus, a comparative photoreceptor (C1) was prepared.

### Comparative Example 2

The procedure for preparation of the photoreceptor in Comparative Example 1 was repeated except that the radical polymerizable compound having no charge transport structure was replaced with the caprolactone modified dipentaerythritol hexaacrylate (KAYARAD DPCA-120 from Nippon Kayaku Co., Ltd.) having the formula (Iv).

Thus, a comparative photoreceptor (C2) was prepared.

### Comparative Example 3

The procedure for preparation of the photoreceptor in Comparative Example 1 was repeated except that the radical polymerizable compound having no charge transport structure was replaced with a mixture in which the dipentaerythritol hexaacrylate (KAYARAD DPHA from Nippon Kayaku Co., Ltd.) having the formula (iii) and the trimethylolpropane triacrylate (TMPTA from Tokyo Chemical Industry Co., Ltd.) having the formula (v) were mixed at a mixing ratio of 1/1 by weight.

Thus, a comparative photoreceptor (C3) was prepared.

### Comparative Example 4

The procedure for preparation of the photoreceptor in Comparative Example 1 was repeated except that the radical polymerizable compound having no charge transport structure was replaced with a mixture in which the caprolactone modified dipentaerythritol hexaacrylate (KAYARAD DPCA-120 from Nippon Kayaku Co., Ltd.) having the formula (Iv) and the trimethylolpropane triacrylate (TMPTA from Tokyo Chemical Industry Co., Ltd.) having the formula (v) were mixed at a mixing ratio of 1/1 by weight.

Thus, a comparative photoreceptor (C4) was prepared.

### Comparative Example 5

The procedure for preparation of the photoreceptor in Example 1 was repeated except that the outermost layer coating liquid was replaced with the following outermost layer coating liquid.

Outermost Layer Coating Liquid

| | |
|---|---|
| Monofunctional radical polymerizable compound having | |
| a charge transport structure having the formula (9-54) | 95 parts |
| Photo polymerization initiator | 5 parts |
| (1-Hydroxycyclohexyl phenyl ketone, IRGACURE ® I-184 | |
| from Ciba Specialty Chemicals) | |
| Tetrahydrofuran | 600 parts |

Thus, a comparative photoreceptor (C5) was prepared.

### Comparative Example 6

The procedure for preparation of the photoreceptor in Example 1 was repeated except that the outermost layer coating liquid was replaced with the following outermost layer coating liquid.

Outermost Layer Coating Liquid

| | | |
|---|---|---|
| Monofunctional radical polymerizable compound having | 95 | parts |
| a charge transport structure having the formula (9-54) | | |
| Compound having the formula (2-1) | 0.1 | parts |
| Photo polymerization initiator | 5 | parts |
| (1-Hydroxycyclohexyl phenyl ketone, IRGACURE ® I-184 | | |
| from Ciba Specialty Chemicals) | | |
| Tetrahydrofuran | 600 | parts |

Thus, a comparative photoreceptor (C6) was prepared.

### Comparative Example 7

The procedure for preparation of the photoreceptor in Example 1 was repeated except that the outermost layer coating liquid was replaced with the following outermost layer coating liquid.

Outermost Layer Coating Liquid

| | |
|---|---|
| Radical polymerizable compound having no charge | 95 parts |
| transport structure (Dipentaerythritol hexaacrylate | |
| (KAYARAD DPHA from Nippon Kayaku Co., Ltd.) | |
| having the formula (iii)) | |
| Arylmethane compound having the formula (5-1) | 3 parts |
| Photo polymerization initiator | 5 parts |
| (1-Hydroxycyclohexyl phenyl ketone, IRGACURE ® I-184 | |
| from Ciba Specialty Chemicals) | |
| Tetrahydrofuran | 600 parts |

Thus, a comparative photoreceptor (C7) was prepared.

### Comparative Example 8

The procedure for preparation of the photoreceptor in Example 1 was repeated except that the outermost layer coating liquid was replaced with the following outermost layer coating liquid.

Outermost Layer Coating Liquid

| | |
|---|---|
| Radical polymerizable compound having no charge | 95 parts |
| transport structure (a mixture in which the caprolactone | |
| modified dipentaerythritol hexaacrylate (KAYARAD | |
| DPCA-120 from Nippon Kayaku Co., Ltd.) having the | |
| formula (iv) and the trimethylolpropane triacrylate (TMPTA | |
| from Tokyo Chemical Industry Co., Ltd.) having the | |
| formula (v) were mixed at a mixing ratio of 1/1 by weight) | |
| Arylmethane compound having the formula (5-1) | 3 parts |
| Photo polymerization initiator | 5 parts |
| (1-Hydroxycyclohexyl phenyl ketone, IRGACURE ® I-184 | |
| from Ciba Specialty Chemicals) | |
| Tetrahydrofuran | 600 parts |

Thus, a comparative photoreceptor (C8) was prepared.

### Comparative Example 9

The procedure for preparation of the photoreceptor in Example 1 was repeated except that the outermost layer coating liquid was replaced with the following outermost layer coating liquid.

Outermost Layer Coating Liquid

| | |
|---|---|
| Radical polymerizable compound having no charge | 95 parts |
| transport structure (Dipentaerythritol hexaacrylate | |
| (KAYARAD DPHA from Nippon Kayaku Co., Ltd.) | |
| having the formula (iii)) | |
| Compound having the formula (2-1) | 3 parts |
| Photo polymerization initiator | 5 parts |
| (1-Hydroxycyclohexyl phenyl ketone, IRGACURE ® I-184 | |
| from Ciba Specialty Chemicals) | |
| Tetrahydrofuran | 600 parts |

Thus, a comparative photoreceptor (C9) was prepared.

### Comparative Example 10

The procedure for preparation of the photoreceptor in Example 1 was repeated except that the outermost layer coating liquid was replaced with the following outermost layer coating liquid.

Outermost Layer Coating Liquid

| | |
|---|---|
| Radical polymerizable compound having no charge | 95 parts |
| transport structure (Dipentaerythritol hexaacrylate | |
| (KAYARAD DPHA from Nippon Kayaku Co., Ltd.) | |
| having the formula (iii)) | |
| Compound having the formula (4-2) | 3 parts |
| Photo polymerization initiator | 5 parts |
| (1-Hydroxycyclohexyl phenyl ketone, IRGACURE ® I-184 | |
| from Ciba Specialty Chemicals) | |
| Tetrahydrofuran | 600 parts |

Thus, a comparative photoreceptor (C10) was prepared.

### Comparative Example 11

The procedure for preparation of the photoreceptor in Example 1 was repeated except that the radical polymerizable compound having no charge transport structure was replaced with a difunctional acrylate (KAYARAD NPGDA from Nippon Kayaku Co., Ltd.) having the following formula (vii).

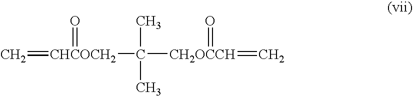

Thus, a comparative photoreceptor (C11) was prepared.

### Comparative Example 12

The procedure for preparation of the photoreceptor in Example 17 was repeated except that the radical polymerizable compound having no charge transport structure was replaced with the difunctional acrylate (KAYARAD NPGDA from Nippon Kayaku Co., Ltd.) having the formula (vii).

Thus, a comparative photoreceptor (C12) was prepared.

### Comparative Example 13

The procedure for preparation of the photoreceptor in Example 29 was repeated except that the radical polymerizable compound having no charge transport structure was replaced with the difunctional acrylate (KAYARAD NPGDA from Nippon Kayaku Co., Ltd.) having the formula (vii).

Thus, a comparative photoreceptor (C13) was prepared.

### Comparative Example 14

The procedure for preparation of the photoreceptor in Example 1 was repeated except that the radical polymerizable compound having a charge transport structure was replaced with a compound having a charge transport structure having the following formula (viii).

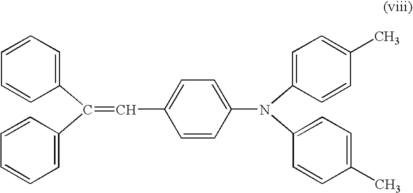

Thus, a comparative photoreceptor (C14) was prepared.

### Comparative Example 15

The procedure for preparation of the photoreceptor in Example 17 was repeated except that the radical polymerizable compound having a charge transport structure was replaced with the compound having a charge transport structure having the formula (viii).

Thus, a comparative photoreceptor (C15) was prepared.

### Comparative Example 16

The procedure for preparation of the photoreceptor in Example 29 was repeated except that the radical polymerizable compound having a charge transport structure was replaced with the compound having a charge transport structure having the formula (viii).

Thus, a comparative photoreceptor (C16) was prepared.

### Evaluations

### (1) Surface Roughness

The surface roughness Rz (i.e., Ten point height of roughness profile, standardized on JIS B0601-1982) of each of the above-prepared photoreceptors was measured using an instrument SURFCOM 1400D (manufactured by Tokyo Seimitsu Co., Ltd.). The measurement length was 2.5 mm and the standard length was 0.5 mm. 3 points, which were 2 points 80 mm from both ends and a central point in the axial direction of the drum, in 4 circumferential directions thereof at an angle of 90° each, i.e., totally 12 points were measured.

The evaluation results are shown in Table 10.

### (2) Running Test

Each of the above-prepared photoreceptors was set in a process cartridge and the process cartridge was set in a modified image forming apparatus IMAGIO MF2200 (manufactured and modified by Ricoh Co., Ltd.). The image forming apparatus includes a semiconductor laser having a wavelength of 655 nm as the light source of the irradiator, and uses a corona charging method (scorotron) as the charging method. A running test in which 100,000 copies were continuously produced was performed after the dark section potential was set to −800 V. The initial and final bright section and the dark section potentials were measured before and after 100,000 copies were continuously produced, respectively. In addition, the initial thickness of the layer, and that after 50,000 copies and 100,000 copies were produced were also measured. The abrasion depth was evaluated by decrement from the initial thickness.

The evaluation results are shown in Table 11.

### (3) Oxidizing Gas Exposure Test

The photoreceptors prepared in Examples 4, 8, 12, 16 to 18, 20, 24, 29 to 32, 36, 40 to 48, 50, 53, 54, 56, and 60 to 65, and Comparative Examples 1 to 4, 9, 12 and 15 were subjected to an oxidizing gas exposure test in which a photoreceptor was put in a chamber filled with 50 ppm of NO gas and 15 ppm of NO₂ gas for 4 days. Each of the photoreceptors was set in the above modified image forming apparatus before and after being subjected to the exposure test, and a half tone image having an image proportion of 50% was produced, respectively, and the image density difference therebetween was measured.

The evaluation results are shown in Table 12.

TABLE 10

| Examples | Rz |
|---|---|
| Ex. 1 | 0.40 |
| Ex. 2 | 0.44 |
| Ex. 3 | 0.27 |
| Ex. 4 | 0.29 |
| Ex. 5 | 0.42 |
| Ex. 6 | 0.45 |
| Ex. 7 | 0.26 |
| Ex. 8 | 0.27 |
| Ex. 9 | 0.41 |
| Ex. 10 | 0.41 |
| Ex. 11 | 0.29 |
| Ex. 12 | 0.23 |
| Ex. 13 | 0.46 |
| Ex. 14 | 0.48 |
| Ex. 15 | 0.31 |
| Ex. 16 | 0.35 |
| Ex. 17 | 0.38 |
| Ex. 18 | 0.36 |
| Ex. 19 | 0.33 |
| Ex. 20 | 0.20 |
| Ex. 21 | 0.35 |
| Ex. 22 | 0.37 |
| Ex. 23 | 0.33 |
| Ex. 24 | 0.22 |
| Ex. 25 | 0.37 |
| Ex. 26 | 0.35 |
| Ex. 27 | 0.33 |
| Ex. 28 | 0.21 |
| Ex. 29 | 0.42 |
| Ex. 30 | 0.40 |
| Ex. 31 | 0.24 |
| Ex. 32 | 0.27 |
| Ex. 33 | 0.44 |
| Ex. 34 | 0.43 |
| Ex. 35 | 0.26 |
| Ex. 36 | 0.27 |
| Ex. 37 | 0.41 |
| Ex. 38 | 0.40 |
| Ex. 39 | 0.44 |
| Ex. 40 | 0.27 |
| Ex. 41 | 0.29 |
| Ex. 42 | 0.42 |
| Ex. 43 | 0.45 |
| Ex. 44 | 0.26 |
| Ex. 45 | 0.27 |
| Ex. 46 | 0.41 |
| Ex. 47 | 0.41 |
| Ex. 48 | 0.29 |
| Ex. 49 | 0.23 |
| Ex. 50 | 0.46 |
| Ex. 51 | 0.48 |
| Ex. 52 | 0.31 |
| Ex. 53 | 0.35 |
| Ex. 54 | 0.38 |
| Ex. 55 | 0.36 |
| Ex. 56 | 0.33 |
| Ex. 57 | 0.20 |
| Ex. 58 | 0.35 |
| Ex. 59 | 0.37 |
| Ex. 60 | 0.33 |
| Ex. 61 | 0.22 |
| Ex. 62 | 0.37 |
| Ex. 63 | 0.35 |
| Ex. 64 | 0.33 |
| Ex. 65 | 0.21 |
| Comp. Ex. 1 | 0.40 |
| Comp. Ex. 2 | 0.44 |
| Comp. Ex. 3 | 0.27 |
| Comp. Ex. 4 | 0.29 |
| Comp. Ex. 5 | Outermost layer cannot be formed. |
| Comp. Ex. 6 | Outermost layer cannot be formed. |
| Comp. Ex. 7 | 0.26 |
| Comp. Ex. 8 | 0.27 |
| Comp. Ex. 9 | 0.41 |
| Comp. Ex. 10 | 0.41 |
| Comp. Ex. 11 | 0.29 |
| Comp. Ex. 12 | 0.23 |
| Comp. Ex. 13 | 0.46 |
| Comp. Ex. 14 | 0.48 |
| Comp. Ex. 15 | 0.31 |
| Comp. Ex. 16 | 0.35 |

It is clear from Table 10 that the photoreceptors of Examples 1 to 65 have good surface smoothness. Specifically, the photoreceptors including a trifunctional acrylic monomer have excellent surface smoothness.

On the other hand, the photoreceptors of Comparative Examples 1 to 4 and 7 to 13 have good surface smoothness. In Comparative Examples 5 and 6, the outermost layer cannot be formed. The photoreceptors of Comparative Examples 14 to 16 have poor surface smoothness that can be visually observed.

TABLE 11

| | Abrasion depth | | Potential (−V) | | | |
|---|---|---|---|---|---|---|
| | (μm) | | | | Final (After | |
| | After | After | Initial | | 100,000 copies) | |
| | 50,000 | 100,000 | Dark | Bright | Dark | Bright |
| Examples | copies | copies | Section | section | section | section |
| Ex. 1 | 0.41 | 0.85 | 805 | 105 | 790 | 120 |
| Ex. 2 | 0.44 | 0.84 | 800 | 95 | 790 | 115 |
| Ex. 3 | 0.38 | 0.76 | 800 | 100 | 790 | 125 |
| Ex. 4 | 0.38 | 0.79 | 800 | 95 | 785 | 110 |
| Ex. 5 | 0.41 | 0.83 | 805 | 110 | 780 | 125 |
| Ex. 6 | 0.43 | 0.81 | 810 | 90 | 795 | 105 |
| Ex. 7 | 0.39 | 0.74 | 805 | 105 | 785 | 130 |
| Ex. 8 | 0.37 | 0.77 | 795 | 95 | 770 | 120 |
| Ex. 9 | 0.42 | 0.84 | 795 | 100 | 780 | 120 |
| Ex. 10 | 0.44 | 0.81 | 800 | 90 | 780 | 105 |
| Ex. 11 | 0.40 | 0.78 | 800 | 105 | 780 | 130 |
| Ex. 12 | 0.39 | 0.79 | 805 | 90 | 790 | 100 |
| Ex. 13 | 0.45 | 0.88 | 795 | 110 | 780 | 120 |
| Ex. 14 | 0.44 | 0.84 | 800 | 95 | 780 | 105 |
| Ex. 15 | 0.38 | 0.76 | 795 | 105 | 765 | 125 |
| Ex. 16 | 0.38 | 0.75 | 790 | 100 | 770 | 110 |
| Ex. 17 | 0.41 | 0.84 | 800 | 85 | 805 | 95 |
| Ex. 18 | 0.45 | 0.89 | 795 | 85 | 800 | 105 |
| Ex. 19 | 0.40 | 0.78 | 800 | 105 | 780 | 130 |
| Ex. 20 | 0.40 | 0.78 | 800 | 85 | 800 | 100 |
| Ex. 21 | 0.41 | 0.83 | 805 | 110 | 780 | 125 |
| Ex. 22 | 0.44 | 0.81 | 800 | 90 | 780 | 105 |
| Ex. 23 | 0.38 | 0.76 | 800 | 100 | 790 | 125 |
| Ex. 24 | 0.42 | 0.81 | 810 | 80 | 790 | 100 |
| Ex. 25 | 0.42 | 0.84 | 810 | 95 | 810 | 110 |
| Ex. 26 | 0.44 | 0.81 | 800 | 90 | 780 | 105 |
| Ex. 27 | 0.38 | 0.80 | 795 | 105 | 805 | 115 |
| Ex. 28 | 0.41 | 0.83 | 805 | 80 | 795 | 90 |
| Ex. 29 | 0.40 | 0.85 | 805 | 105 | 810 | 115 |
| Ex. 30 | 0.38 | 0.82 | 800 | 105 | 805 | 115 |
| Ex. 31 | 0.36 | 0.77 | 810 | 100 | 810 | 105 |
| Ex. 32 | 0.38 | 0.79 | 805 | 105 | 810 | 110 |
| Ex. 33 | 0.42 | 0.84 | 810 | 95 | 810 | 110 |
| Ex. 34 | 0.42 | 0.87 | 805 | 105 | 810 | 120 |
| Ex. 35 | 0.38 | 0.80 | 795 | 105 | 805 | 115 |
| Ex. 36 | 0.39 | 0.78 | 790 | 115 | 795 | 125 |
| Ex. 37 | 0.44 | 0.85 | 800 | 110 | 805 | 120 |
| Ex. 38 | 0.41 | 0.82 | 800 | 105 | 810 | 120 |
| Ex. 39 | 0.38 | 0.77 | 795 | 110 | 805 | 125 |
| Ex. 40 | 0.35 | 0.79 | 790 | 100 | 805 | 130 |
| Ex. 41 | 0.31 | 0.73 | 800 | 125 | 785 | 145 |
| Ex. 42 | 0.34 | 0.72 | 805 | 120 | 780 | 150 |
| Ex. 43 | 0.38 | 0.74 | 805 | 130 | 785 | 150 |
| Ex. 44 | 0.38 | 0.76 | 800 | 130 | 770 | 145 |
| Ex. 45 | 0.38 | 0.77 | 810 | 95 | 800 | 110 |
| Ex. 46 | 0.35 | 0.75 | 800 | 90 | 790 | 105 |
| Ex. 47 | 0.38 | 0.73 | 790 | 100 | 795 | 110 |
| Ex. 48 | 0.34 | 0.73 | 805 | 95 | 800 | 105 |
| Ex. 49 | 0.37 | 0.74 | 810 | 100 | 795 | 110 |
| Ex. 50 | 0.31 | 0.73 | 800 | 125 | 810 | 155 |
| Ex. 51 | 0.30 | 0.72 | 795 | 140 | 810 | 160 |
| Ex. 52 | 0.35 | 0.73 | 805 | 135 | 815 | 160 |
| Ex. 53 | 0.34 | 0.74 | 800 | 150 | 775 | 170 |
| Ex. 54 | 0.42 | 0.88 | 805 | 100 | 800 | 115 |
| Ex. 55 | 0.45 | 0.85 | 800 | 105 | 790 | 120 |
| Ex. 56 | 0.37 | 0.80 | 800 | 145 | 810 | 165 |
| Ex. 57 | 0.39 | 0.78 | 805 | 105 | 780 | 115 |
| Ex. 58 | 0.41 | 0.79 | 790 | 105 | 790 | 115 |
| Ex. 59 | 0.41 | 0.80 | 790 | 105 | 790 | 115 |
| Ex. 60 | 0.49 | 0.93 | 810 | 125 | 770 | 155 |
| Ex. 61 | 0.52 | 1.01 | 810 | 125 | 770 | 155 |
| Ex. 62 | 0.52 | 1.01 | 810 | 125 | 770 | 155 |
| Ex. 63 | 0.40 | 0.77 | 800 | 110 | 790 | 130 |
| Ex. 64 | 0.41 | 0.79 | 800 | 110 | 790 | 130 |
| Ex. 65 | 0.41 | 0.79 | 800 | 110 | 790 | 130 |
| Comp. Ex. 1 | 0.40 | 0.79 | 795 | 85 | 770 | 105 |
| Comp. Ex. 2 | 0.44 | 0.81 | 795 | 75 | 770 | 95 |
| Comp. Ex. 3 | 0.38 | 0.74 | 800 | 90 | 780 | 115 |
| Comp. Ex. 4 | 0.35 | 0.71 | 805 | 85 | 775 | 100 |
| Comp. Ex. 5 | Outermost layer cannot be formed. | | | | | |
| Comp. Ex. 6 | Outermost layer cannot be formed. | | | | | |
| Comp. Ex. 7 | 0.39 | 0.73 | 810 | 280 | 780 | 360 |
| Comp. Ex. 8 | 0.37 | 0.70 | 810 | 250 | 785 | 295 |
| Comp. Ex. 9 | 0.41 | 0.83 | 790 | 240 | 770 | 305 |
| Comp. Ex. 10 | 0.35 | 0.72 | 800 | 255 | 810 | 325 |
| Comp. Ex. 11 | 1.00 | 1.94 | 805 | 115 | 780 | 150 |
| Comp. Ex. 12 | 0.79 | 1.52 | 800 | 105 | 780 | 120 |
| Comp. Ex. 13 | 0.82 | 1.73 | 800 | 105 | 800 | 120 |
| Comp. Ex. 14 | 1.35 | 2.51 | 810 | 110 | 785 | 150 |
| Comp. Ex. 15 | 1.31 | 2.43 | 795 | 100 | 770 | 120 |
| Comp. Ex. 16 | 1.44 | 2.63 | 795 | 100 | 810 | 120 |

It is clear from Table 11 that in Examples 1 to 59 and 63 to 65, the potential does not largely change and the abrasion depth is small.

In Examples 60 to 62, the bright section potential and the abrasion depth slightly increase. The reason is uncertain, but it is considered that the polymerization initiator influences thereon. However, the potential change and the abrasion resistance are acceptable.

In Comparative Examples 1 to 4, the potential does not largely change and the abrasion depth is small.

In Comparative Examples 7 to 10, the initial bright section potential is too high, resulting in producing images having low image density. These photoreceptors are not suitable for practical use.

In Comparative Examples 11 to 16, the abrasion depth is too large. These photoreceptors are not considered to be highly durable photoreceptors.

TABLE 12

| Examples | Image density change |
|---|---|
| Ex. 4 | not changed |
| Ex. 8 | not changed |
| Ex. 12 | not changed |
| Ex. 16 | not changed |
| Ex. 17 | not changed |
| Ex. 18 | not changed |
| Ex. 20 | not changed |
| Ex. 24 | not changed |
| Ex. 29 | not changed |
| Ex. 30 | not changed |
| Ex. 31 | not changed |
| Ex. 32 | not changed |
| Ex. 36 | not changed |
| Ex. 40 | not changed |
| Ex. 41 | slightly increase |
| Ex. 42 | slightly increase |
| Ex. 43 | slightly increase |
| Ex. 44 | slightly increase |
| Ex. 45 | slightly increase |
| Ex. 46 | slightly increase |
| Ex. 47 | slightly increase |
| Ex. 48 | slightly increase |
| Ex. 50 | slightly increase |
| Ex. 53 | not changed |
| Ex. 54 | not changed |
| Ex. 56 | not changed |
| Ex. 60 | not changed |
| Ex. 61 | not changed |
| Ex. 62 | not changed |
| Ex. 63 | not changed |
| Ex. 64 | not changed |
| Ex. 65 | not changed |
| Comp. Ex. 1 | increase |
| Comp. Ex. 2 | increase |
| Comp. Ex. 3 | increase |
| Comp. Ex. 4 | increase |

It is clear from Table 12 that in Comparative Examples 1 to 4, wherein the photoreceptor does not include any functional compound (A), (B), (C), or (D), the resultant image density changes after being subjected to the gas exposure test. On the other hand, in all Examples, wherein the photoreceptor include a functional compound (A), (B), (C), or (D), the resultant image density hardly changes even after being subjected to the gas exposure test.

Having now fully described the invention, it will be apparent to one of ordinary skill in the art that many changes and modifications can be made thereto without departing from the spirit and scope of the invention as set forth therein.

What is claimed:

1. An electrophotographic photoreceptor, comprising:
an electroconductive substrate;
a photosensitive layer located overlying the electroconductive substrate; and
an outermost layer located overlying the photosensitive layer,
wherein the outermost layer is formed by a reaction between a radical polymerizable compound having no charge transport structure and comprising a compound represented by the following formula (1), and a radical polymerizable compound having a charge transport structure, while applying at least one member selected from the group consisting of heat, light, and ionizing radiation to the reaction, and
wherein at least one of the photosensitive layer and the outermost layer comprises at least one member selected from the group consisting of (A) an arylmethane compound having an alkylamino group, (B) a compound represented by the following formula (2), (C) a compound represented by the following formula (3), and (D) a compound represented by the following formula (4): 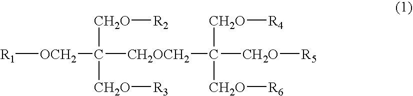
wherein each of R₁, R₂, R₃, R₄, R₅, and R₆ independently represents a hydrogen atom or a group represented by the following formula: 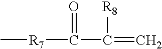
wherein R₇ represents a single bond, an alkylene group, an alkylene ether group, a polyoxyalkylene group, an alkylene ether group substituted with a hydroxyl group, an alkylene ether group substituted with a (meth)acryloyloxy group, an oxyalkylene carbonyl group, or a poly(oxyalkylene carbonyl) group; and R₈ represents a hydrogen atom or a methyl group,
wherein four or more of R₁, R₂, R₃, R₄, R₅, and R₆ do not simultaneously represent hydrogen atoms: 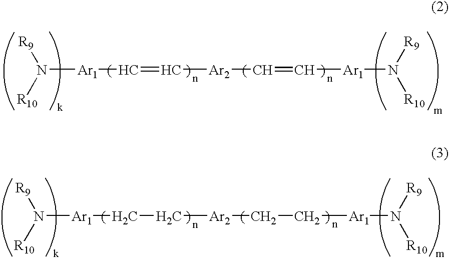
wherein each of R₉ and R₁₀ independently represents a substituted or unsubstituted aryl group or a substituted or unsubstituted alkyl group, wherein R₉ and R₁₀ optionally share bond connectivity to form a heterocyclic group containing a nitrogen atom; each of Ar₁ and Ar₂ independently represents a substituted or unsubstituted aryl group; each of k and m independently represents an integer of from 0 to 3, wherein both of k and m does not simultaneously represent 0; and n represents an integer of from 1 to 3: 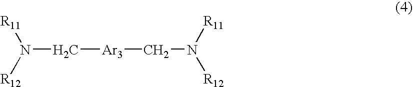
wherein each of R₁₁ and R₁₂ independently represents a substituted or unsubstituted alkyl group or a substituted or unsubstituted aryl group, wherein at least one of R₁₁ and R₁₂ is a substituted or unsubstituted aryl group, and wherein R₁₁ and R₁₂ optionally share bond connectivity to form a substituted or unsubstituted heterocyclic group containing a nitrogen atom; and Ar₃ represents a substituted or unsubstituted aryl group.

2. The electrophotographic photoreceptor according to claim 1, wherein the arylmethane compound having an alkylamino group is represented by the following formula (5): 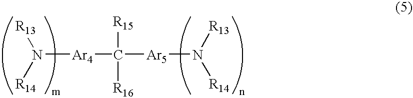
wherein each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom; each of R₁₅ and R₁₆ independently represents a hydrogen atom, a substituted or unsubstituted alkyl group having 1 to 11 carbon atoms, or a substituted or unsubstituted aryl group; each of Ar₄ and Ar₅ independently represents a substituted or unsubstituted aryl group; and each of m and n independently represents an integer of from 0 to 3, wherein both of m and n does not simultaneously represent 0.

3. The electrophotographic photoreceptor according to claim 1, wherein the arylmethane compound having an alkylamino group is represented by the following formula (6): 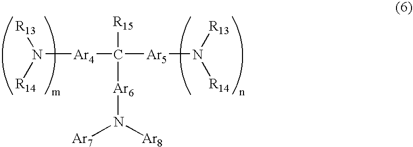
wherein each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom; R₁₅ represents a hydrogen atom, a substituted or unsubstituted alkyl group having 1 to 11 carbon atoms, or a substituted or unsubstituted aryl group; each of Ar₄, Ar₅, Ar₆, Ar₇, and Ar₈ independently represents a substituted or unsubstituted aryl group, wherein Ar₇ optionally shares bond connectivity with Ar₆ or Ar₈ to form a heterocyclic group containing a nitrogen atom; and each of m and n independently represents an integer of from 0 to 3, wherein both of m and n does not simultaneously represent 0.

4. The electrophotographic photoreceptor according to claim 1, wherein the arylmethane compound having an alkylamino group is represented by the following formula (7): 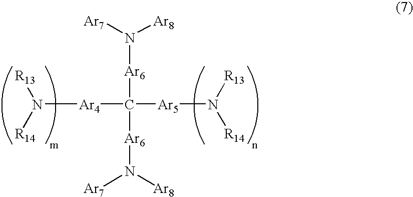
wherein each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom; each of Ar₄, Ar₅, Ar₆, Ar₇, and Ar₈ independently represents a substituted or unsubstituted aryl group, wherein Ar₇ optionally shares bond connectivity with Ar₆ or Ar₈ to form a heterocyclic group containing a nitrogen atom; and each of m and n independently represents an integer of from 0 to 3, wherein both of m and n does not simultaneously represent 0.

5. The electrophotographic photoreceptor according to claim 1, wherein the arylmethane compound having an alkylamino group is represented by the following formula (8): 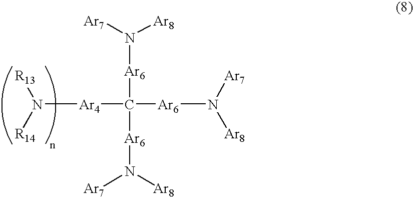
wherein each of R₁₃ and R₁₄ independently represents an alkyl group having 1 to 4 carbon atoms which may be substituted with an aryl group, wherein R₁₃ and R₁₄ optionally share bond connectivity to form a heterocyclic group containing a nitrogen atom; each of Ar₄, Ar₆, Ar₇, and Ar₈ independently represents a substituted or unsubstituted aryl group, wherein Ar₇ optionally shares bond connectivity with Ar₆ or Ar₈ to form a heterocyclic group containing a nitrogen atom; and n represents an integer of from 1 to 3.

6. The electrophotographic photoreceptor according to claim 1, wherein the radical polymerizable compound having no charge transport structure further comprises a trifunctional or tetrafunctional radical polymerizable compound.

7. The electrophotographic photoreceptor according to claim 1, wherein the radical polymerizable compound having a charge transport structure has at least one functional group selected from the group consisting of an acryloyloxy group and a methacryloyloxy group.

8. The electrophotographic photoreceptor according to claim 1, wherein the radical polymerizable compound having a charge transport structure has a triarylamine structure.

9. The electrophotographic photoreceptor according to claim 1, wherein the radical polymerizable compound having a charge transport structure is a monofunctional radical polymerizable compound.

10. The electrophotographic photoreceptor according to claim 9, wherein the monofunctional radical polymerizable compound comprises at least one member selected from the group consisting of a compound represented by the following formula (9) and a compound represented by the following formula (10): 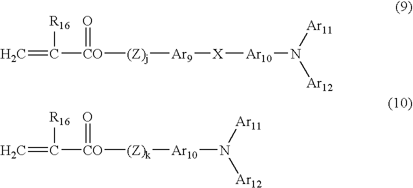
wherein R₁₆ represents a hydrogen atom, a halogen atom, an alkyl group which may have a substituent group, an aralkyl group which may have a substituent group, an aryl group which may have a substituent group, a cyano group, a nitro group, an alkoxy group, —COOR₁₇ (R₁₇ represents a hydrogen atom, an alkyl group which may have a substituent group, an aralkyl group which may have a substituent group, or an aryl group which may have a substituent group), a halogenated carbonyl group, or —CONR₁₈R₁₉ (each of R₁₈ and R₁₉ independently represents a hydrogen atom, a halogen atom, an alkyl group which may have a substituent group, an aralkyl group which may have a substituent group, or an aryl group which may have a substituent group); each of Ar₉ and Ar₁₀ independently represents a substituted or unsubstituted arylene group; each of Ar₁₁ and Ar₁₂ independently represents a substituted or unsubstituted aryl group; X represents a single bond, a substituted or unsubstituted alkylene group, a substituted or unsubstituted cycloalkylene group, a substituted or unsubstituted alkylene ether group, an oxygen atom, a sulfur atom, or a vinylene group; Z represents a substituted or unsubstituted alkylene group, a substituted or unsubstituted alkylene ether group, or an alkyleneoxycarbonyl group; and each of j and k independently represents an integer of from 0 to 3.

11. The electrophotographic photoreceptor according to claim 9, wherein the monofunctional radical polymerizable compound comprises a compound represented by the following formula (11): 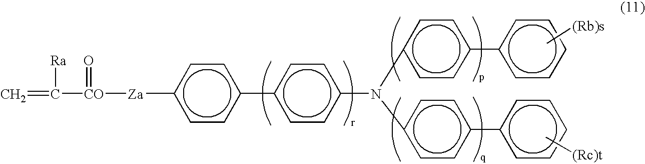
wherein each of r, p, and q independently represents an integer of 0 or 1; each of s and t independently represents an integer of from 0 to 3; Ra represents a hydrogen atom or a methyl group; each of Rb and Rc independently represents an alkyl group having 1 to 6 carbon atoms; Za represents a single bond, a methylene group, an ethylene group,

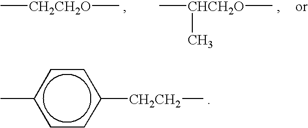

12. The electrophotographic photoreceptor according to claim 1, wherein heat or light is applied to the reaction.

13. The electrophotographic photoreceptor according to claim 12, wherein light is applied to the reaction.

14. The electrophotographic photoreceptor according to claim 1, wherein the outermost layer has a thickness of from 1 to 15 μm.

15. The electrophotographic photoreceptor according to claim 1, wherein the photosensitive layer comprises a charge generation layer and a charge transport layer.

16. An image forming apparatus, comprising:
the electrophotographic photoreceptor according to claim 1;
a charging device configured to charge the electrophotographic photoreceptor;
a latent image forming device configured to form an electrostatic latent image on the charged electrophotographic photoreceptor;
a developing device configured to adhere a toner to the electrostatic latent image to form a toner image; and
a transfer device configured to transfer the toner image onto a transfer medium.

17. A process cartridge detachably attachable to an image forming apparatus, comprising:
the electrophotographic photoreceptor according to claim 1; and
a developing device configured to adhere a toner to the electrostatic latent image to form a toner image.
